(19) United States
(12) Patent Application Publication
(10) Pub. No.: US 2010/0280956 A1
(43) Pub. Date: Nov. 4, 2010

(54) SYSTEMS AND METHODS FOR CONDUCTING COMMERCE IN A VEHICLE

(75) Inventors: Richard J. Chutorash, Oakland Township, MI (US); Mark Zeinstra, Holland, MI (US); James E. Trainor, Holland, MI (US); Jeffrey N. Golden, Holland, MI (US); Steven L. Geerlings, Holland, MI (US); Philip J. Vanderwall, Marne, MI (US); Michael J. Sims, Zeeland, MI (US); Rodger W. Eich, Holland, MI (US); Brian L. Douthitt, Holland, MI (US); Danny B. Larsen, Holland, MI (US)

Correspondence Address: FOLEY AND LARDNER LLP;SUITE 500, 3000 K STREET NW, WASHINGTON, DC, 20007, US

(73) Assignee: JOHNSON CONTROLS TECHNOLOGY COMPANY

(21) Appl. No.: 12/810,801

(22) PCT Filed: Dec. 23, 2008
(86) PCT No.: PCT/US08/88122

§ 371 Date: Jun. 25, 2010

Related U.S. Application Data
(60) Provisional application No. 61/016,789, filed on Dec. 26, 2007.
(60) Provisional application No. 61/062,205, filed on Jan. 23, 2008.
(60) Provisional application No. 61/011,928, filed on Jan. 23, 2008.

(51) Int. Cl. G06Q 20/00

(52) U.S. Cl. 705/64; 705/21; 705/17

(57) ABSTRACT

A system for a vehicle and for conducting a transaction with a remote system includes a circuit configured to wirelessly obtain data from a payment mechanism brought into the vehicle and to wirelessly transmit the data to the remote system.

### CROSS REFERENCE TO RELATED PATENT APPLICATIONS

The present application claims the benefit of:

U.S. Provisional Application No. 61/016,789, filed Dec. 26, 2007, the entirety of which is hereby incorporated by reference;

U.S. Provisional Application No. 61/062,205, filed Jan. 23, 2008, the entirety of which is hereby incorporated by reference; and

U.S. Provisional Application No. 61/011,928, filed Jan. 23, 2008, the entirety of which is hereby incorporated by reference.

### BACKGROUND

The present disclosure relates to systems and methods for conducting commerce in a vehicle. Applicants have identified that, among other challenges, secure communications of commerce data such as payment information remain ongoing concerns of users and merchants.

### SUMMARY

One embodiment relates to a system for installing in a vehicle and for conducting a transaction with a remote system. The system includes a circuit configured to wirelessly obtain data from a payment mechanism brought into the vehicle and to transmit the data to the remote system. The payment mechanism may be, for example, a credit card, an identifier tag, a key fob, a mobile phone, and/or a personal digital assistant. The circuit may include or be communicably coupled to a reader configured to receive the data from the payment mechanism. The circuit may also (or alternatively) include a transmitter configured to transmit the data to the remote system. The circuit may be configured to communicate with a connectivity module in the vehicle and may transmit the data to the remote system via the connectivity module. The circuit may also (or alternatively) be configured to communicate with a telematics module in the vehicle and to transmit the data to the remote system via the connectivity module. The circuit may also (or alternatively) be configured to communicate with a remote control system in the vehicle and transmits the data to the remote system via the remote control system. The circuit may be integrated with a connectivity module, integrated with a telematics module, and/or integrated with a remote control system configured to transmit a signal to activate a garage door opener.

Another embodiment relates to a system for a vehicle and for conducting a transaction with a merchant remote from the vehicle using a mobile commerce agent and a payment processing system remote from the vehicle. The vehicle has a transmitter and a receiver for wireless communications. The system includes a circuit configured to cause the transmitter to transmit a transaction signal for reception by the mobile commerce agent and to receive first information via the receiver after transmitting the transaction signal. The circuit is further configured to gather payment data. The circuit is further configured to process the first information and the payment data to cause the transmitter to transmit payment information for reception by the remote payment processing system.

In some embodiments processing the first information and the payment data can be or include transforming the payment data based on the first information. The remote payment processing system may be one of a plurality of remote payment processing systems. Processing the first information and the payment data can include formatting the payment information for secure transmission to a particular remote payment processing system indicated by the first information. The mobile commerce agent can be configured to provide the first information to vehicle systems in response to receiving transaction signals and the first information may be or include an identifier of the remote payment processing system. The identifier for the remote payment processing system may be transmitted with the payment information. The circuit may also (or alternatively) be configured to encrypt a portion of the payment information prior to transmission and the encryption may be based on the first information. When the encryption is based on the first information, the first information may be used as at least part of a cryptography key during the encryption of the payment information.

Yet another embodiment relates to a method for conducting a transaction with a merchant using a vehicle system, a mobile commerce agent, and a remote payment processing system. The method includes causing the a transmitter in the vehicle to transmit a transaction signal for reception by the mobile commerce agent. The method further includes receiving first information at a receiver in the vehicle after the transmitter transmits the transaction signal and gathering payment data at the vehicle system. The method yet further includes processing the first information and the payment data to cause the transmitter to transmit payment information for reception by the remote payment processing system.

Another embodiment relates to a mobile commerce agent for facilitating a transaction originating from a vehicle system and using a merchant and a payment processing system. The mobile commerce agent includes a processing circuit configured to process a transaction signal received from the vehicle system. The processing circuit is further configured to cause the transmission of a payment processing system identifier to the vehicle system in response to the transaction signal. The processing circuit is configured to receive a confirmation of payment from the remote payment processing system. The processing circuit is further configured to cause the transmission of the purchase request to the merchant in response to the received confirmation of payment. The mobile commerce agent may also include a memory device associating payment processing system identifiers with merchants. The processing circuit can be configured to select the payment processing system identifier for transmission to the vehicle control system by recalling the payment processing system identifier associated with a merchant as indicated by the transaction signal.

Another embodiment relates to a method for facilitating a transaction originating from a vehicle system using a merchant and a payment processing system. The method includes receiving a transaction signal from a vehicle system and processing the transaction signal received from the vehicle control system to determine a payment processing system identifier relating to the transaction signal. The method further includes transmitting the payment processing system identifier to the vehicle system. The method yet further includes receiving a confirmation of payment from the payment processing system corresponding to the payment processing system identifier. The transaction signal can then be transmitted to the merchant in response to receiving the confirmation of payment. The method can also include selecting the payment processing identifier for transmission to the vehicle system by recalling, from a memory device, a payment processing system identifier associated with a merchant indicated by the transaction signal.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle communicating wirelessly with a merchant, according to an exemplary embodiment;

FIGS. 2A-F are block diagrams of systems for conducting commerce in a vehicle, according to exemplary embodiments;

FIG. 2G is a perspective view of a vehicle interior including a mobile device bin, according to an exemplary embodiment;

FIG. 2H is a front elevation view of the user interface of the vehicle control system of FIG. 1, according to an exemplary embodiment;

FIG. 3 is a block diagram of the vehicle control system of FIG. 1 and remote sources, according to an exemplary embodiment;

FIG. 4 is a more detailed block diagram of the vehicle control system and remote sources of FIG. 3, according to an exemplary embodiment;

FIG. 5A is a block diagram of a mobile commerce system including a mobile commerce agent, according to an exemplary embodiment;

FIG. 5B is a block diagram of a mobile commerce system including a mobile commerce agent, according to another exemplary embodiment;

FIG. 5C is a flow chart of a process for the mobile commerce system of FIGS. 5A-B, according to an exemplary embodiment;

FIG. 5D is a block diagram of the mobile commerce agent of FIGS. 5A-C, according to an exemplary embodiment;

FIG. 5E is a flow chart of a process for the mobile commerce agent of FIGS. 5A-D, according to an exemplary embodiment;

FIGS. 6A-D are block diagrams of mobile commerce systems, according to multiple exemplary embodiments;

FIG. 7 is a block diagram of a merchant and vehicle control system coupled to a communication add-on, according to an exemplary embodiment;

FIGS. 8A-D are flow charts of various processes for using the mobile commerce systems of FIGS. 6A-D to purchase or otherwise obtain products, services, and/or information, according to an exemplary embodiment;

FIG. 9 is a flow chart of a process for storing and deleting a payment method and related information, according to an exemplary embodiment;

FIG. 10A is a block diagram of a system of communications between a vehicle and a pump of a service station, according to an exemplary embodiment;

FIG. 10B is a block diagram of a system of communications between multiple vehicles, pumps, and a service station, according to an exemplary embodiment;

FIG. 10C is a block diagram of a system of communications between multiple vehicles, pumps, and a service station, according to another exemplary embodiment;

FIG. 11 is a flow chart of a process for a vehicle control system communicating with a service station and/or pump, according to an exemplary embodiment;

FIG. 12 is a flow chart of a process for locating, choosing, and communicating with a service station using a vehicle control system, according to an exemplary embodiment;

FIG. 13 is a flow chart of a process for communicating non-payment information between a vehicle control system and a service station, according to an exemplary embodiment;

FIG. 14 is a flow chart of a process for selecting a pump at a service station using a vehicle control system, according to an exemplary embodiment;

FIG. 15 is a flow chart of a process for a service station communicating with a vehicle control system, according to an exemplary embodiment;

FIG. 16A is a block diagram of a vehicle control system and a parking system configured to communicate with one another, according to an exemplary embodiment;

FIG. 16B is a block diagram of a vehicle control system and a parking system configured to communicate with one another via a parking station, according to an exemplary embodiment;

FIG. 16C is a block diagram of a vehicle control system and a parking system configured to communicate with one another, according to an exemplary embodiment;

FIG. 16D is a block diagram of a parking meter configured to communicate with a vehicle control system and/or other devices, according to an exemplary embodiment;

FIG. 17 is a flow chart of a process for purchasing parking time using the systems of FIGS. 16A-D, according to an exemplary embodiment;

FIG. 18 is a flow chart of a process for processing a payment request received from a parking meter, according to an exemplary embodiment;

FIG. 19 is a flow chart of a process for a parking meter or parking system for continuing to charge a vehicle for parking time or credits, according to an exemplary embodiment;

FIG. 20 is a flow chart of a process for a parking system for sending additional information to a vehicle control system, according to an exemplary embodiment;

FIG. 21 is a flow chart of a process for a vehicle control system receiving additional information from a parking system, according to an exemplary embodiment;

FIG. 22 is a flow chart of a process for selecting between multiple payment methods, according to an exemplary embodiment;

FIG. 23 is a block diagram of a vehicle communicating with a merchant via a remote source, according to an exemplary embodiment;

FIG. 24 is a flow chart of a process for placing an order on the remote system of FIG. 23, according to an exemplary embodiment;

FIG. 25 is a block diagram of a navigation device and merchant, according to an exemplary embodiment;

FIG. 26 is a block diagram of a navigation device and merchant, according to another exemplary embodiment;

FIG. 27 is a flow chart of a process for placing an order using the navigation system of FIGS. 25-26, according to an exemplary embodiment;

FIG. 28, is a block diagram of a vehicle communicating with an RFID detected merchant via a remote system, according to an exemplary embodiment;

FIG. 29 is a flow chart of a process for placing an order on the remote system of FIG. 28, according to an exemplary embodiment;

FIG. 30A is a flow chart of a process for using multiple systems (e.g., voice recognition or speech recognition systems) to execute a command based on an oral input, according to an exemplary embodiment;

FIG. 30B is a flow chart of a process for using multiple systems (e.g., voice recognition or speech recognition systems) to execute a command based on an oral input, according to another exemplary embodiment;

FIG. 31 is a block diagram of communications between a vehicle and an outside source, according to an exemplary embodiment;

FIGS. 32A-F are block diagrams of vehicle control system embodiments including a mobile device module, receiver module, audio module, and navigation module, according to an exemplary embodiment;

FIG. 33 is a block diagram of the user interface module of FIGS. 32A-F, according to an exemplary embodiment;

FIG. 34 is a block diagram of the display engine of the user interface module of FIG. 33, according to an exemplary embodiment; and

FIGS. 35A-B are alternative embodiments of the vehicle control system user interface shown in FIG. 2H, according to exemplary embodiments.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the FIGS., vehicle control systems and methods are shown for conducting commerce in a vehicle. The vehicle control system is configured to wirelessly transmit information to one or more systems remotely located from the vehicle to conduct the commerce.

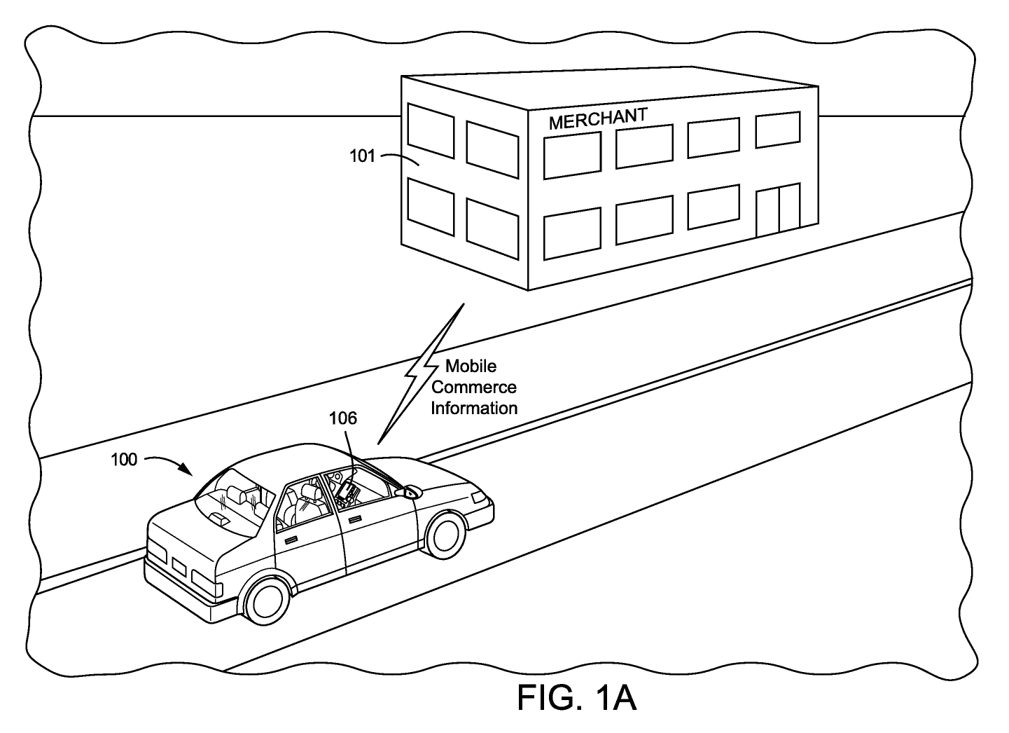

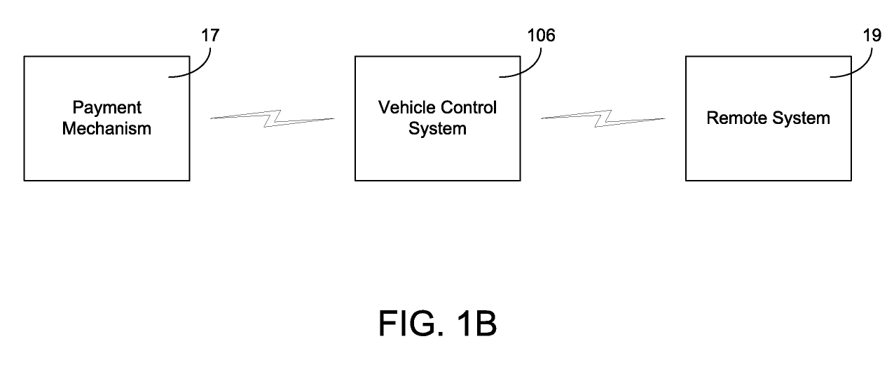

Referring to FIG. 1A, a perspective view of a vehicle 100 is shown, according to an exemplary embodiment. A vehicle control system 106 mounted or installed in vehicle 100 may be configured to facilitate mobile commerce activities. Vehicle control system 106 can be disposed in and/or mounted to any location in vehicle 100, including, for example, locations associated with the steering wheel, a visor, a dashboard, a vehicle seat, a trunk location, a rear view mirror location, a center stack location, or any other vehicle structure or location. Vehicle control system 106 may also or alternatively be distributed throughout multiple locations of the vehicle.

Vehicle control system 106 can be utilized to receive inputs, facilitate communications, and to provide feedback for mobile commerce activities. For example, vehicle control system 106 may form a wireless communication link with a merchant 101 (e.g., a payment system for a merchant, a receiver for a merchant, a bank system associated with a merchant, etc.). Merchant 101 may be configured to receive and/or transmit mobile commerce information to vehicle control system 106. According to various exemplary embodiments, vehicle control system 106 communicates with a source or system other than merchant 101, but a user receives goods or services from merchant 101 once the transaction between the vehicle control system and the source or system is completed.

Referring now to FIG. 1B, a block diagram of a system for conducting commerce in a vehicle is shown, according to an exemplary embodiment. Vehicle control system 106 is configured to wirelessly obtain data from a payment mechanism 17 (e.g., financial instrument, payment device, etc.) and to wirelessly provide information to a remote system 19 for initiating, completing and/or facilitating a transaction. In an exemplary embodiment, the data obtained from payment mechanism 17 includes payment data (e.g., an account number, a user identifier, a credit card number, a debit card number, a passkey relating to an account, an identifier associated with the payment merchant, etc.). The information provided to remote system 19 may be the payment data, information based on the payment data, a transformation of the payment data, a transaction signal, or any other information relating to a transaction between the vehicle (e.g., a user of the vehicle) and a merchant (which may or may not be associated with remote system 19).

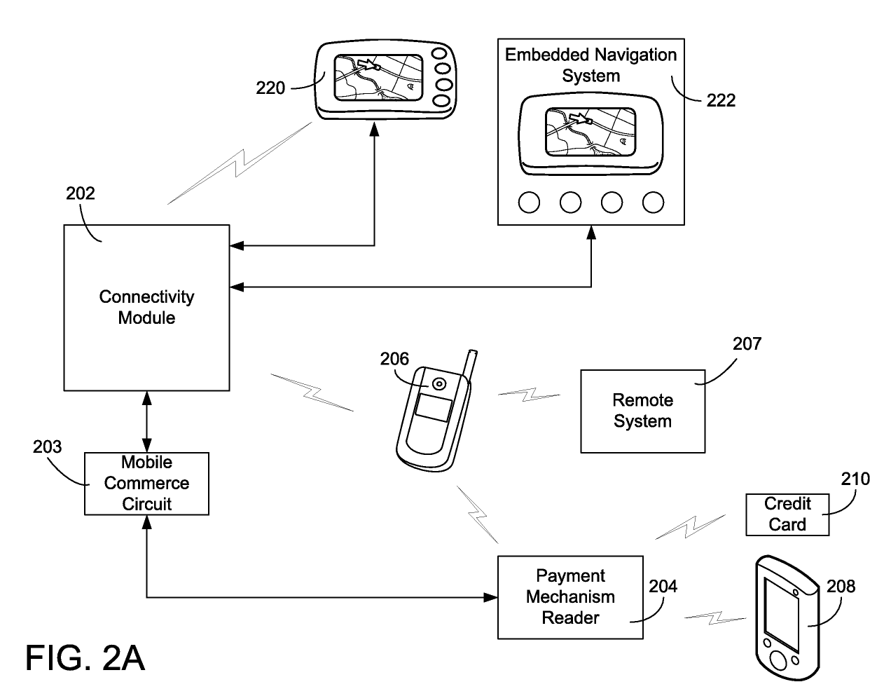

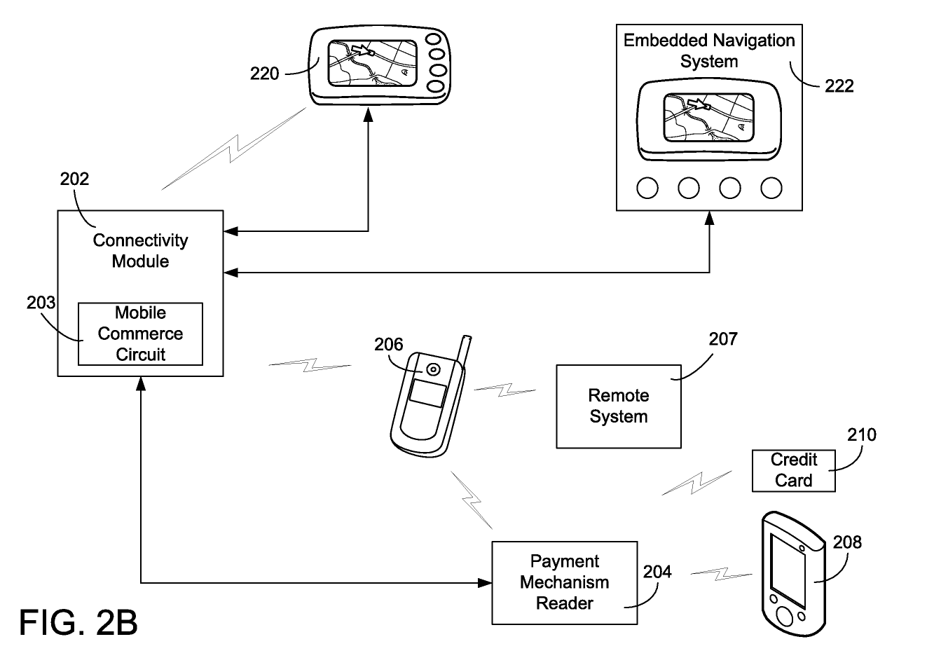

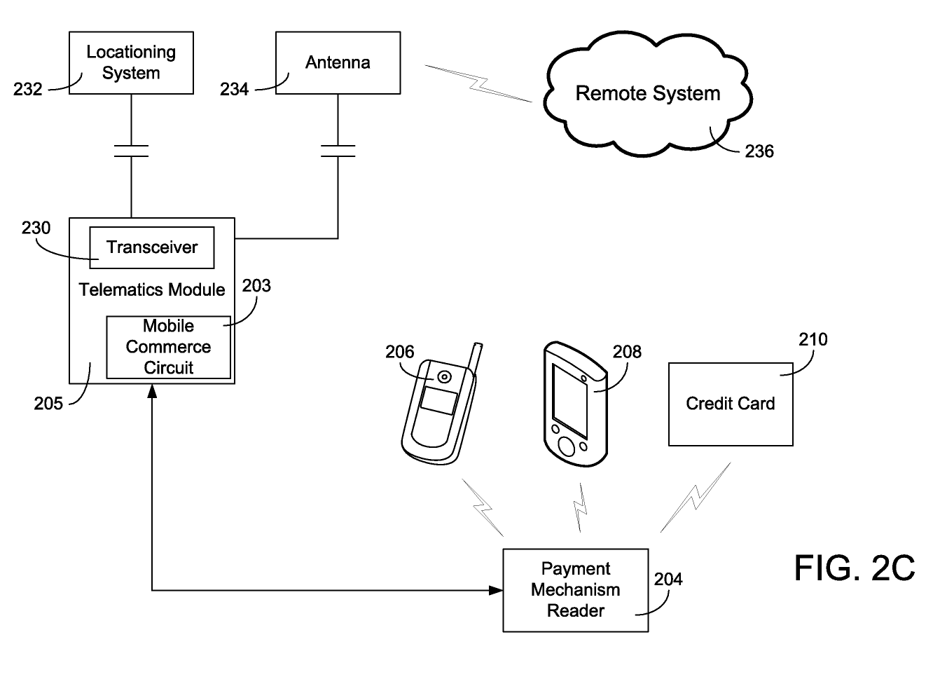

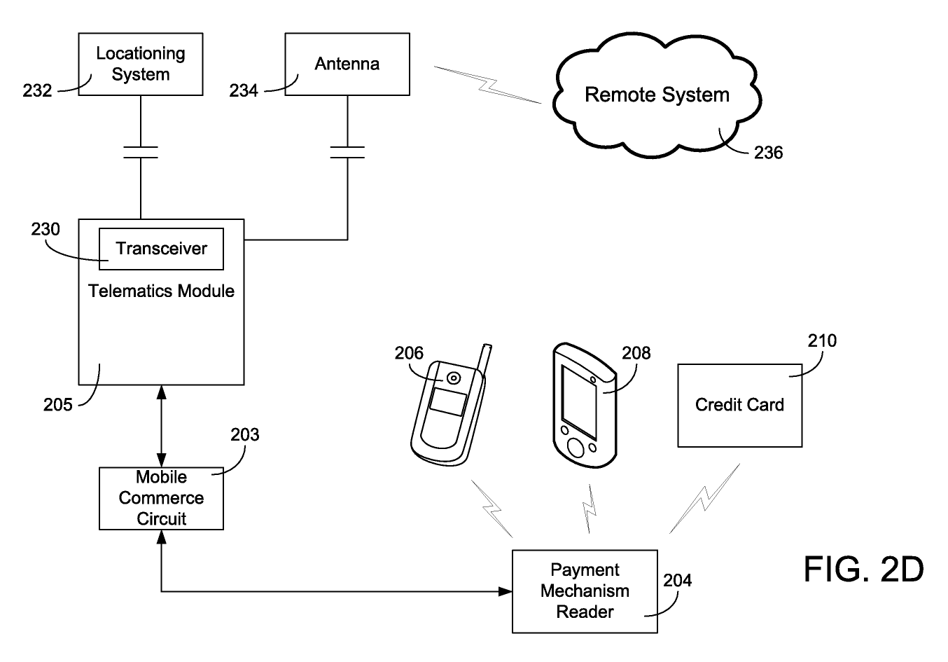

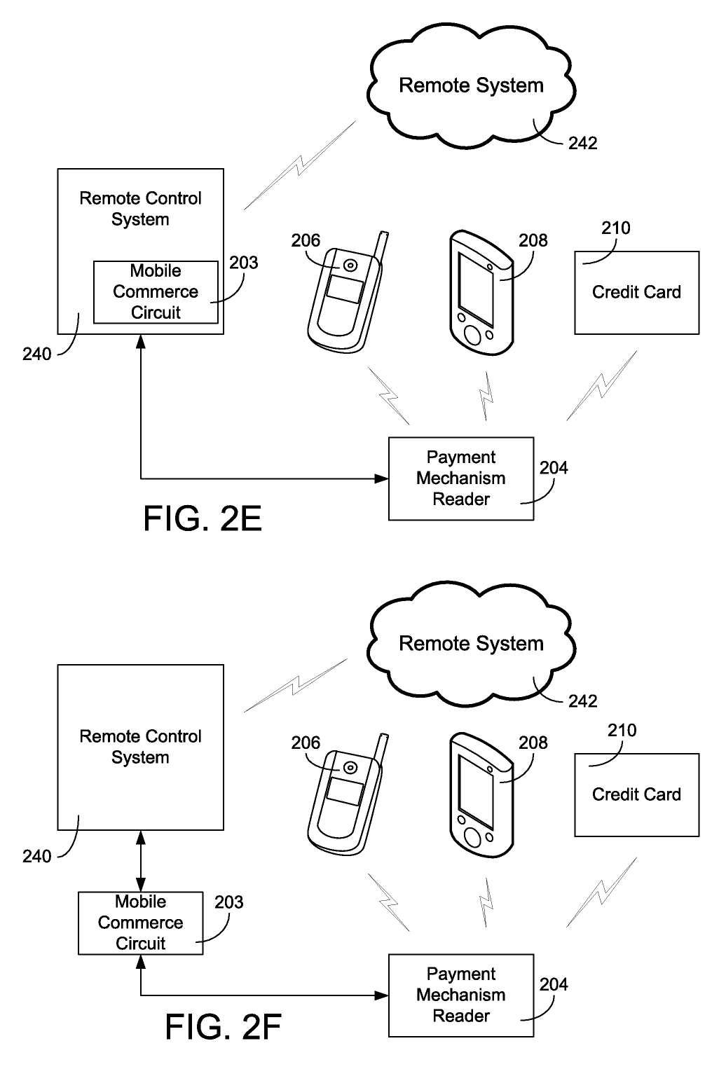

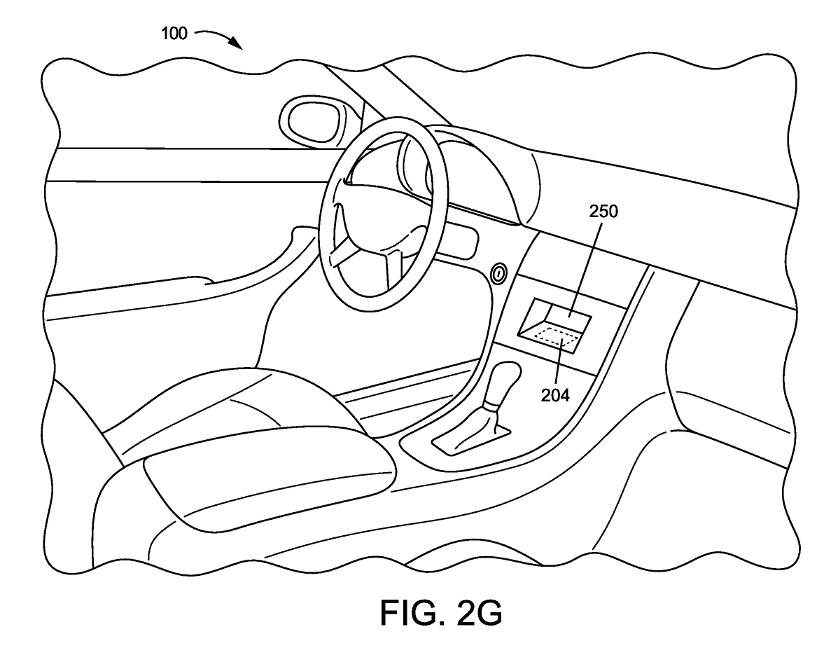

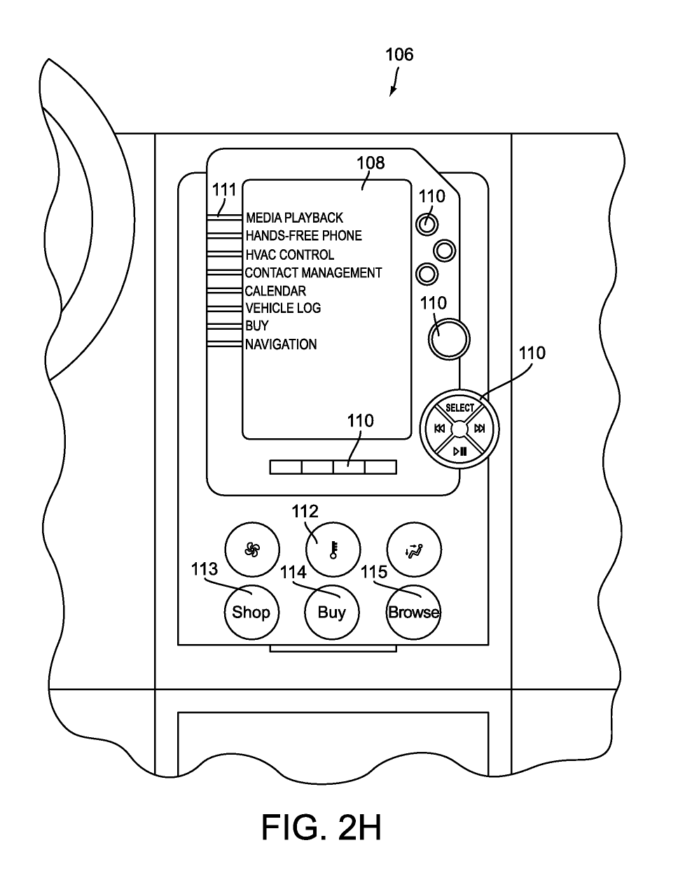

Referring to FIG. 2A, a block diagram of a system for conducting commerce in a vehicle is shown, according to an exemplary embodiment. Connectivity module 202 can be installed (e.g., mounted, integrated, etc.) in a vehicle (e.g., vehicle 100 shown in FIG. 1). Connectivity module 202 is a module (e.g., a circuit, a collection of electronics, a collection of circuits, etc.) configured to form wired and/or wireless connections with devices such as portable electronic device 206 (e.g., mobile phone) brought into the vehicle. Connectivity module 202 can use the connected devices to communicate with a remote system 207 (e.g., connectivity module 202 can cause portable electronic device 206 to send information to remote system 207 and/or receive information from remote system 207). A mobile commerce circuit 203 is shown communicating (e.g., directly, indirectly, wirelessly, wired, etc.) with connectivity module 202. Mobile commerce circuit 203 can include hardware (e.g., a microprocessor, more than one microprocessor, memory, etc.) and software (e.g., executable computer code stored in a memory device) for executing its activities. Mobile commerce circuit 203 can also communicate (e.g., via a wired or wireless connection) with payment mechanism reader 204 to wirelessly receive data (e.g., payment information) from a payment mechanism (e.g., portable electronic device 206, personal digital assistant 208, credit card 210). Connectivity module 202 can communicate with a navigation system such as portable navigation device 220 and/or embedded navigation system 222 to receive information regarding points of interest such as merchants. Mobile commerce circuit 203 can utilize information from the navigation system in a mobile commerce activity (e.g., to select a merchant with which to initiate a transaction).

According to the exemplary embodiment shown in FIG. 2B, mobile commerce circuit 203 is shown as integrated in connectivity module 202. When integrated in connectivity module 202, mobile commerce circuit 203 can share components (e.g., a processor, memory, communications hardware, etc.) with connectivity module 202.

According to the exemplary embodiment shown in FIG. 2C, mobile commerce circuit 203 is shown as integrated in a telematics module 205. Telematics module 205 can be a circuit or set of electronics configured to use a transceiver 230 (e.g., coupled to antenna 234) to communicate with remote system 236 (e.g., directly or indirectly). Telematics module 205 can be coupled to a locationing system 232 for receiving an indication of location. Telematics module 205 is shown as coupled to payment mechanism reader 204 configured to receive data from a payment mechanism (e.g., a mobile phone 206, a personal digital assistant 208, a credit card 210).

According to the exemplary embodiment shown in FIG. 2D, mobile commerce circuit 203 is connected to telematics module 205 via a wired (e.g., via a USB connection, an optical connection, or any other wired connection) or a wireless connection (e.g., a Bluetooth connection).

According to the exemplary embodiment shown in FIG. 2E, mobile commerce circuit 203 is shown as integrated in a remote control system 240 for communicating with remote system 242. Remote control system 240 can be a system configured to wirelessly transmit (e.g., via radio frequency communications) control signals to remote devices (e.g., garage door openers, lighting systems, etc.) when a button or other user interface element is actuated by a vehicle occupant. Remote control system 240 can be, for example, a Johnson Controls, Inc. HomeLink® system. Mobile commerce circuit 203 can cause remote control system 240 to transmit transaction signals, payment information, or other data relevant in a transaction involving the vehicle to remote system 242 (e.g., for forwarding to a merchant, a remote payment processing system, or another system).

According to the exemplary embodiment shown in FIG. 2F, mobile commerce circuit 203 is shown as not integrated but communicating (e.g., via a wired or wireless connection) with remote control system 240.

According to the exemplary embodiment shown in FIG. 2G, an interior of vehicle 100 having a mobile device bin 250 is shown. Mobile device bin 250 can be a structure or area within which a user may place his or her mobile devices including any payment mechanisms (e.g., credit cards, debit cards, identity cards, mobile phones, personal digital assistants, key fobs, etc.). Mobile device bin 250 can be a recess, a pocket, a door, a slot, a cradle, or any other hardware configuration for holding a mobile device. Mobile device bin 250 can be located in a center stack location (as shown in FIG. 2G), a floor console location, an overhead console location, a door location, a floor location, a seat location, a dash location, an instrument panel location, a ceiling location, or at any other location within vehicle 100. Mobile device bin 250 can include a payment mechanism reader 204 as shown in FIGS. 2A-2F. Payment mechanism reader 204 can be a near field communication (NFC) reader or any other reader configured to use induction field communication to receive information from another device. Payment mechanism reader 204 can also (or alternatively) be a smart card reader, an radio frequency identification (RFID) reader, a far field radio frequency transceiver (e.g., a Bluetooth transceiver, an IEEE 802.11 transceiver, a wireless USB transceiver, a ZigBee transceiver, or any other standard or proprietary transceiver configured to communicate with mobile devices). Payment mechanism reader 204 can include circuitry for interpreting data it receives or payment mechanism reader can provide data it receives another circuit (e.g., a mobile commerce circuit, a telematics circuit, a connectivity circuit, etc.) for interpreting and using the data.

Referring now to FIG. 2H, a front elevation view of a user interface of vehicle control system 106 is shown, according to an exemplary embodiment. A vehicle user interface such as that shown in FIG. 2H or otherwise can be used to enter payment information, select a merchant with which to initiate a transaction, make selections from a catalog or menu, identify the user, authenticate the user, or to otherwise receive information and/or provide information to the user.

Vehicle control system 106 is shown to include an output display 108, one or more knobs 112-115, one or more pushbuttons 110, and one or more tactile user inputs or pushbuttons 111, which facilitate controlling various vehicle functions. Output display 108 may be configured to display data related to the control of the vehicle functions. In one exemplary embodiment, output display 108 may be a touch-screen display, while in other exemplary embodiments, may be any other non-touch sensitive display. In still other exemplary embodiments, output display 108 may be of any technology (e.g., LCD, DLP, plasma, OLED, CRT), configuration (e.g., portrait or landscape), or shape (e.g., polygonal, curved, curvilinear). Output display 108 may be a manufacturer installed output display, an aftermarket output display, or an output display from any source. Output display 108 may be an embedded display (e.g., a display embedded in the control system or other vehicle systems, parts, or structures), a standalone display (e.g., a portable display, a display mounted on a movable arm), or a display having any other configuration. Knobs 112-115 and pushbuttons 110, 111 may be configured to control functions of a mobile commerce application, HVAC system such as fan speed, cabin temperature, or routing of air flow, to control playback of media files over the sound system, to control retrieval of phonebook entries, to control a function of a connected remote source, or to control any other desired vehicle function.

Pushbuttons 111 typically allow for the selection and display of various functions of vehicle control system 106 including mobile commerce selections and functions, sound system control, media system control, display system control, communications system control, hands-free phone use, HVAC system control, contact or address/phone book management, calendar viewing and modification, and vehicle data logging. The operation of a pushbutton 111 for media playback may display a media playback menu screen or execute commands that allow the user to view, select, sort, search for, and/or play audio or video files by tactile or oral command. The operation of a pushbutton 111 for hands-free phone operation may display a menu screen or execute commands that allow the user to connect vehicle control system 106 to a mobile phone so that speaking into the vehicle console of vehicle control system 106 operates the mobile phone. The operation of a pushbutton 111 for HVAC control may display a menu screen or execute commands that allow the user to control cabin temperature and air flow by tactile or oral command. The operation of a pushbutton 111 for contact management may display a menu screen or execute commands that allow the user to view, list, select, sort, search for, edit, and/or dial one or more entries containing personal contact information, by use of a tactile or oral command. The operation of a pushbutton 111 for calendar management may display a menu screen or execute commands that allow the user to view, list, select, sort, search for, edit, and/or create one or more entries containing personal schedule information by tactile or oral command. The operation of a pushbutton 111 for vehicle log management may display a menu screen or execute commands that allow the user to input, view, select and/or reset information related to the vehicle operation (e.g., fuel economy, engine temperature, distance to empty, etc.) by tactile or oral command. The operation of a pushbutton 111 for navigation can include selecting one or more points of interest from a map, list, or other graphical user interface provided to display 108. According to an exemplary embodiment, selecting a point of interest can provide a menu item to the user to “shop” from the point of interest, “browse a catalog” from the point of interest, or otherwise initiate a mobile commerce activity involving the point of interest. Upon initiating a mobile commerce activity, the vehicle control system can create a data communications link with a remote source (e.g., an internet source, a merchant, a mobile commerce agent, etc.) to request menu information. The data communications link can then be used to exchange payment information, confirmation information, authentication information, item selection information, a transaction signal, and/or any other data pertinent to the transaction. The information exchanged between the vehicle and the remote source (e.g., the menu information) can be displayed on output display 108 and the buttons or other user interface elements of vehicle control system 106 can be configured/reconfigured to allow the user to make a selection from a displayed menu using the buttons or other user interface elements.

The operation of a pushbutton 113 or an oral command to execute a “Shop” operation may display a menu screen or execute commands that allow a user to view and purchase a product or service. Pushbutton 114 may be used to execute a “Buy” operation and may cause the display of a menu screen or cause the execution of commands that allow a user to input, view, and/or select information or media for purchase and/or download or delivery. Pushbutton 115 may be used to execute a “Browse” operation may display a menu screen that allows a user to look at products or services (e.g., a menu, a catalog, a list of services, a list of goods, a list of media files, etc.) offered for purchase by a merchant or another outside source. Operating a pushbutton 112-115 may include pressing down on the pushbutton, touching the pushbutton, rotating the pushbutton, or otherwise manipulating the pushbutton. It should be noted that while one or more of the user interface elements provided for operation with vehicle control system 106 can be pushbuttons, any number of different types of user interface elements of the past, present, or future may be used.

A pushbutton 110 (and/or any other user interface element(s)) of the vehicle control system 106 may be used to control other vehicle subsystems such as, but not limited to, vehicle door locking systems, vehicle cruise control systems, seat control systems, window control systems, vehicle lighting systems, vehicle radio systems, wireless control systems, media control systems, and/or any other control system that may accept user input.

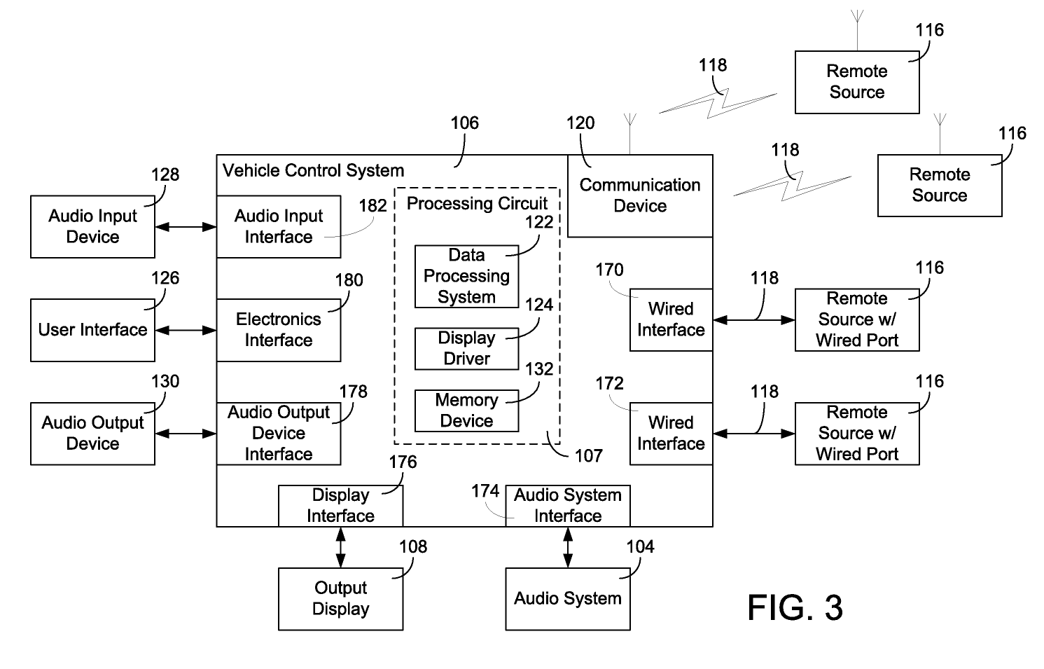

Referring now to FIG. 3, a block diagram of vehicle control system 106 of FIG. 1 is shown, according to an exemplary embodiment. Vehicle control system 106 is configured to communicate with a remote source 116 (e.g., a portable electronic device, a payment mechanism, a mobile phone, a personal digital assistant, a wireless service organization, a remote server, an Internet access point, a mobile commerce agent, a remote payment processing system, a bank network, a merchant, etc.) over a communication link 118. For example, vehicle control system 106 may use communication link 118 to access menu information, order information, confirmation information, point of interest information, media data files, phonebook data files, calendar data, or any other accessible data of use by vehicle control system 106. In some embodiments, vehicle control system 106 may be capable of accessing data files from multiple remote source 116s over a single or multiple communication link 118s. Vehicle control system 106 may send and/or receive requests, signals, files, commands, messages (e.g., text messages, voice messages, etc.), meta information, stream data or information, and any other type of data to and/or from a remote source 116 over a communication link 118.

Vehicle control system 106 is shown to include processing circuit 107, communication device 120, a data processing system 122, a display driver 124, a user interface 126, an audio input device 128, an audio output device 130, an output display 108, and a memory device 132.

Communication device 120 is generally configured to establish communication link 118 with remote source 116. In various exemplary embodiments, vehicle control system 106, using communication device 120, is configured to establish wireless communication links such as with Bluetooth communications protocol, an IEEE 802.11 protocol, an IEEE 802.15 protocol, an IEEE 802.16 protocol, a cellular signal, a shared wireless access protocol-cord access (SWAP-CA) protocol, a wireless universal serial bus (USB) protocol, or any other suitable wireless technology. In another exemplary embodiment, vehicle control system 106 may establish a wired communication link such as with USB technology, IEEE 1394 technology, Firewire technology, optical technology, other serial or parallel port technology, or any other suitable wired link. Communication device 120 may be configured so that communication links may be formed with multiple remote sources and/or so that communication device 120 can simultaneously communicate with multiple remote source 116s. Communication device 120 may send and receive one or more data streams, data strings, data files and/or other types of data (e.g., non-file based data) to and/or from remote source 116. In various exemplary embodiments, the communicated data may include text, numeric data, audio, video, program data, command data, information data, encrypted data, payment date, coordinate data, image data, streaming media, or any combination thereof.

Processing circuit 107 is shown to include data processing system 122, display driver 124, and memory device 132. According to an exemplary embodiment, data processing system 122 or any other processing electronics of processing circuit 107 is communicably coupled to communications device 120 and is generally configured to control each function of vehicle control system 106. For example, data processing system 122 may facilitate speech recognition capabilities of vehicle control system 106 for the convenience of the user. Data processing system 122 may be or include any processing electronics, digital or analog processing components, integrated circuits, other circuitry and/or may be of any past, present, or future design that facilitates control or provides processing features to vehicle control system 106. Data processing system 122 may be a single data processing device or multiple data processing devices. For example, data processing system 122 may be a data processing device having multiple data processing sub-devices or components. Data processing system 122 may include any combination of program software (e.g., stored in a memory device) and hardware capable of providing control, display, communications, input and output features to the vehicle. Data processing system 122 may coordinate, control, and/or facilitate the various devices, components and features of vehicle control system 106 (e.g., communications device 120, output display 108, display driver 124, memory device 132, audio system 104, user interface 126, audio input device 128, audio output device 130, wired interface 170, wired interface 172, audio system interface 174, display interface 176, electronics interface 180, etc.).

Display driver 124 is coupled to output display 108 and is typically configured to provide an electronic signal to output display 108. In one exemplary embodiment, the electronic signal may include text and/or numeric data of information received via communication device 120 or recalled from memory device 132. In another exemplary embodiment, display driver 124 may be configured to control output display 108 with touch-screen capabilities, while in other exemplary embodiments, display driver 124 may be configured to control output display 108 without making use of touch-screen capabilities. Display driver 124 may include any number of functions, software or hardware, to facilitate the control and display of images on output display 108. In still other exemplary embodiments, display driver 124 may be of any past, present, or future design that allows for the control of output display 108.

User interface 126 is typically configured to facilitate tactile user interaction with vehicle control system 106 via electronics interface 180. In various exemplary embodiments, user interface 126 may include pushbuttons or rotatable knobs as in the exemplary embodiment shown in FIG. 2, any similar or dissimilar configuration, or may include other tactile user contact points. User interface 126 may include a graphical user interface (GUI), a voice recognition system or voice user interface (VUI), a text user interface (TUI), and/or any other type of user interface.

Audio input device 128, for example a microphone, is configured to receive the utterance of a user and to provide a representation of the utterance to data processing system 122 for speech recognition so that the functions of vehicle control system 106 may be operated by voice command. Audio output device 130, for example a built-in speaker, is configured to provide the user with an audio prompt of various functions, such as user selection confirmation, payment confirmation, audible requests for user input from a user, etc.

Memory device 132 is configured to store data. The data stored in memory device 132 may be accessed by data processing system 122 or any other processing electronics. Memory device 132 may store data received from remote source 116, data created by data processing system 122 that may be used later, intermediate data of use in current calculation or process, or any other data of use by vehicle control system 106. Memory device 132 can also store executable computer code (or compilable computer code or other computer code that can be transformed into executable computer code) for conducting the various activities described herein. For example, a mobile commerce circuit as described herein can be considered one or more processing devices (and/or other hardware) and computer code stored in memory that the processing device(s) may execute to complete one or more of the commerce-related activities described herein.

Referring still to FIG. 3, vehicle control system 106 is shown to include interfaces 170-182. Interfaces 170-182 can include any hardware and/or electronics configured to communicably couple to each interface's respective connected device. Interfaces 170-182 can include electronics local to vehicle control system 106 which may connect directly or indirectly to remote source 116. In some embodiments, one or more cords, connectors, or other electronics may be included with or between vehicle control system interfaces 170-182 and the remote source 116s.

Audio input interface 182 can be configured to physically couple an audio input device 128 (e.g., via a corded connection) to vehicle control system 106. Signals from audio input device 128 can be received at audio input interface 182, filtered, interpreted, or otherwise processed, and routed or provided to electronics of vehicle control system 106 (e.g., to data processing system 122 or another processing circuit of vehicle control system 106). Electronics interface 180 may be configured to communicably couple to wiring, a harness, or another connection scheme associated with user interface electronics 126. For example, buttons, switches, LEDs or other user interface elements located throughout the vehicle interior may provide signals to and/or receive signals from electronics interface 180. Electronics interface 180 may be configured to control the activity of the connected user interface elements, interpret received signals, and/or to route received signals to appropriate processing circuitry such as data processing system 122. Audio output device interface 178 may be configured to receive audio signals from data processing system 122 or other processing circuitry of vehicle control system 106 and to provide the received audio signals to audio output device 130. Audio output interface 178 may convert digital signals to analog, amplify the signals, normalize the signals, or otherwise before providing the signals (or a transformed version of the audio signals) to audio output device 130. Display interface 176 may be configured to receive control signals from data processing system 122 or other processing circuitry of vehicle control system 106, convert the control signals into analog or digital signals for the particular output display connected to display interface 176, or otherwise configured to provide display information from vehicle control system 106 to output display 108. Audio system interface 174 may be configured to receive signals from data processing system 122 or other processing circuitry of vehicle control system 106 and to route the signals to audio system 104. Audio interface 174 may conduct any number of processing tasks (e.g., A/D conversion, D/A conversion, decoding, normalizing, filtering, etc.) on audio signals prior to providing the audio signals (or a transformed version of the audio signals) to audio system 104. Wired interfaces 170, 172 may include any number of jacks, terminals, solder points, cords, or other hardware for physically coupling a cord or other hardware linkage system formed between wired interfaces 170, 172 and remote source 116 that may include a wired port. Wired interfaces 170, 172 may be, for example, a USB terminal and associated hardware as described below or otherwise. According to other exemplary embodiments, wired interfaces 170, 172 may be proprietary interfaces (e.g., an Apple iPod interface, etc.). Wired interfaces 170, 172 may merely include connectors or terminals for connecting vehicle control system 106 and another device or can be or include the connectors or terminals in addition to electronics (e.g., filters, converters, security circuitry, power charging circuitry) that facilitates the communicative/functional connection between vehicle control system 106 (e.g., and its various processing circuitry) and the connected devices. According to various exemplary embodiments, communication device 120 may be considered an interface for wirelessly connecting vehicle control system 106 and remote or portable devices such as remote source 116.

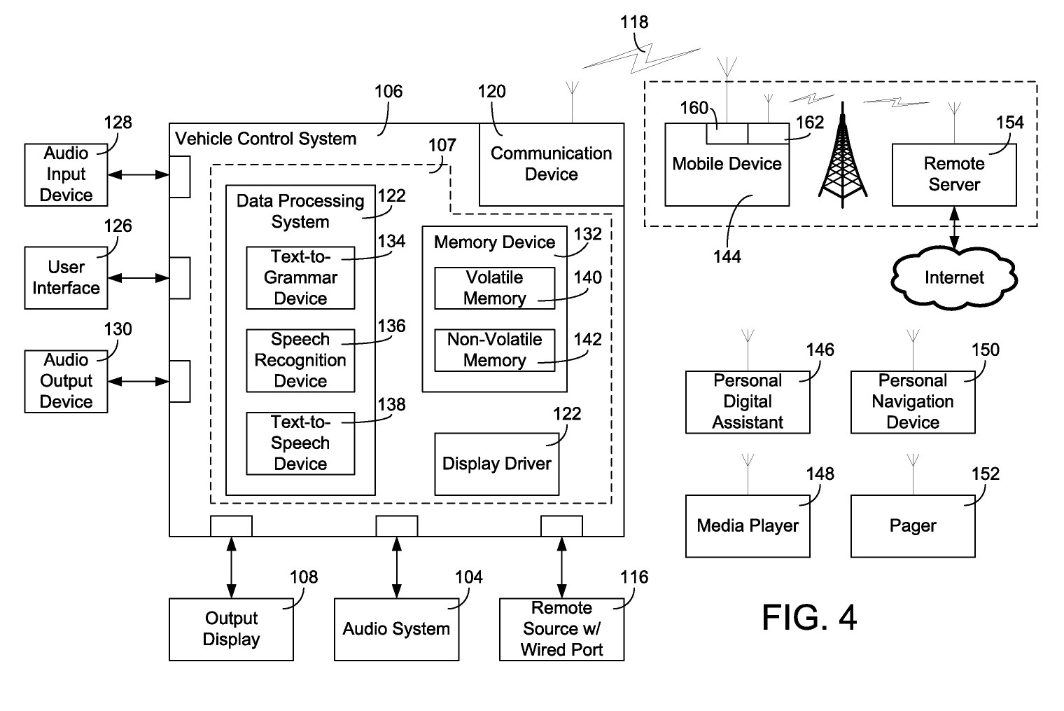

Referring now to FIG. 4, a more detailed block diagram of vehicle control system 106 of FIG. 3 is shown, according to an exemplary embodiment. Vehicle control system 106 can be provided on a single circuit board module or as distributed circuits or processing electronics components. Data processing system 122 may generally include a text-to-grammar device 134, a speech recognition device 136, and a text-to-speech device 138. Data processing system 122 may include any number of additional hardware modules, software modules, or processing devices (e.g., additional graphics processors, communications processors, etc.).

Text-to-grammar device 134 is configured to generate a phonemic representation of the text and/or numeric data it is provided. The phonemic representation of the text and/or numeric data may be used to facilitate speech recognition of the text and/or the numeric data. According to an exemplary embodiment, full files, partial files, or identifiers for files may be converted to a phonemic representation. According to an exemplary embodiment, text-to-grammar device 134 may be able to provide phonemic representations of information received from remote source 116.

Speech recognition device 136 is typically configured to receive an oral input command from a user via audio input device 128. Speech recognition device 136 compares the received oral input command to a set of predetermined input commands, which may have been configured by text-to-grammar device 134. In various exemplary embodiments, the input commands may be related to the playback of a media file, the dialing or input of a phone book entry, the entry or listing of calendar or contact data, the control of the HVAC system, or any other desired function to be performed on data. Speech recognition device 136 may determine an appropriate response to the oral input command received from the user, for example, whether the oral input command is a valid or invalid instruction, what command to execute, or any other appropriate response. According to an exemplary embodiment, speech recognition device 136 may be able to trigger, activate, or facilitate a mobile commerce mode of operation for the vehicle control system when certain commands are recognized. Furthermore, speech recognition device 136 may be able to recognize, interpret, and pass commands to remote source 116 to facilitate interactive control of remote source 116 via a communication link.

Text-to-speech device 138 is generally configured to convert the text and/or numeric data of each data file received from remote source 116 into an audible speech representation. This functionality may allow vehicle control system 106 to audibly provide information to the user via audio output device 130 or audio system 104. For example, vehicle control system 106 may repeat a user selected function back to the user, provide navigational information, announce directions, announce menu options, announce prices, announce payment options, announce payment confirmations, announce media file information, provide phonebook or contact information, or other information related to data stored in memory 132, remote source 116, remote server 154, etc. According to an exemplary embodiment, text-to-speech device 138 may be able to provide an audible speech representation of information received from a remote source 116.

According to various exemplary embodiments, text-to-grammar functionality, speech recognition functionality, and text-to-speech functionality are implemented primarily in software (e.g., stored in memory) and executed by data processing system 122, which may be a general purpose data processing system. According to yet other exemplary embodiments, text-to-grammar functionality, speech recognition functionality, and text-to-speech functionality are implemented partially in software and partially in hardware.

Memory device 132 is shown to include both a volatile memory 140 and a non-volatile memory 142. Volatile memory 140 may be configured so that the contents stored therein may be erased during each power cycle of vehicle control system 106 or vehicle 100. Non-volatile memory 142 may be configured so that the contents stored therein may be retained across power cycles, such that upon vehicle control system 106 and/or vehicle 100 power-up, data from previous system use remains available for the user. According to an exemplary embodiment non-volatile memory 142 may store one or more user profiles, display profiles, communications profiles, navigation profiles, or any other type of user or system setting file. Memory device 132 may store computer code, scripts, object code, or other executable information for activating, completing, and/or facilitating the various exemplary activities described herein when executed by processing electronics of the system (e.g., a processing circuit, a data processing system, a processing module, etc.).

According to an exemplary embodiment, remote source 116 may be any suitable remote source that is able to interface with vehicle control system 106 via a wired or wireless link. In various exemplary embodiments, remote source 116 may be one or more of a mobile device 144, a personal digital assistant (PDA) 146, a media player 148, a personal navigation device (PND) 150, a pager, 152, a remote server 154 that may be coupled to the Internet, a mobile phone, or various other remote data sources. Remote source 116 can include a storage device, one or more processing devices, and one or more communications devices. According to various exemplary embodiments, remote source 116 is a mobile device 144 that may connect to vehicle control system 106 using a first communication device 160 while connecting to the Internet or any other remote source 154 using second communication device 162. Processing electronics of the vehicle control system can be configured to utilize communications electronics such as communication device 120 to provide information to remote source 116 for the purpose of providing the information to remote source 154.

### Systems and Methods for Securely Completing a Mobile Transaction from a Vehicle

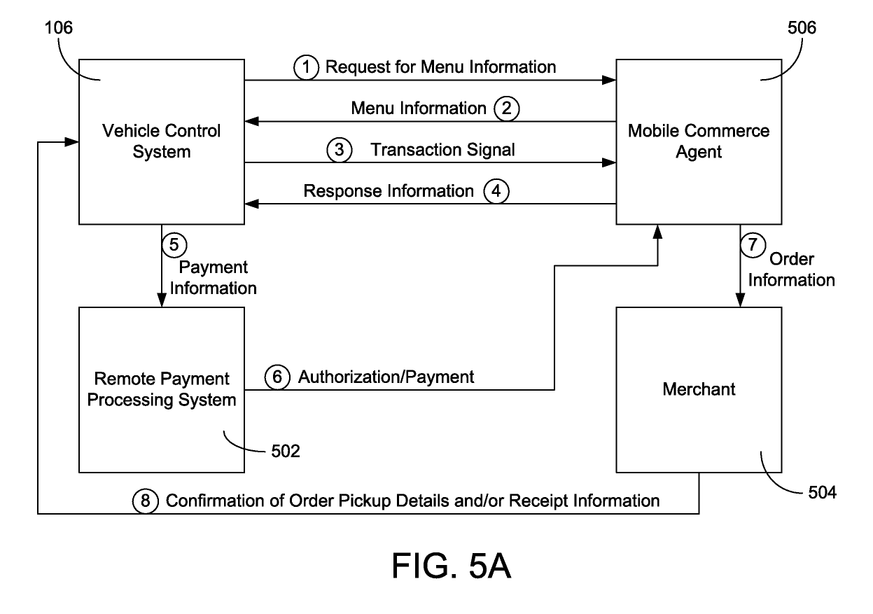

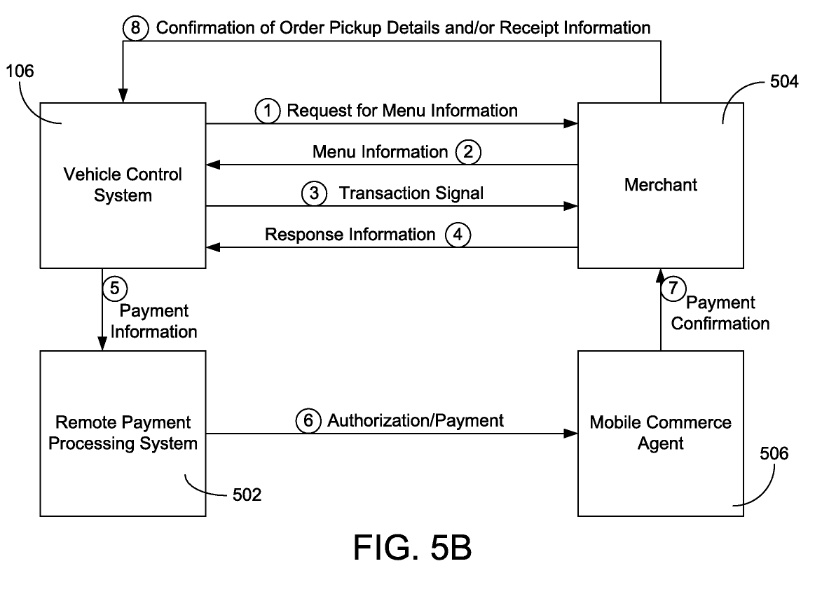

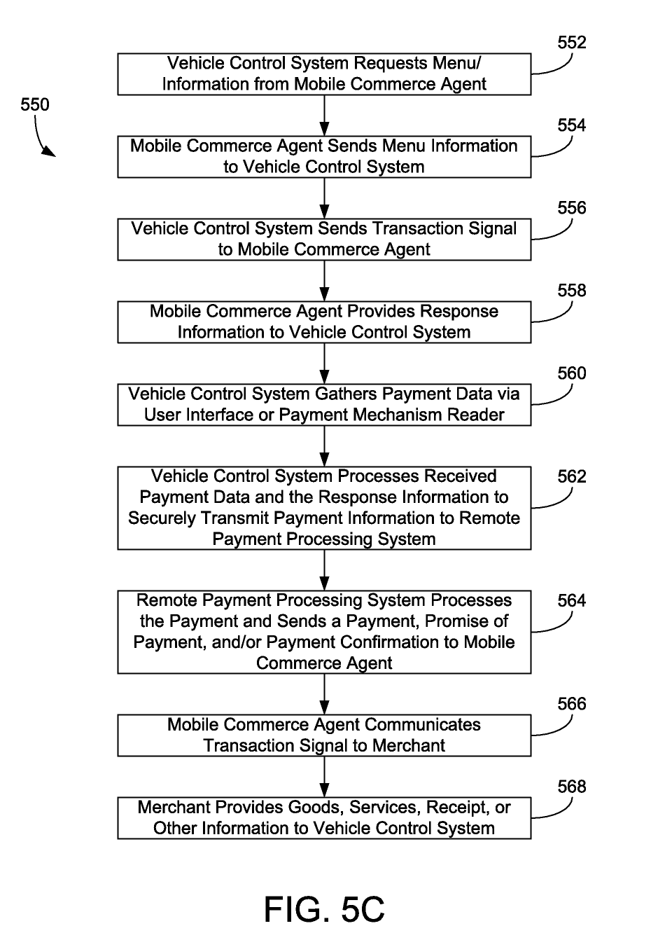

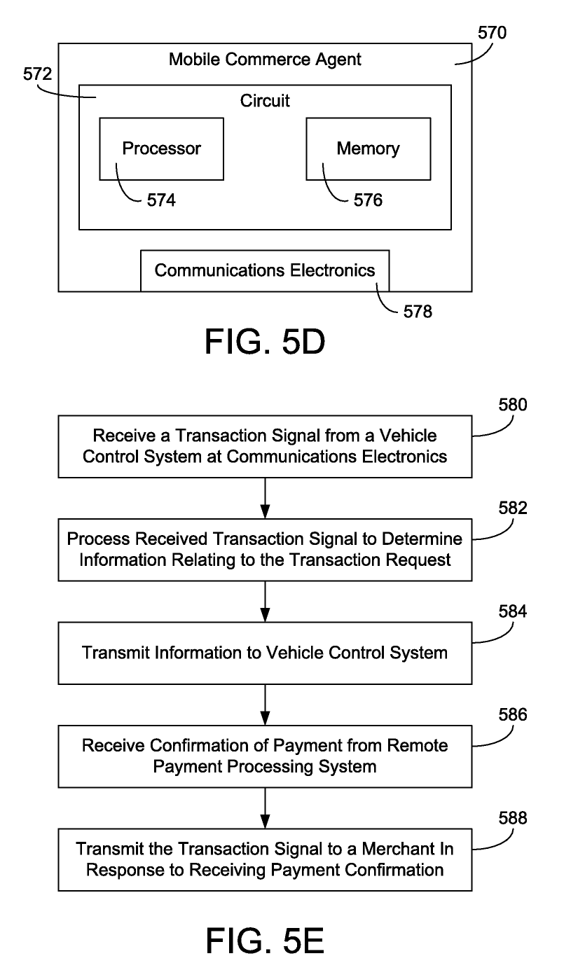

Referring generally to FIGS. 5A-D, various embodiments of a mobile commerce system are described in detail. A mobile commerce system may generally include a vehicle control system, a merchant system, a mobile commerce agent, and a remote payment processing system (e.g., a bank, a bank network). The mobile commerce system may generally allow a user of the vehicle to complete a transaction between the vehicle and merchant, and may use a mobile commerce agent and a payment processing system in order to provide the merchant with payment (e.g., money, other credit, payment information, a promise of payment, etc.) for the transaction.

Referring now to FIGS. 5A and 5B, two exemplary mobile commerce systems are shown, according to an exemplary embodiment. The mobile commerce system may include a remote payment processing system 502 (e.g., a bank, a bank network, other financial institution or system), a merchant 504 (or merchant system) from which products, services, and/or information may be purchased (e.g., the provider of the goods/services once the transaction is complete), and a vehicle control system 106 (e.g., such as the exemplary embodiments shown and described in the present application) of a vehicle.

According to the exemplary embodiment shown in FIG. 5A, vehicle control system 106 can be used to request menu information from a mobile commerce agent 506 (e.g., which may be any remote system configured to facilitate the commerce activity of vehicle control system 106 and/or other mobile commerce systems). Mobile commerce agent 506 can respond to vehicle control system 106's request for menu information by providing the menu information to vehicle control system 106 (e.g., for display and/or playback by a vehicle system). An occupant of the vehicle can select a good or service and place an order with mobile commerce agent 506 by communicating a transaction signal (e.g., transaction request) to mobile commerce agent 506. Mobile commerce agent 506 can be configured to process the transaction signal (or to forward the transaction signal to one or more other systems for processing) and to respond to the transaction signal with response information. Vehicle control system 106 can process the response information and gathered payment data (e.g., account information gathered by a payment mechanism reader or user interface) to securely communicate payment information to a remote payment processing system 502. Remote payment processing system 502 can be configured to authorize the payment information and to send the payment, a promise of the payment, and/or a confirmation of the payment to mobile commerce agent 506 or to another system (e.g., merchant 504). Mobile commerce agent 506, having received the payment, promise of payment, and/or a confirmation of the payment, can provide order information (e.g., a portion of the transaction signal originated by the vehicle control system) to merchant 504 (or a system associated with the merchant) for processing. The merchant 504's processing can include fulfilling the order (or preparing for fulfillment of the order). Accordingly, the merchant can confirm the order, send pick-up details, and/or a receipt to vehicle control system 106 which can provide the information received from merchant 504 to an audio and/or video playback system of the vehicle.

According to an exemplary embodiment, processing the response information and the payment data can include transforming the payment data based on the response information. For example, the vehicle control system can use the response information to encode the payment data, to encrypt the payment data, to compress the payment data, to truncate the payment data, to interleave the payment data, and/or otherwise transform the payment data. In some exemplary embodiments, remote payment processing system 502 is one of a plurality of remote payment processing systems and processing the response information and the payment data can include formatting the payment information for secure transmission to a particular remote payment processing system indicated by the first information. The mobile commerce agent can be configured to provide the first information to vehicle systems in response to receiving transaction signals based on the merchant with which the vehicle control system would like to transact, the payment mechanism (e.g., credit card, mobile phone, etc.) to be used for payment of the goods/services, a remote payment processor with which the vehicle or the vehicle's occupant has subscribed, or based on any other determinations. According to an exemplary embodiment, the mobile commerce agent can be an authentication processor for vehicle control systems. For example, the transaction signal can include, among details regarding the actual order, a vehicle identifier, a customer identifier, a passcode, an account code, or other identifying information. The mobile commerce agent can authenticate that the account is still active, that the account/vehicle has a sufficient payment history, that the account/vehicle has not been stolen, or otherwise—prior to providing the response information back to the vehicle control system so that the vehicle control system can proceed with the transaction with the remote payment processing system and/or with the merchant.

According to an exemplary embodiment, the response information is or includes an identifier of the remote payment processing system. The vehicle control system can use the identifier for the remote payment processing system by transmitting it with the payment information, by directing the payment information to a particular remote payment processing system, to authenticate the payment information sent to the remote payment processing system, to encrypt a portion of the payment data and/or payment information prior to transmission. According to various exemplary embodiments, the response information may be used as at least part of a cryptography key during the encryption of the payment data into the payment information.

According to various exemplary embodiment, the vehicle control system may be configured to gather the payment data using at one or more of: user interface electronics, communications electronics in the vehicle, pre-stored payment data recalled from the memory device, a second receiver configured to receive the payment data from a payment mechanism brought within the vehicle, and/or a wired interface communicably coupling a payment mechanism and the in-vehicle control system. The second receiver may be configured to utilize induction-field communication, near-field communication, or induction-field communication and near field communication to receive the payment data from the portable electronic device. The second receiver can also or alternatively be a Bluetooth transceiver, a radio frequency identification (RFID) receiver, and/or another radio frequency receiver. The payment mechanism may be, for example, a smart card, a mobile phone, a personal digital assistant, a key fob, and a portable navigation device. The vehicle control system can further be configured to provide an indication to an in-vehicle electronic display system and/or an in-vehicle audio playback system based on the confirmation received from merchant 504. The indication can be, for example, a confirmation that the payment information has been accepted by the remote processing system and/or a confirmation that the merchant will respond to the transaction signal by providing a good and/or a service.

Referring now to FIG. 5B, another exemplary embodiment of a mobile commerce system including vehicle control system 106, a merchant 504 remotely located from the vehicle, a mobile commerce agent 506, and a remote payment processing system 502 are shown. In the embodiment shown in FIG. 5B, vehicle control system 106 is configured to primarily communicate with merchant 504 (or a system associated with the merchant). As shown, vehicle control system 106 can be configured to request menu information from merchant 504, receive menu information from merchant 504, transmit a transaction signal to merchant 504, transmit a transaction signal to merchant 504, and to receive response information from merchant 504. Vehicle control system 106 can process the payment data and the response information in a way similar to or different from that discussed above with respect to FIG. 5A and to provide resultant payment information to remote payment processing system 502. Remote payment processing system 502 can authorize the purchase by processing the payment information and send the payment, a promise of the payment, and/or a confirmation of the payment to mobile commerce agent 506 and/or to merchant 504. If the payment, promise of payment, and/or confirmation of the payment is provided to a mobile commerce agent 506, mobile commerce agent 506 can be configured to forward the payment, promise of payment, and/or confirmation of the payment to merchant 504. Mobile commerce agent 506 can be configured to conduct one or more processing activities relating to security or confirmation of the payment. In other exemplary embodiments, remote payment processing system 502 can provide the payment, promise of payment, and/or confirmation of the payment directly to merchant 504 or a system associated therewith.

According to various exemplary embodiments, one or more security measures may be provided to a mobile commerce system (the remote payment processing system, merchant, and vehicle control system) in an attempt to ensure that financial information is not available to the public and/or to hackers. For example, the transceiver and/or communications circuitry provided for a vehicle control system may be configured to encrypt any purchase information transmitted between the vehicle control system and any other system. RF scrambling and/or spread spectrum technologies may be used to provide additional security. The vehicle control system may further be configured with other security technologies (i.e., technologies for safely storing, transmitting, and/or receiving information, technologies for protecting information from unauthorized interception and/or use by third parties). These technologies may include rolling code protection, key code protection, multi-factor authentication, public and/or private key encryption schemes, various cryptography measures, and the like.

Relating further to security, only portions of payment or account data may be transmitted to a remote system at any one time. For example, only the last four digits of the card number may be sent from the vehicle control system to the mobile commerce agent with the transaction signal while other payment data (e.g., the rest of the card number) may be transmitted to a remote payment processing system by the mobile commerce agent. In such systems, the merchant may have pre-stored complete payment information associated with an account for the vehicle. This pre-storing may have occurred, for example, when the user subscribed and/or first signed up for a service of the mobile commerce agent. According to an exemplary embodiment, a payment selection system of the vehicle control system may be configured to allow the user to select which portion of the payment information to send to the merchant system (e.g., different security levels). If a user is not very concerned with security he or she may select a low security level which may correspond to providing complete payment information to the merchant with quick encryption for faster processing or for reception by more merchants.

Relating yet further to security, multifactor authentication may be used by the merchant and supported by the vehicle control system. For example, the vehicle control system may be configured to send a vehicle identifier (e.g., VIN) with the payment information (e.g., credit card information) or the transaction signal. Only if the VIN is expected and previously associated with the payment information will the mobile commerce agent, merchant, and/or other remote system involved accept and/or process the payment information. Other information may be used in place of (or in addition to) the VIN. For example, an address or identifier associated with the transceiver may be used for authentication purposes.

Relating still to security, payment information stored for other purposes may be used as an authentication factor for activities not related to the purchase of goods or services, according to various exemplary embodiments. For example, an access controller (e.g., of a parking structure) may be configured to authenticate an approaching vehicle using stored payment information. Only if the access controller recognizes both the payment information (e.g., last four credit card digits) and vehicle information (e.g., VIN), will the access controller allow the vehicle to pass.

It is important to note that the aforementioned payment activities related to security may occur automatically and/or may occur with varying levels of manual user input. For example, in addition to using pre-stored information for authentication, various user interface activities may also be used for authentication. Payment software stored in memory may be configured so that payment information is not sent until a pre-defined user input activity has occurred to authenticate the user. For example, the payment software may be configured to detect multiple button pushes, a button push plus a voice recognized password and/or command, prompt for and receive a password or personal identification number (PIN) (via GUI, TUI, VUI, etc.). A user interface authentication sequence may be selected by a user of the vehicle control system and stored in memory (e.g., in a configuration file) for use when a payment routine is initiated.

Referring still to security measures that may be utilized in various vehicle control systems, if a key-based encryption scheme is used to transmit payment information from a vehicle to a merchant and/or to another remote system, a key may be passed from the vehicle to the merchant and/or a remote system (or vice versa). According to an exemplary embodiment, the server may send an encryption key (or, e.g., a seed, a distinct secret, a shared secret, a private key, a public key, etc.) to the vehicle. This key may be provided and/or hidden with other information sent to the vehicle prior to purchase (e.g., menu information, price information, etc.). The key may be used by the vehicle to encrypt the payment information for transmission to the merchant and/or remote system. The server may decrypt the payment information using the key and encryption method. According to various other exemplary embodiments, the remote system may receive a key from the server and using the key the server and the vehicle may establish secure communications.

According to various exemplary embodiments, any of the described security features may be implemented as standalone modules or may be included within existing vehicle systems such as a vehicle control system, a garage door opener, etc.

Referring now to FIG. 5C, a flow chart of a process 550 for completing a mobile commerce transaction is shown, according to an exemplary embodiment. Process 550 is shown to include requesting a menu from a mobile commerce agent using a vehicle control system (step 552). The mobile commerce agent sends menu information to the vehicle control system in response to the request (step 554) which may be displayed or played back on a vehicle audio and/or video system. The vehicle control system (e.g., after any number of user interface activities conducted by a vehicle occupant) then sends a transaction signal to a mobile commerce agent (step 556). The mobile commerce agent provides response information to the vehicle control system (step 558) in response to the transaction signal or in response to another request for the information, the request transmitted from the vehicle control system to the mobile commerce agent. The vehicle control system can then gather payment data via a user interface and/or a payment mechanism reader in the vehicle (step 560). In step 562, the vehicle control system processes the response information received from the mobile commerce agent and the gathered payment data to wirelessly and securely transmit payment information to a remote payment processing system. The remote payment processing system can process the payment information and sends a payment, a promise of payment, and/or a payment confirmation to the mobile commerce agent (step 564). The mobile commerce agent can then communicate the transaction signal and/or any other information to the merchant (step 566). The merchant may directly or indirectly provide goods, services, a receipt, or other information to the vehicle control system (step 568).

Referring now to FIGS. 5D and 5E, an exemplary embodiment of a mobile commerce agent configured for use in the systems or methods of FIGS. 5A-5C is shown. Mobile commerce agent 570 is shown to include a circuit 572 including a processor 574 and memory 576. Mobile commerce agent 570 is further shown to include communications electronics that can be used by circuit 572 to send and/or receive data. Circuit 572 (e.g., via execution of computer code stored in memory device 576 or otherwise) can be configured to receive a transaction signal from a vehicle control system (step 580). Circuit 572 processes the transaction signal to determine response information relating to the transaction signal (step 582) and causes the response information to be communicated to the vehicle control system (step 584). Mobile commerce agent can then receive a confirmation of payment (e.g., or a promise for payment or a confirmation of payment) from a remote payment processing system (step 586). Circuit 572 can be configured to communicate the transaction signal (e.g., and or essential order details relating thereto) to a merchant or a merchant system in response to receiving the payment confirmation (step 588).

### Other Exemplary Mobile Commerce Systems

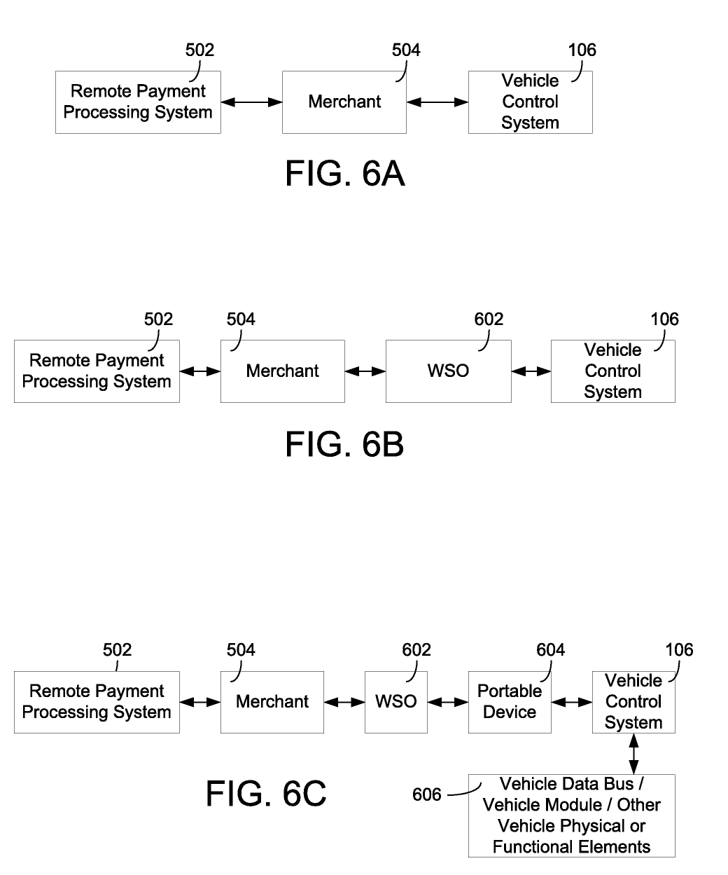

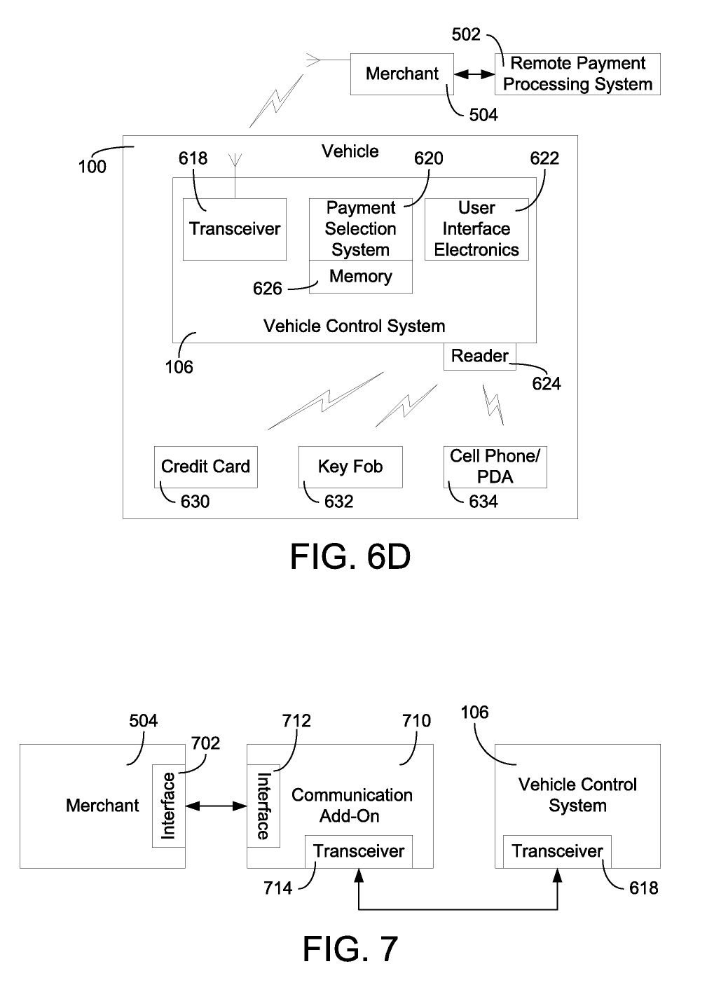

Referring now to FIG. 6A, a block diagram of a mobile commerce system is shown, according to yet another exemplary embodiment. Vehicle control system 106 is configured to communicate directly with merchant 504 via wireless communications. Merchant 504 (or a system associated with merchant 504) can communicate with remote payment processing system 502 to facilitate the transaction. It should be noted that vehicle control system 106 might also directly communicate with remote payment processing system 502 in some exemplary embodiments.

Referring now to FIG. 6B, a block diagram of a mobile commerce system is shown, according to yet another exemplary embodiment. Vehicle control system 106 may be configured to communicate with merchant 504 and/or remote payment processing system 502 via a wireless service organization (WSO) 602 (e.g., a network, a cellular network, a mobile phone network, a WiFi network, a WiMax network, another type of WLAN, etc.). Vehicle control system 106 may reach WSO 602 (indirectly or directly) via a mobile phone or another data communications device controllable by (via wired or wireless communication) and local to vehicle control system 106.

Referring to FIG. 5C, a block diagram of a mobile commerce system is shown, according to yet another exemplary embodiment. Vehicle control system 106 may connect to WSO 602 via a portable device 604. Vehicle control system 106 may also be coupled to a vehicle data bus, a vehicle data module, or other vehicle physical or functional elements 606.

Referring to FIG. 5D, a more detailed block diagram of the mobile commerce system of FIG. 5A is shown, according to an exemplary embodiment. Vehicle control system 106 is shown to include includes a transceiver 618 which may be configured to allow for the transfer of credit card or other purchase information regarding via wireless communications. According to an exemplary embodiment, transceiver 618 may be configured for installation inside a side-view mirror, rear view mirror, or another structure held up and/or somewhat away from other electronics of vehicle 100. Other electronics may be configured for installation in the same housing as transceiver 618, may be integrated with a center stack or console control system, or may be configured for installation elsewhere in vehicle 100. Vehicle control system 106 is further shown to include a payment selection system 620. Payment selection system 620 may be configured to recall or catalog different payment account information, payment preference information, and/or information regarding payment mechanisms brought into the vehicle and detected via reader 624. Payment selection system 620 may be configured to present options regarding the different payment possibilities it recalls or catalogs to a user via, for example, a graphical user interface provided on a vehicle display or a vehicle audio system. Payment selection system 620 may allow a user to scroll or otherwise receive payment options and to make a selection regarding the payment mechanism or information to be used. For example, if reader 624 wirelessly sees a first credit card 630, a key fob that can be used as a payment mechanism 632, and a cell phone or PDA 634 that can be used as a payment mechanism, reader 624 can provide this information to payment selection system 620 and payment selection system 620 can allow the user to select the account associated with the payment option for payment in a mobile commerce transaction.

Reader 624 (e.g., a receiver) may be configured to detect the presence of a payment object (e.g., a credit card 630, a key fob 632, a cell phone or PDA 634) and to gather payment data that may be used to purchase a product, service, or information. Reader 624 may also be configured for one-way communication with the payment mechanism or for bi-directional communication with the payment mechanism. Bi-directional communication may be used, for example, to negotiate secure communications between payment mechanisms 630-634 and vehicle control system 106. Reader 624 may be integrated into or communicably coupled to vehicle control system 106. Reader 624 may be placed or installed in various locations for user convenience (e.g., in or around a seat, in a center console, in a floor console, in an overhead console, in a “purse holder” or other holder of the vehicle, in an instrument panel, etc.). Reader 624 may be located such that the user does not need to remove payment object 630-634 from a wallet or purse. According to various exemplary embodiments, reader 624 may be a short range transceiver (e.g., for communication within 0-10 cm), a medium range transceiver (e.g., for communication within about a meter), or a longer range transceiver (e.g., for communication from anywhere within vehicle 100, for communication when outside vehicle 100, etc.). According to an alternative exemplary embodiment, transceiver 618 used for communication with merchant 604 may also detect and/or read payment object 630-634. In such an embodiment, reader 624 may not be provided.

Payment selection system 620 may include a memory device 626 or may be coupled to a memory device (e.g. memory device 132 of vehicle control system 106). Memory device 626 may store data regarding the payment methods. According to an exemplary embodiment, memory device 626 may store payment methods used previously by a user, and may use the payment method information as stored to execute further payments. According to an exemplary embodiment, the memory may be volatile memory such that the payment method information may be deleted if the information is not used for a specific length of time (e.g., 1 hour, 1 day, etc.). According to another exemplary embodiment, the volatile memory may erase all data when vehicle 100 is turned off.

Payment selection system 620 may include or be coupled to user interface electronics 622 for communicating with a user. For example, user interface electronics 622 may be a voice recognition system or VUI, a GUI, a TUI, or another user interface. According to an exemplary embodiment, user interface electronics 622 may provide the user with options relating to payment methods. For example, user interface electronics 622 may provide the user with known payment options stored in memory 626 and/or detected and may let the user select a payment option stored in memory 626. As another example, payment selection system 620 may be assigned a “preferred” payment method by a user, and payment selection system 620 may use the preferred payment method (e.g., a specific credit card, a debit card, a bank account, etc.) for all transactions, if possible.

User interface electronics 622 may also be configured ask/prompt the user for a payment method not already stored in memory 626. The user may enter a new credit card or account information to provide to payment selection system 620 to use for the current purchase. Payment selection system 620 may then store the new information in memory 626. The user may also provide payment selection system 620 with credit card or account information when not making a purchase, storing the information for further use. The method of providing the information may be made via a VUI, GUI, and/or TUI. Additionally, user interface 622 may include a device to “swipe” a credit card or other object.

According to another exemplary embodiment, payment selection system 620 may automatically detect a payment method without user input. For example, a pre-selected method of payment may be chosen by a user, and payment selection system 620 may be programmed to automatically select and use the method of payment, with or without user confirmation.

According to another exemplary embodiment, payment selection system 620 may automatically detect a payment method via a wireless connection. For example, a user may use a cell phone 630, key fob 632, cell phone or PDA 634, or other device to access an account via a wireless Internet connection. The device may transmit data regarding the online account to payment selection system 620 via the cellular network or a short range wireless technology (e.g., near field communication (NFC)) to carry out financial and identification transactions. As another example, credit card 630 may be a “tag” such that payment selection system 620 or a point of sale (POS) terminal can detect or “tap” credit card 630 and credit card information (e.g., the credit card may have a radio frequency identification (RFID) tag). Additionally, other devices (e.g., key fob 632) may contain a RFID tag or other tag on which account information may be available.

User interface 622 may include a display output (e.g., output display 108 of FIGS. 2-4) to display payment information for the user. For example, if a credit card is detected and/or selected, the credit card type, credit card holder, and/or a portion of the credit card number (e.g., the last four digits) may be displayed. The user may use the displayed information to check if the information is correct and/or for card selection purposes.

According to an exemplary embodiment, transceiver 618 may be the transceiver of a Homelink® remote control system sold by Johnson Controls, Inc. Transceiver 618 may be configured to operate at the same or different frequencies as typical Homelink® transmitters. According to an exemplary embodiment, other wireless control systems (e.g., home automation transceivers, universal transceivers, home security system transceivers, etc.) may be configured to send payment information to merchant 504. According to an exemplary embodiment, vehicle control system 106 may first guide user through a process to train the remote control system for communicating with receiving devices (e.g., garage door opener, etc.) and then guide the user through a process of configuring and/or setting up the payment system. Any payment configurations and/or settings may be stored in memory 626.

Referring to FIG. 7, a block diagram of a merchant 504 communicably coupled to a communication add-on device 710 is shown, according to an exemplary embodiment. A point of sale (POS) terminal may be manufactured with a wireless communication system or a wireless communication system may be added in the aftermarket (e.g., via communication add-on 710). In an aftermarket embodiment, an additional RF device can be added to the existing merchant POS terminal that may enable the new RF link described above. The add-on system may reduce the amount of changes made to the existing POS terminals. For example, communication add-on device 710 may be installed in the vehicle after manufacture as an after-market device as an alternative to a manufactured device such as those shown in FIGS. 6A-6D. Communication add-on device 710 may facilitate communications between vehicle control system 106 and merchant 504. Communication add-on device 710 may include an interface 712 to couple with an interface 702 of merchant system 504, and a transceiver 714 to communicate with a transceiver 718 of vehicle control system 106. Add-on device 710 may be configured to support the security activities, communications activities, logic activities, and/or other activities (e.g., the multi-factor authentication) mentioned in the present disclosure.

### Other Exemplary Processes for Obtaining Products and Services from Merchant

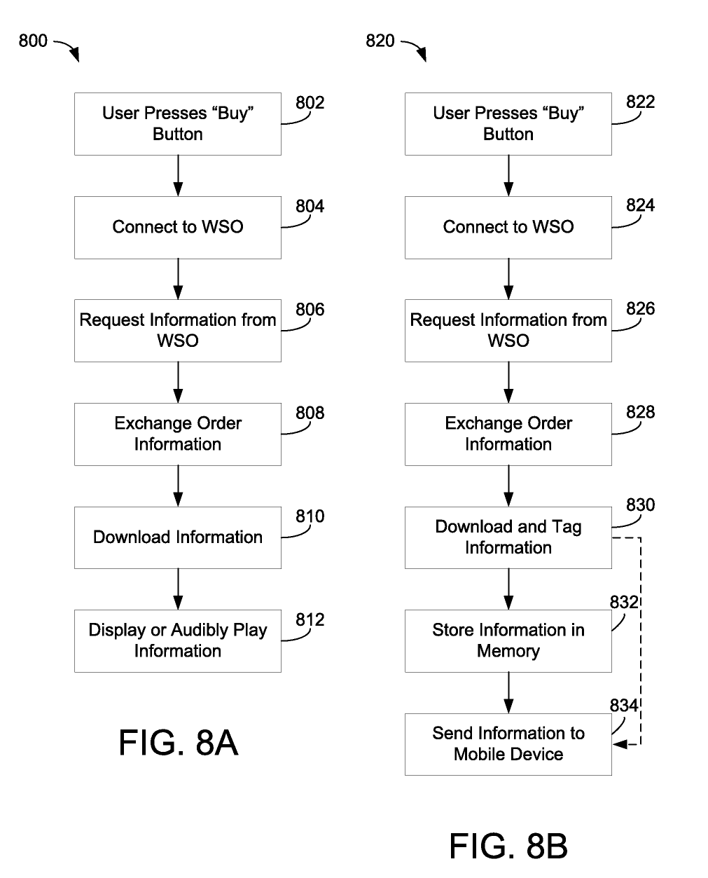

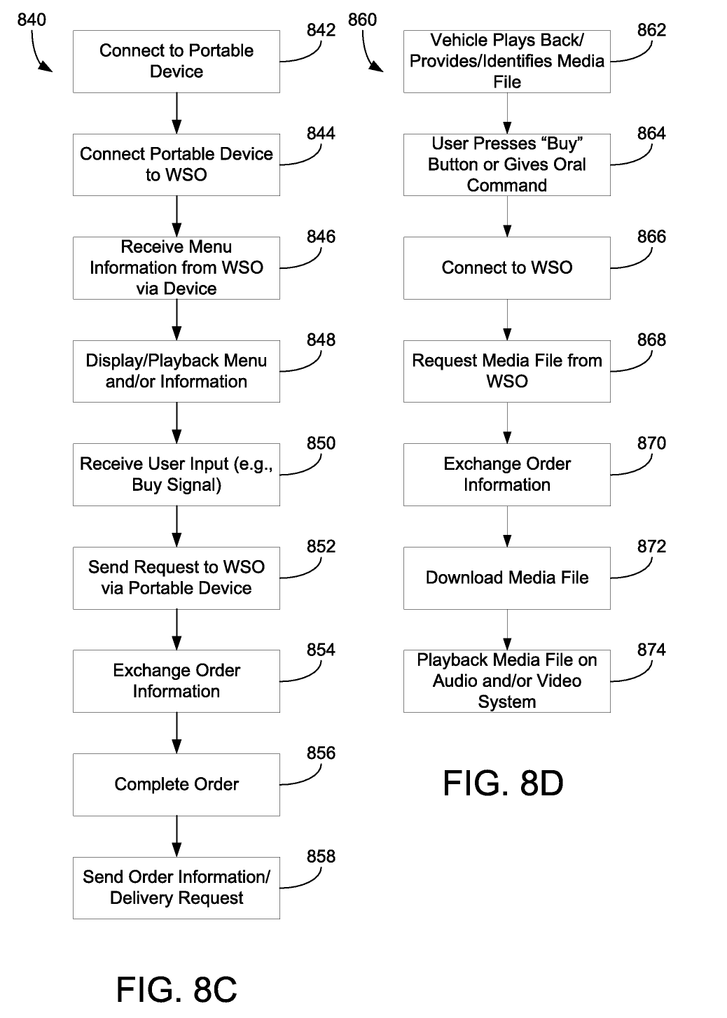

FIGS. 8A-8D are flow charts of processes for using a mobile commerce system (e.g. the mobile commerce system of FIGS. 6A-D) to purchase goods and/or services, according to various exemplary embodiments.

Referring to FIG. 8A, a flow chart of a process 800 for a vehicle control system (e.g., vehicle control system 106) to purchase goods and/or services from a remote source is shown, according to an exemplary embodiment. The goods/services purchase may be or include information such as directions or traffic information, news headlines or other small data sets, or any other kind of information. Process 800 is initialized when a user of the vehicle presses or otherwise activates a “Buy” button, other designated button (e.g., “Shop”, “Browse”), or another user interface element associated with the vehicle control system (step 802). The use of a “Buy” or similarly designated button may vary. According to an exemplary embodiment, a single push or a pressing of the button for a set period of time of the “Buy” button may indicate a preference to obtain the information. The “Buy” button may then “activate” for a set period of time (e.g., 15 seconds, 20 seconds, 30 seconds, longer, or shorter) in which if the button is pressed again, the information (or product or service) may then be obtained. Additionally, a method of using a voice input to supplement or replace a “Buy” button may be implemented. According to various exemplary embodiments, the activation of process 800 via a “Buy” button may be implemented in other ways.

A connection to the WSO is formed (step 804) and a request for information is transmitted to the WSO (step 806) for forwarding to the remote source. The request can identify the information the user wishes to obtain. Order information may be exchanged between the remote source and the vehicle control system (step 808) via the WSO. Order information may include the price of the information, the payment method if the information includes a fee (e.g., credit card information, a promise to pay, etc.), the format in which the product or service will be provided (e.g., a MP3 format for an audible version of news headlines), and/or other information.

The purchased information may then be downloaded by the vehicle control system (step 810). A wireless link may be used to transmit the information from the WSO to the vehicle control system. The vehicle control system can use the information to provide a visual display (e.g., news headlines) or an audio output to an audio output device of the vehicle for a user of the vehicle (step 812). If the information is encoded for security or copyright reasons the vehicle control system may decode the information for display and/or playback in the vehicle.

Referring to FIG. 8B, a flow chart of a process 820 for purchasing goods, services and/or information from a remote source is shown, according to another exemplary embodiment. The process of pressing a “Buy” button, connecting to and requesting information from the remote source via a WSO, and exchanging order information (steps 822-828) may be similar to steps 802-808 of process 800 of FIG. 8A.

Information from the remote source via the WSO may be downloaded to the vehicle control system and tagged (step 830). The information may be tagged by the remote source, the WSO, or the vehicle control system. A tag may be or include an identifier which classifies the information. For example, news headlines may be tagged as either world news, local news, business news, sports news, etc. The information may be stored in memory of a system within the vehicle control system or vehicle (step 832). The tag assigned may be used to sort and select information that is stored in the memory of the vehicle control system (or another system) of the vehicle.

If desired, the user can select that the received information be transmitted to a mobile device, such as a cell phone or PDA (step 834). The information may be transmitted wirelessly or via a wired connection to the mobile device. According to one exemplary embodiment, the information may directly be transmitted to the mobile device without first storing the information in memory and/or in non-volatile memory of the vehicle control system.

Referring to FIG. 8C, a flow chart of a process 840 for using a portable electronic device (e.g., a mobile phone) to place and receive an order for information or a service at a vehicle control system is shown, according to an exemplary embodiment. Process 840 may correspond with the mobile commerce system of FIG. 6C or otherwise. The information may be a media file as described in FIG. 8D. Process 840 may be used to purchase a pre-order of a particular service (e.g., pre-ordering or pre-scheduling an oil change for the vehicle) or any other service or product. Process 840 may be initialized when a portable electronic device is connected to the vehicle control system of the vehicle (step 842). The connection may be made either via a wireless link or via a wired link between the PED and the VCS. Once the portable device is connected and ready for use, the portable device may connect to a WSO (step 844). The connection may be made via a wireless link, according to an exemplary embodiment.

The WSO may detect the connection formed with the portable device and the vehicle control system may receive menu information transmitted from the WSO or a remote source in communication with the WSO via the portable device (step 846). The menu information may be related to any activity detected by the PED, WSO, or remote source (e.g., a song of the radio prompting music-related information, an advertisement prompting appropriate product information, etc.) to be available for playback by the vehicle control system or may simply be general information routinely provided by the WSO. The menu information may be in the form of a list or in the form of various menu options. The menu information may be displayed visually and/or provided audibly for an audio output device of the portable device or of the vehicle for playback (step 848).

A user of the vehicle may view and/or hear the menu information provided via the portable device and may provide a user input in response to be received by the vehicle control system (step 850). For example, the user input may include the pressing of a “Buy” button on the vehicle control system. The user input may relate to a request or desire to purchase a product, service, or information. The vehicle control system sends a request to the WSO and/or the remote source via the WSO using the portable device (step 852).

Once the request is identified by the WSO, order information may be exchanged between the WSO and the vehicle control system (step 854). Order information may include the price of the product, service, or information, the payment method if the product, service, or information includes a fee (e.g., credit card information), the format in which the product, service, or information will be provided (e.g., a MP3 format for an audible version of news headlines), and other information. Once the order information is reviewed and approved by a user of the vehicle, the order may be completed or finalized (step 856).

The information, product, or service ordered may be transmitted to the vehicle control system as described with reference to processes 800, 820 of FIGS. 8A and 8B (step 858) or otherwise. According to another exemplary embodiment, the purchase order may be sent to another location and/or device (e.g., a merchant, to a company or delivery company responsible for distribution of a product or service, a mobile commerce agent, etc.). For example, if the user orders a book, an order may be transmitted to the appropriate company and the book may be delivered to the user's household.

Referring to FIG. 8D, a flow chart of a process 860 for purchasing a media file in a vehicle is shown, according to an exemplary embodiment. The media file may be a song, another audio file, and/or a video clip. The method may be initialized when an event occurs that involves a media file (step 862). For example, the vehicle may play a song from a radio service and the vehicle control system may identify the title of the song, the artist of the song, the genre of the song, or other relevant properties using information transmitted with the song or via a microphone. According to an alternative exemplary embodiment, instead of a media file, driving by a billboard advertisement or other forms of advertisement may trigger an option to purchase a different product or service by receiving information via wireless communication. Step 862 may include identifying characteristics of the song and displaying an option to purchase the media file.

When provided with the option, the user may choose to buy or otherwise obtain the media file (step 864). The user may do so using a “Buy” button on a vehicle control system, via an oral command, or via any other manual or automated input. The option for a user to give such a command may also be available when the vehicle control system detects a related media file. For example, if a particular song comes on the radio, the vehicle control system may automatically activate a mode where a user input indicating a desire to purchase the song may be accepted.

Once user input to purchase or obtain a media file is recognized, a wireless connection may be formed between the vehicle control system and a WSO and/or a remote source with the WSO (step 866). The vehicle control system may request the appropriate media file in a transaction signal (step 868). The media files that may be made available may be of various types. For examples, previews, clips, highlights, complete movies, television shows, or other videos may be purchased, parts of songs or complete songs may be purchased, or any type of audio recording may be purchased.

Order information may be exchanged between the WSO and the vehicle control system (step 870). Once the order information is reviewed and approved by a user of the vehicle (e.g., causing a payment or the promise of a payment), the media file may be downloaded to the vehicle control system (step 872). The media file then may be played back by the vehicle control system (step 674). The media file may be played back on an audio system, video system, or a combination of an audio system and video system.

### Refreshing of Payment Information for Security Purposes

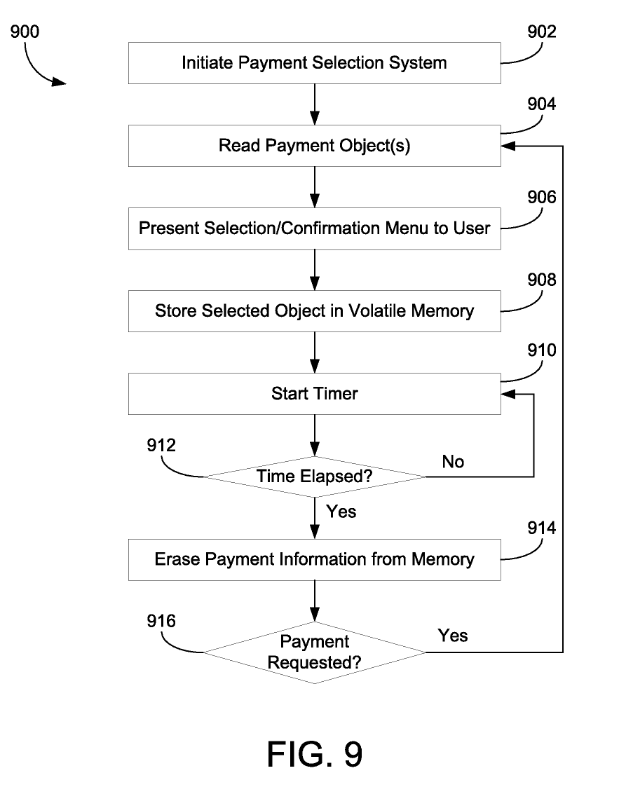

Referring to FIG. 9, a flow chart of a process 900 for storing and deleting payment information (e.g., an account identifier, a credit card number, a bank number, a routing number, an account identifier and password, etc.) using a payment selection system (such as payment selection system 620 of FIG. 6D or a payment selection system of a mobile commerce circuit) in a vehicle control system is shown, according to an exemplary embodiment. The payment selection system may be initialized (step 902) in a variety of ways. For example, the system may be initialized once a purchase request is formed by a user of the vehicle control system. According to another exemplary embodiment, the vehicle control system may receive a signal from a merchant with regard to the purchase request, the signal causing the payment selection system to initiate so that the vehicle control system can transmit payment information relating to the payment request to the merchant.

The payment selection system may read a payment object or objects (e.g., a credit card, a mobile phone, a smart card, a personal digital assistant, a key fob, a government identification card, etc.) (step 904). Alternatively, the payment selection system may obtain the payment information from memory associated with the vehicle control system.

If multiple payment objects or stored accounts are available for use in a transaction, the available payment objects may be presented in a menu (or other data format) to the user of the vehicle via a GUI, VUI, and/or TUI (step 906). The user may select and/or confirm a particular payment object and/or account. A confirmation may be provided via an interface of the vehicle control system, via a receipt or other output object that may be provided to a user in the vehicle or otherwise delivered to the user (e.g., via text message, e-mail, display on a vehicle display system, via playback on an audio system, etc.).

The payment information regarding the selected object and/or account may be stored in volatile memory (step 908) of the vehicle control system. According to an exemplary embodiment, a timer is started when the payment information is first stored in volatile memory (step 910).

A determination may be made as to whether the timer has expired (step 912). If the time period has elapsed, the payment information may be removed from memory (step 914). Process 900 may remain idle until a new payment is requested, initializing the payment selection system (step 916). For example, the system may be configured to delete all payment information after a specific time period (e.g., 1 hour, 2 hours, 1 day, etc.). The timer may be set to count down a specific time period for retaining the payment information when the payment information is first stored into volatile memory. If the payment information was already in volatile memory, the timer may reset to the original specific time period and begin counting down again (to step 910). According to an alternative exemplary embodiment, the timer system as described may be omitted and the process of erasing data in volatile memory may occur when a vehicle is turned off, after receiving a user input, in response to an alarm triggered by a key fob, in response to a request received at communications electronics of the vehicle control system, or can be triggered via other methods (e.g., voice command).

According to other exemplary embodiments, payment information is not periodically erased from vehicle memory as detailed in process 900 or otherwise. In these embodiments, the vehicle control system may be configured with other security measures so that others using the car (e.g., a valet, a nanny, a relative, a crook, etc.) cannot make unauthorized payments. Such a system may include a feature that disables payment and/or locks stored payment information from access whenever the vehicle is: (a) turned off, and/or (b) when the vehicle determines that the user has left the vicinity of the vehicle. For example, in the scenario where the valet uses the car, the car may not be turned off when handed from the driver to the valet. Rather than provide the valet with access to payment features and/or payment information, the vehicle control system may be configured to associate a portable device unique to the driver with authorization. For example, the user may associate a certain key fob, mobile phone, PDA, or particular credit card with an authorized user/driver of the vehicle. If the key fob, mobile phone, PDA, or particular card are detected by the payment system (e.g., within meters of the vehicle), the vehicle may unlock payment information stored in the vehicle and/or enable or unlock the payment system in the vehicle. In the same or other embodiments, the vehicle may be configured to disable the payment system or to lock payment information when the fob, phone, PDA, or particular card are not detected (e.g., the user and his or her valet walk away from the car). A user may be able to bypass this security measure with a TUI or GUI, for example, by entering a password, answering a security question, saying a word that is voice recognized, or otherwise.

### Service/Gas Station Payment

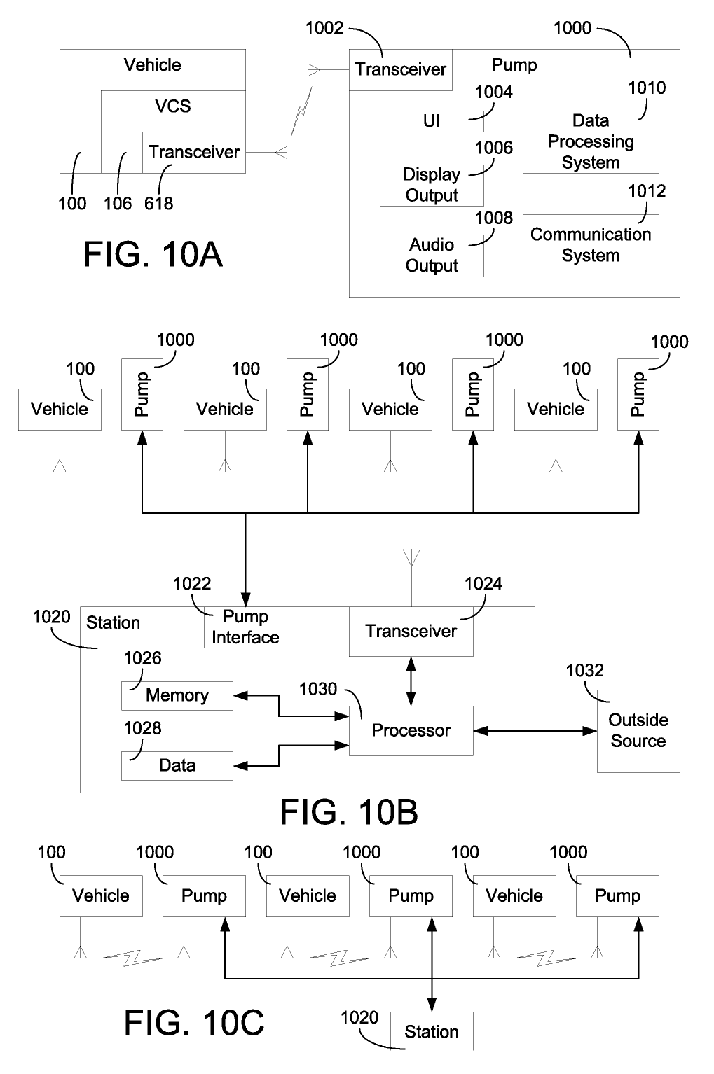

According to one exemplary embodiment, merchant 504 of FIGS. 6A-6D may be a service station or similar station. The service station may provide fuel for vehicles and other vehicle-related services. According to another exemplary embodiment, a user may communicate with the fuel pump of the service station rather than the actual service station. Referring generally to FIGS. 10-15, systems and methods for use with a service station or fuel pump of the service station as a merchant are described in greater detail.

Referring now to FIG. 10A, a block diagram for a system of communication between a vehicle 100 and a fuel pump 1000 is shown, according to an exemplary embodiment. Vehicle control system (VCS) 106 of vehicle 100 includes transceiver 618 as described in FIG. 6D. Transceiver 618 of vehicle control system 106 may communicate with a transceiver 1002 of fuel pump 1000.

Fuel pump 1000 may include a user interface (UI) 1004. UI 1004 may include various pushbuttons, tactile inputs, and/or other UI elements for entering information, selecting fuel octane, selecting payment methods, and the like. Fuel pump 1000 may include a display output 1006 configured to display information for a user of vehicle 100 (e.g., the status of fueling, the number of gallons pumped into the vehicle, etc.). Fuel pump 1000 may additionally include an audio output 1008 for providing an audible message or warning to the user. Fuel pump 1000 may include a data processing system 1010 to process data entered by a user or to perform any other task. Fuel pump 1000 is also shown to include a communication system 1012 configured to create a connection with other systems. For example, pump 1000 may use communication system 1012 to connect wirelessly to a remote payment processing system to complete a transaction of a payment. As another example, pump 1000 may connect via a wired or wireless connection to the service station to relay and/or request information.

Referring to FIG. 10B, a block diagram of a system for mobile commerce communications between multiple vehicles 100, a service station 1020, and multiple pumps 1000 is shown, according to an exemplary embodiment. The transceivers in vehicles 100 (e.g., via a telematics and/or connectivity module) may create a wireless link with a transceiver 1024 of service station 1020.

Service station 1020 may include a processor 1030 that receives input from transceiver 1024. Processor 1030 may be coupled to memory 1026 and/or a database 1028. Memory 1026 and database 1028 may store information regarding previous vehicle use and previous visits of a vehicle 100 to service station 1020, fuel prices, other services offered by the service station, etc. Processor 1030 may receive a payment request and other vehicle information from a vehicle 100, and may use memory 1026 and database 1028 to provide a response for vehicle 100.

Processor 1030 of service station 1020 may also communicate with an outside source 1032, for example, the remote payment processing system of FIGS. 6A-6B. According to one exemplary embodiment, processor 1030 may receive data regarding payment information, and the data may be sent to outside source 1032. Upon confirmation of the payment, service station 1020 may send a response back to vehicle 100 to confirm the transaction.

Service station 1020 may include a pump interface 1022 used to communicate with the various fuel pumps 1000 of the station. Service station 1020 may receive data from vehicles 100 regarding the fuel pumps 1000 the vehicles are using, and service station 1020 may connect to the appropriate fuel pump 1000 and provide information to a user of vehicle 100 through a user interface, display output, or audio output of fuel pump 1000. Fuel pumps 1000 may have the functionality as described in FIG. 10A or otherwise.

Referring to FIG. 10C, a block diagram of a system for communications between multiple vehicles 100, a service station 1020, and multiple pumps 1000 is shown, according to another exemplary embodiment. Each vehicle 100 may wirelessly connect to a fuel pump 1000 vehicle 100 is parked at or is approaching. Each fuel pump 1000 may communicate with service station 1020, either via a wired or wireless link. A fuel pump 1000 may receive payment information from vehicle 100 and transmit the information to service station 1020 and/or to another system (e.g., a mobile commerce agent, a RPPS, etc.). Service station 1020 may also (or alternatively) communicate with a bank or other outside source to execute the transaction.

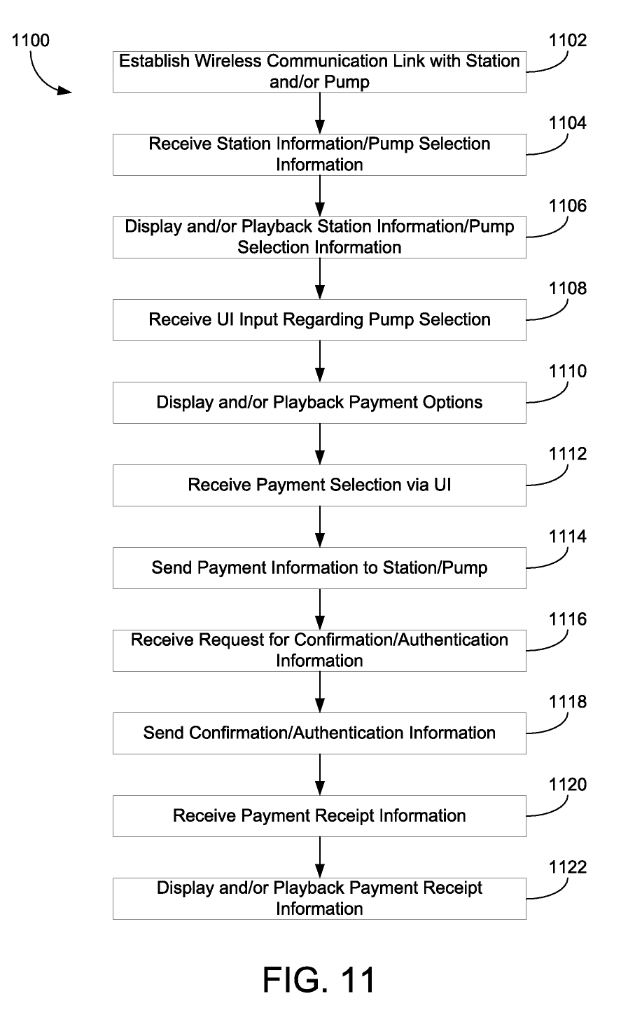

Referring to FIG. 11, a flow chart of a process 1100 for a vehicle control system communicating with a service station and/or a pump is shown, according to an exemplary embodiment. The vehicle control system may form a wireless communication link with the service station and/or pump (step 1102). According to an exemplary embodiment, the vehicle control system may communicate with the pump via systems as shown in FIG. 10A or otherwise.

The vehicle control system may receive (step 1104) and display and/or playback (step 1106) service station and/or pump selection information. Service station information may include the price of fuel and services and products offered. Pump selection information may include an indication of available pumps at the service station. The vehicle control system may receive a UI input relating to a pump selection (step 1108).

The vehicle control system may display and/or playback payment options for the user of the vehicle (step 1110). The payment options may be options determined and presented by a payment selection system of the vehicle control system. The vehicle control system may receive payment selection input from the user (step 1112). The payment selection may be completed via a user interface of the vehicle control system, or the vehicle control system may detect a user choice via a wireless link (e.g., a link to a cell phone, an NFC handset, PDA, via an RFID tag on a credit card, etc.). According to one exemplary embodiment, the payment information could be sensed when the vehicle is started and stored in the vehicle electronics. Once the vehicle is turned off, the information may be erased. Once the payment information is sensed and/or determined by the vehicle, the payment information may be sent to the service station and/or pump (step 1114) (e.g., on user input, when a purchase is made, etc.).

A request for confirmation and/or authentication information regarding the payment is received from the service station and/or pump by the vehicle control system (step 1116). The confirmation and/or authentication information (e.g., a PIN number entered on a keypad or other tactile input, a voice command, etc.) is sent by the vehicle control system back to the service station and/or pump (step 1118). The vehicle control system may have the confirmation and/or authentication information stored in memory, or a user of the vehicle may provide the information when prompted by the vehicle control system (e.g., via voice authentication, authentication by a tactile selection, etc.). The vehicle control system may receive payment receipt information (step 1120) and may display and/or playback the payment receipt information for the user of the vehicle (step 1122). The receipt information may alternatively be sent to a handset or mobile device that may be connected to the vehicle.

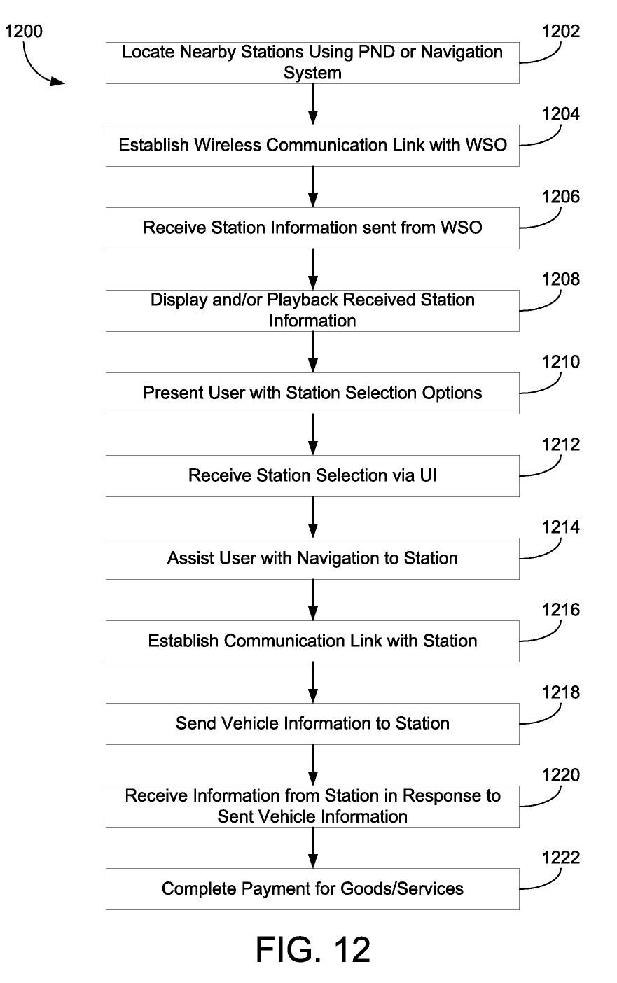

Referring to FIG. 12, a flow chart of a process 1200 for locating, choosing, and communicating with a service station using a vehicle control system is shown, according to an exemplary embodiment. Nearby service stations may be located using a PND or another navigation system coupled to the vehicle control system (step 1202). A wireless communication link may be established with a WSO or other remote system (step 1204). Station information regarding nearby stations determined by the PND or other navigation system may be received from the remote source or the WSO by the vehicle control system (step 1206).

The vehicle control system may display and/or playback the received station information (step 1208). Station information may include station location, distance to station, fuel prices for each station, etc. In addition, the vehicle control system may present a user with station selection options (step 1210). According to an exemplary embodiment, the vehicle control system may present the user with station selection options if stations are nearby. According to another exemplary embodiment, the vehicle control system may provide the station options if the user of the vehicle requests the options. According to yet another exemplary embodiment, the vehicle control system may present station information for the closest service station (or most desired service station based on other properties such as fuel prices) with or without providing the user with a choice of stations. The station selection options and/or station information may be provided via a VUI, GUI, TUI, or any combination thereof. The options and/or information may be displayed as a map with labeled markers to illustrate the relative location of the stations to the vehicle, as any type of menu or list, or otherwise.

The vehicle control system may receive a station selection via a UI of the system, according to an exemplary embodiment (step 1212). According to another exemplary embodiment, the vehicle control system may pre-select the station for the user of the vehicle (e.g., the nearest or next station). The vehicle control system may use a PND or navigation device to assist the user in navigating the vehicle to the station (step 1214).

When the vehicle is within wireless range of the station, the vehicle may establish a communication link with the station (step 1216). The communication link may also (or alternatively) be established via an Internet connection. Vehicle information may be sent to the station (step 1218) and information from the station in response to the sent vehicle information may be received by the vehicle control system (step 1220). The vehicle control system may initialize and complete the payment for goods and services of the service station as described in process 900 of FIG. 9, otherwise in this disclosure, or otherwise (step 1222).

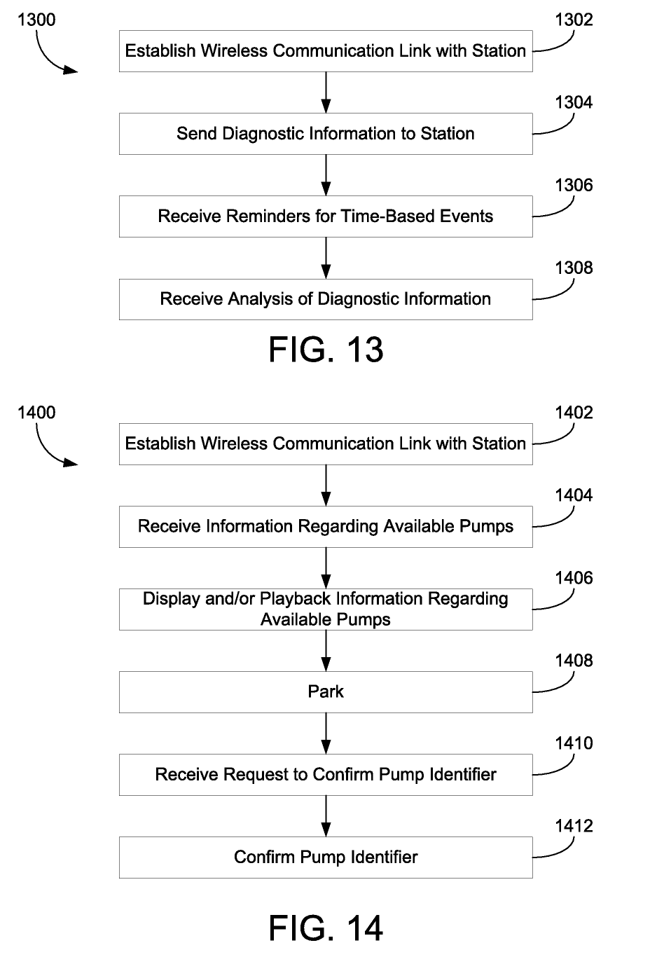

Referring to FIG. 13, a flow chart of a process 1300 for communicating other information between a vehicle control system and a service station is shown, according to another exemplary embodiment.

A wireless communication link may be established with a service station (step 1302), and diagnostic information may be sent from the vehicle control system to the service station (step 1304). Diagnostic information may include the oil level, washer fluid level, tire pressure, fuel level, error codes, and various states of the various components and devices of the vehicle.

The service station may provide the vehicle control system with reminders related to time-based events (step 1306). For example, the service station may store data and records regarding the last time the vehicle was at the service station for an oil change, and may alert to the vehicle control system if the vehicle is due for another oil change. In addition, the service station may detect if a time-based event is necessary without the use of stored data and records of the service station (e.g., if the diagnostic information provided indicates that the vehicle has gone without an oil change for a specified distance and/or time period, the service station may provide a reminder to the vehicle).

The service station may also provide the vehicle control system with an analysis of the diagnostic information (step 1308). The analysis may include an analysis of error codes provided by the vehicle control system. Other analysis may refer to warnings (e.g., if an oil level or tire pressure level is low) or may simply refer to a performance evaluation of the vehicle.

According to various exemplary embodiments, the vehicle may receive information from the service station that includes music, maps, movies, points of interest, vehicle information, personalization settings, etc. The information may include a “pay for use” option requiring the user to purchase the content.

Referring to FIG. 14, a flow chart of a process 1400 for selecting a pump at a service station using a vehicle control system is shown, according to an exemplary embodiment. A wireless communication link may be established between the service station and vehicle control system (step 1402). The vehicle control system may receive information from the service station regarding available fuel pumps at the station (step 1404), and may display and/or playback the information (step 1406).

The user may park at a fuel pump (step 1408) and the vehicle control system may receive a request from the service station to confirm the pump identifier of the chosen fuel pump (step 1410). The user may confirm the pump identifier of the fuel pump using the vehicle control system (step 1412). Additionally or alternatively, the user may use the user interface of the fuel pump to confirm that the user has selected the fuel pump. The pump identifier may be a color or colors, letters, numbers, any other identifier, or any combination thereof.

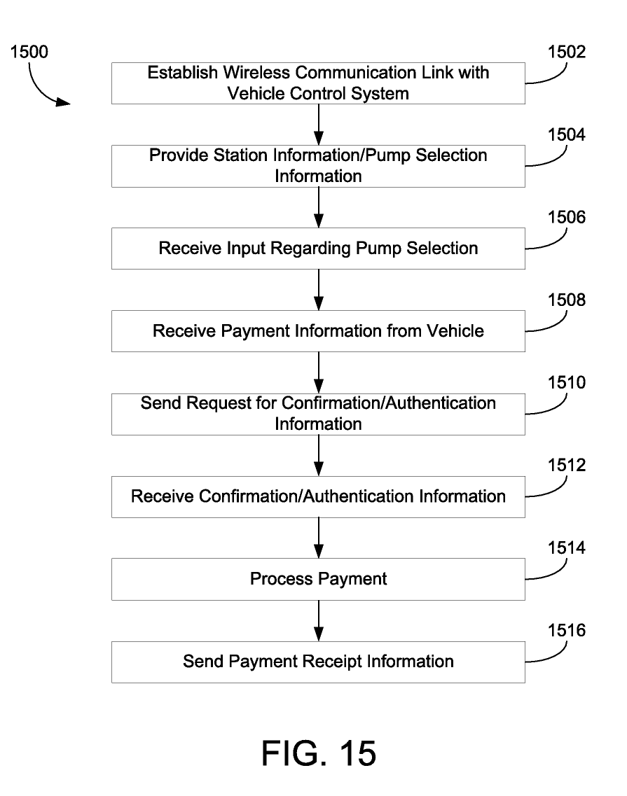

Referring to FIG. 15, a flow chart of a process 1500 for a service station or fuel pump communicating with a vehicle control system is shown, according to an exemplary embodiment.

The service station and/or fuel pump establishes a wireless communication link with the vehicle control system (step 1502). Information related to the service station or fuel pump may then be provided to the vehicle control system (step 1504). For example, the service station or fuel pump may provide information related to vehicle services available (e.g., oil change, car wash, tune-up, etc.), products for purchase (e.g., product name, price, etc.), fuel type available, coupons or specials, etc. If the user desires to purchase fuel for the vehicle, he or she may then make a fuel type and/or pump selection via the vehicle control system (e.g., by voice command, by tactile input, etc.) and the fuel pump may receive the selection from the vehicle (step 1506). The fuel pump and/or service station may then receive payment information from the vehicle (step 1508). The fuel pump and/or service station sends a request to the vehicle for confirmation and/or authentication information (step 1510). The fuel pump and/or service station may then receive a confirmation for a purchase or authenticating information via a user provided vocal command or tactile input on the vehicle control system (step 1512). Once authenticated or confirmed, the fuel pump and/or service station processes the payment (step 1514) and sends a payment receipt to the vehicle (step 1516).

It should be noted that the pump, station, and/or fueling of the aforementioned embodiments may be related to gasoline and/or any other energy providing technology (e.g., electrical).

### Parking Payment and Information

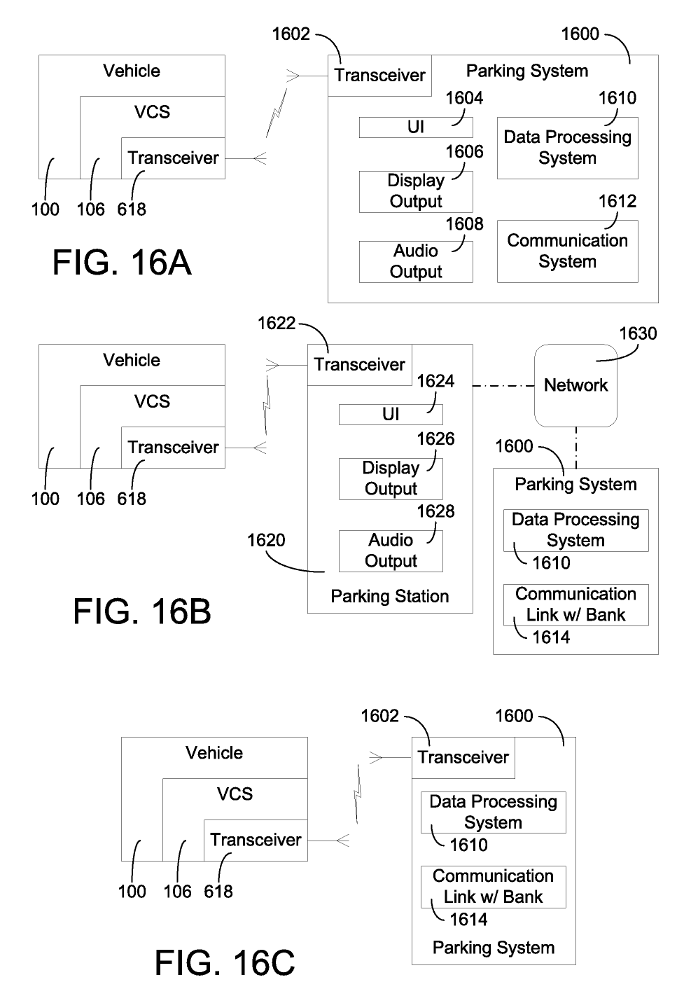

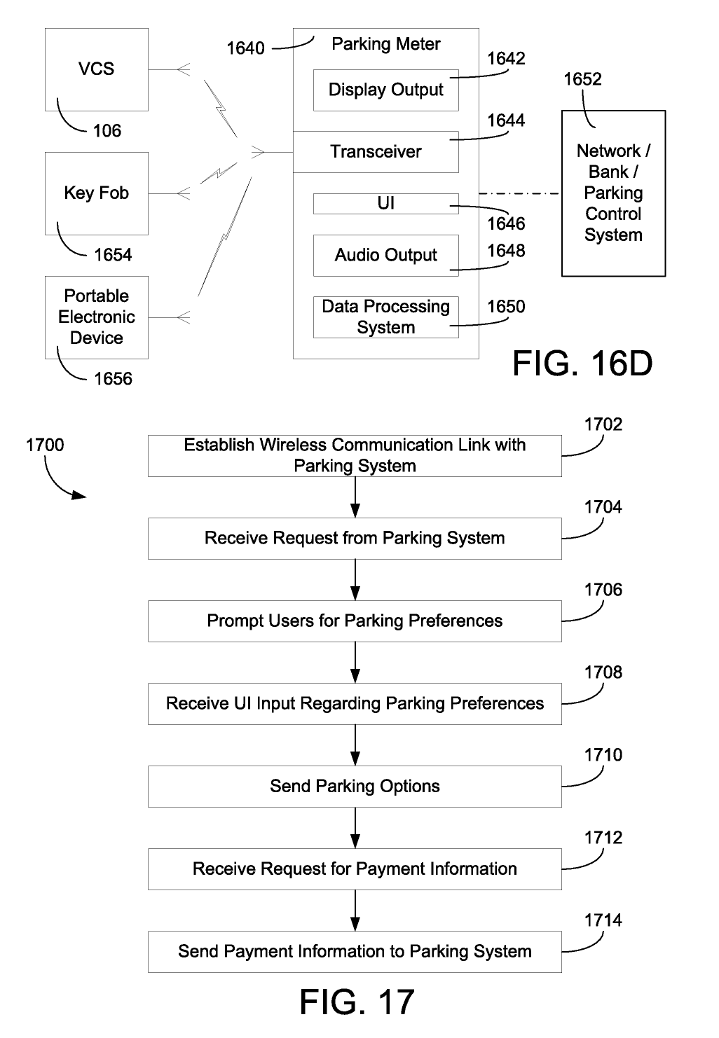

Referring generally to FIGS. 16-21, various systems and methods are shown for facilitating parking payment via a vehicle control system and/or for providing of information from a parking system to the vehicle control system. The parking system of FIGS. 16-21 may be an example of a merchant (e.g., merchant 504 are described in the present disclosure) described with reference to the present processes described herein.

Referring to FIG. 16A, a block diagram of a vehicle control system 106 and a parking system 1600 configured to communicate with one another is shown, according to an exemplary embodiment. Parking system 1600 is shown to include a user interface 1604 (UI), a display output 1606, an audio output 1608, a data processing system 1610, a communication system 1612, and/or a transceiver 1602. Parking system 1600 may be a kiosk near a parking structure entrance, an automated parking booth, a parking meter, a kiosk near a parking spot, or another system configured for completing one or more of the parking-related activities described herein. According to an exemplary embodiment, output from parking system 1600 of FIG. 16A is configured to be viewed and/or heard by a user from the user's vehicle. Vehicle 100 may connect to parking system 1600 via transceiver 618 of VCS 106.

Referring now to FIG. 16B, a block diagram of a vehicle control system 106 and a parking system 1600 configured to communicate with one another via a parking station 1620 is shown, according to another exemplary embodiment. Parking station 1620 is communicably connected (via a wired and/or wireless connection and/or network) to parking system 1600. Parking system 1600 may be located remotely from parking station 1620 and/or the parking structure. Parking station 1620 may be configured for local communications with vehicle 100 (e.g., to serve as a communications “bridge” between vehicle 100 and parking system 1600). Parking system 1600 may conduct payment processing activities, user authentication, payment authentication, and/or other logic activities described herein. Parking station 1620 may also include a data processing system and may be able to conduct some of the logic activities described herein or otherwise. For example, parking station 1620 may conduct some initial authentication and/or user interaction activities. In such a system, the parking station may only communicate with the parking system to complete a transaction.

Referring now to FIG. 16C, parking system 1600 is shown according to another exemplary embodiment. Parking system 1600 of FIG. 16C may be a central and/or distributed parking system configured for data communications with vehicle control system 106. In the embodiment of FIG. 16C, parking system 1600 may utilize vehicle control system 106 and/or the GUI, VUI, and/or TUI of vehicle control system 106 to interact with the user. Parking system 1600 may not include a separate display or audio system to facilitate user interaction. The systems of FIGS. 16A and/or 16B may also or alternatively make use of the vehicle display and/or audio system for user interaction rather than (or in addition to) the UI of parking system 1600.

Referring now to FIG. 16D, a block diagram of a parking meter 1640 interacting with various devices is shown, according to an exemplary embodiment. Parking meter 1640 may include a display output 1642, a transceiver 1644, one or more user interface elements 1646 (e.g., buttons, touch pad elements, touch screen areas, etc.), an audio output 1648 (e.g., a speaker), and/or a data processing system 1650 (e.g., a processor and/or memory). Parking meter 1640 may be coupled to a network, a banking system, a mobile commerce agent, a RPPS, a parking control system or otherwise (1652). It is important to note that parking meter 1640 may be configured to accept payment information from devices other than vehicle control system 106. For example, parking meter 1652 may be configured to receive payment information from a key fob 1654, a portable electronic device 1656, a credit card, or another payment mechanism via wireless communication. The payment information may be transmitted to parking meter 1640 and the vehicle occupant can input a PIN or other authentication information and select/confirm a duration of time for which to pay. The parking duration may be an open time period until the vehicle leaves, at which time the payment information may be processed.

Referring now to FIG. 17, a flow chart of a process 1700 for allowing a user to purchase parking time is shown, according to an exemplary embodiment. After establishing a wireless communication link between the vehicle control system and the parking system (step 1702), the parking system may send a request to the vehicle control system and the vehicle control system may receive the request (step 1704). The request may be for identifying information, confirming information, payment information, and/or other parking preferences. Once the request is received at the vehicle control system, the vehicle control system may cause a user interface element in the vehicle to prompt the user for input relating to the parking preferences of the user (step 1706). Parking preferences may be, for example, expected time of parking, size of vehicle, class of vehicle (e.g., commerce, personal), parking class (e.g., economy, business, VIP, etc.), etc. The vehicle control system may receive the UI input regarding the preferences via a vehicle-installed GUI, TUI, and/or VUI (step 1708). The vehicle control system may compile and/or otherwise process the user input and provide a representation of the selected parking options to the parking system (step 1710). The parking system may be configured to process the received parking options and to send a request for payment information to the vehicle control system based on the processed parking options (step 1712). When received by the vehicle control system, the vehicle control system may respond to the request by sending payment information (pre-stored, detected, or otherwise) to the parking system (step 1714).

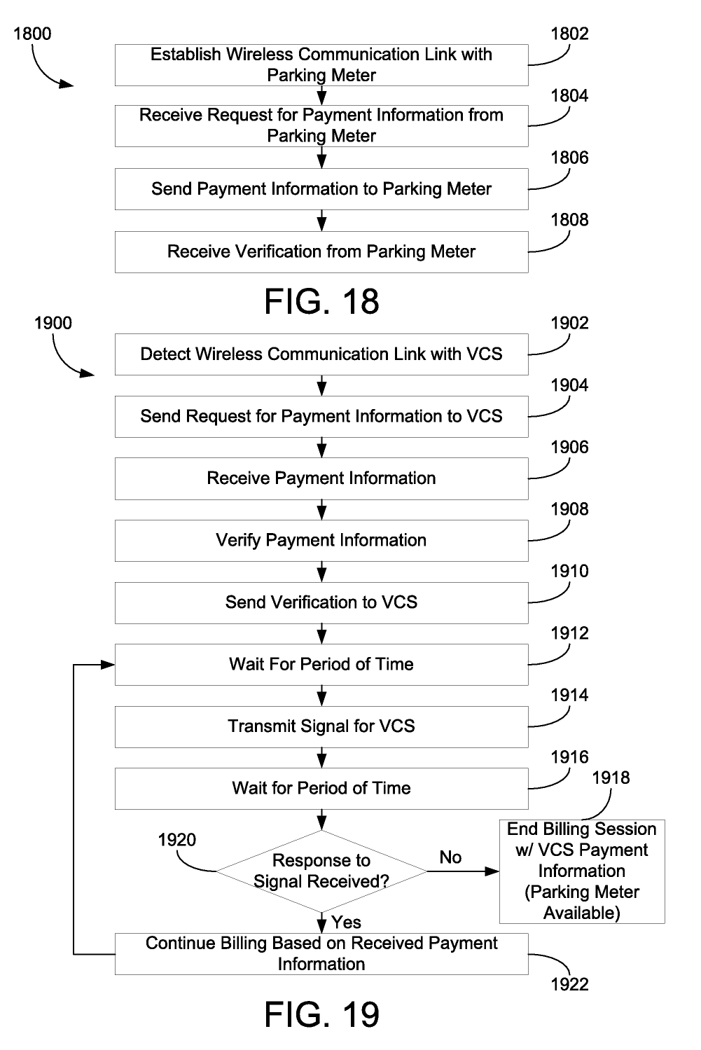

Referring now to FIG. 18, a flow chart of a process 1800 for a vehicle control system processing a payment request received from a parking meter is shown, according to an exemplary embodiment. After establishing a wireless communication link with the parking meter (step 1802), a request for payment information may be received from the parking meter at the UI (step 1804). The vehicle control system may send the payment information to the parking meter (step 1806) in response to the request. The parking meter may send a verification and/or receipt for the parking purchase to the vehicle control system (step 1808). Process 1800 may be repeated to purchase additional time and/or parking credits using a mobile device (e.g., key fob, mobile phone etc.). Each parking meter may include an e-mail address, internet address, other identifier, and/or phone number that the user may use to purchase additional parking time. The mobile device may connect directly to the parking meter, connect via the internet, connect via a wireless service organization, and/or connect via a parking system not located on the parking meter. A button or UI element may be provided on the mobile device and/or vehicle UI for quickly increasing time and/or credits.

Referring now to FIG. 19, a flow chart of a process 1900 for a parking meter or parking system for continuing to charge a vehicle for parking time or credits is shown, according to an exemplary embodiment. When a potential wireless communication link with the vehicle control system is detected (step 1902), the parking system may send the vehicle control system a request for payment information (step 1094). According to various other exemplary embodiments, the vehicle control system may initiate the communications (by the user entering and the system sending, for example, the identifier of the parking meter at which the vehicle will be parked).

Referring further to FIG. 19, once payment information is exchanged and verified between the vehicle control system and the parking system (steps 1906-1910), the parking meter may wait a period of time (step 1912) before transmitting a signal configured for the vehicle control system (step 1914). If a period of time elapses during which a response to the signal is received (steps 1918-1920), the parking meter or parking system may continue billing based on the previously received payment information (step 1922). As illustrated, this loop may continue until a response to the signal is not received. The parking meter or parking system may then determine that the vehicle is no longer parked at the parking spot and will end the billing session using the previously received payment information (step 1920). The parking meter may change the color of an indicator on the parking meter or otherwise signal to other vehicles that its associated parking spot is available for use.

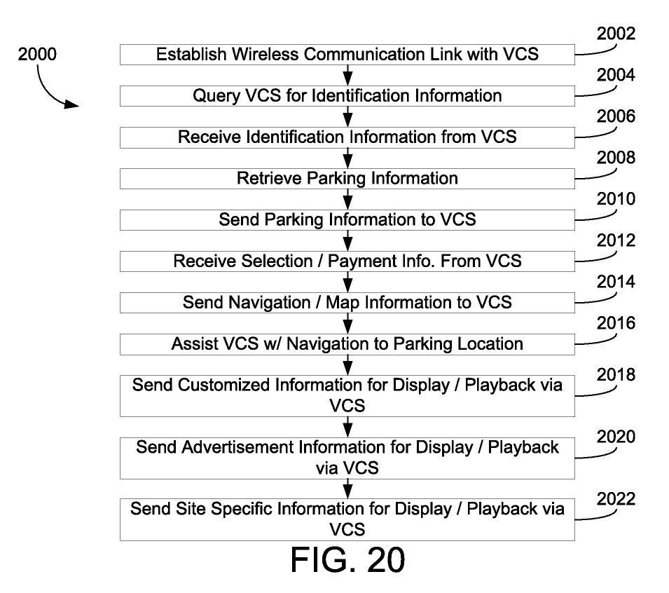

Referring now to FIG. 20, a flow chart of a process 2000 for a parking system and for sending additional information (associated with a purchase or otherwise) to a vehicle control system is shown, according to an exemplary embodiment. After wireless communications have been initiated between the vehicle control system and the parking system (step 2002), the parking system may query the vehicle control system for identification information (step 2004). Based on the received identification information (step 2006), the parking system may query one or more databases for stored parking information (the parking information based on the received identification information or otherwise) (step 2008) and send the information to the vehicle control system (step 2010). The parking system may use the identification information to determine, for example, that the driver of the vehicle is a preferred customer, a habitual user, a user with certain preferences, or to make any other determination relating to parking. According to an exemplary embodiment, for example, an airport parking system may utilize identification information (e.g., credit card information, VIN information, etc.) to determine that the user is a frequent flier and direct the user to premium and/or priority parking

Referring further to FIG. 20, a vehicle user may make a selection relating to parking via a user interface system in the vehicle. Based on the received selection and/or the exchange of payment information (step 2012), the parking system may send navigation and/or map information to the vehicle control system (step 2014). The navigation and/or map information may allow the user to park in a reserved spot, to drive in an unmanned parking lane (e.g., at amusement parks, sporting events, and/or other special events), to enter certain parking areas (e.g., gated parking areas, reserved parking areas, premium trails of a national park, priority parking, etc.), etc. The navigation and/or map information may be generated entirely by the parking system, by the parking system in conjunction with the vehicle control system (or, e.g., a navigation system/database thereof), a remote mapping service, or otherwise.

Referring further to FIG. 20, the parking system may also assist the user and/or the vehicle control system to the parking location with navigation information (step 2016). GPS coordinates from the vehicle's GPS receiver and/or steering information, speed information, etc. may be sent to the parking system, the parking system may generate visual and/or audio prompts for sending to the vehicle control system in response. For example, if the determined premium parking spot for the vehicle is to the left, the parking system may generate an audio prompt for sending to the vehicle control system that says, “Please turn left to find your parking spot.”

Referring yet further to FIG. 20, the parking system may be used to send customized information to the vehicle control system for display/playback (step 2018), advertisement information for display/playback (step 2020), and/or site specific information for display/playback (step 2022). The advertisement information may be tailored for the user and/or for the vehicle (e.g., the parking system may provide certain advertisements to one car type and other advertisements to a second car type).

Site specific information may be provided by parking systems or systems that are other than parking systems. For example, using a transceiver in a vehicle, a tour system may be configured to provide tour and/or drive-through exhibit information to a user. In a tour system with multiple stations/exhibits, the stations and/or exhibits may utilize transceiver strength (signal strength) information and/or triangulation calculations to determine the appropriate information to send to the vehicle.

The communication link can also be used to identify a person entering a secure area. For example, a community gate may open automatically when a transceiver associated with the gate wirelessly detects an authorized PED approaching the security area. The information can also be used in a commercial environment that would be used as access to a parking lot or for any other identification purpose.

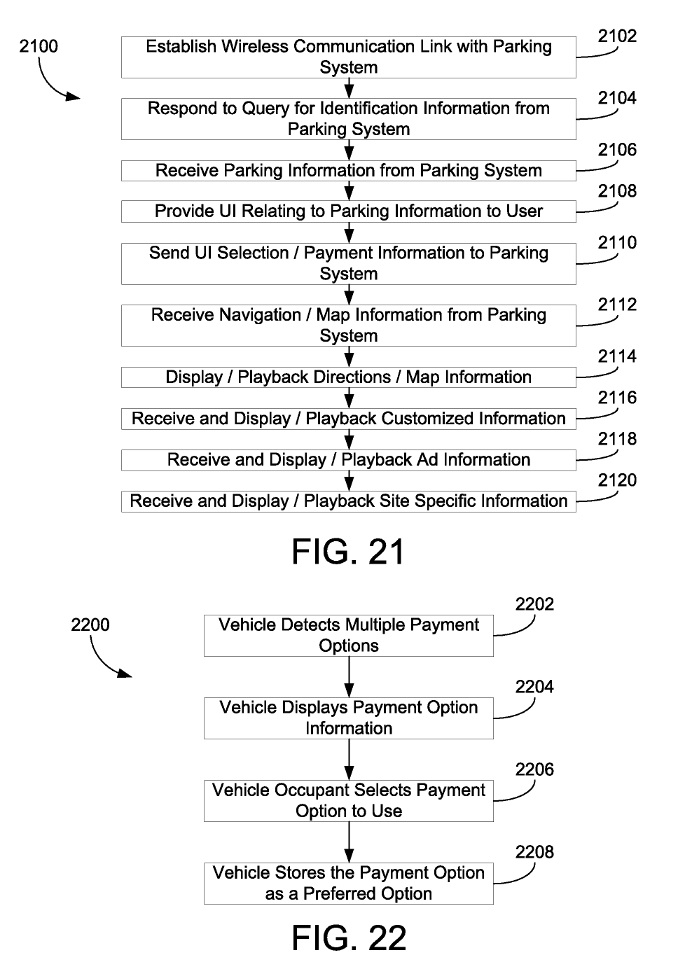

Referring now to FIG. 21, a flow chart of a process 2100 for a vehicle control system interacting with a parking system is shown, according to an exemplary embodiment. The vehicle control system and/or process 2100 are configured to operate with process 2000 and the parking system discussed in FIG. 20. According to an exemplary embodiment, information provided from the parking system to the vehicle control system may be output audibly and/or visually by the vehicle control system using a vehicle display and/or a vehicle audio system.

After establishing a wireless communications link with the parking system (step 2102), the vehicle control system may respond to a query from the parking system for identification information (step 2104). The vehicle control system may receive parking information from the parking system (step 2106) and provide a user interface regarding the received information to a user (step 2108). The user may select an option based on the received parking information and the vehicle control system may send the option and payment information to the parking system (step 2110).

The vehicle control system may receive navigation and/or map information from the parking system (step 2112) and display or playback the information (step 2114). The vehicle control system may additionally receive and display or playback customized information, advertisement information, and/or site specific information (steps 2116-2120).

Referring to FIG. 22, a flow chart of a process 2200 for selecting between multiple payment methods is shown. If the vehicle detects multiple payment mechanisms or options (such as one or more RFID cards (e.g., credit cards) and/or one or more NCF handsets) (step 2202) using a payment mechanism reader, the vehicle may display the payment method information (e.g., card information and/or NCF information or playback information related to the cards and/or NCFs) (step 2204). The vehicle occupant may then select the payment option to use for a single purchase or to use as a preferred option for future purchases (step 2206). The selection may be made by any tactile interface or by voice command. Once the user selects the payment option to use, the vehicle may store the information for that option as a preferred option for later use (step 2208). According to various exemplary embodiments, the selection of multiple payment methods may be used in conjunction with any of the payment transmittal or processing methods or steps described in the disclosure.

### Payment System Behavior Change Based on Mode

According to an exemplary embodiment, the vehicle control system configured for wireless payment of goods and/or services may include a memory unit for storing a variety of payment mode information. Payment mode information may be used to configure the payment system for a certain payment mode. Different payment modes may allow the user to change how his or her payment system behaves. Once a mode is selected, the payment system will be configured to operate according to the mode. The payment system may change behavior according to, for example, a business mode, a personal mode, and/or a travel mode. When a business mode is selected, for example, the vehicle payment system may be configured to use a credit card or payment mechanism associated with a business account. Furthermore, greater and/or more specific log information may be kept/generated by the vehicle when in business mode. For example, the vehicle may be configured to generate and/or e-mail a detailed business report, business travel summary, business expenses summary, and/or mileage log when in business mode. Personal mode may be associated with increased security over business mode and/or may be associated with one or more personal financial accounts. A trip mode may operate with the highest of security options and/or debit a “travel account” (e.g., a prepaid account). Other configurations may be provided or contemplated. The modes may be preset and/or reconfigurable by the user via a TUI, VUI, and/or GUI associated with the vehicle control system.

### Targeted Advertising

As any of the aforementioned payment systems may be configured for bi-directional communications, the vehicle control system may be configured to receive and display and/or playback advertisements in the vehicle. A configuration option provided by the vehicle control system may be configured to allow the user of the vehicle to “opt in” and/or to “opt out” of such advertising using a GUI, TUI, or VUI. Using vehicle information, user information, financial information, and/or any other information that may be harvested from the vehicle control system, systems exterior the vehicle and/or the vehicle control system itself may tailor advertisements for the user. The advertisements may be coupons, textural, graphical, video, image-based, audible, discounts, informative, or otherwise. For example, discounts and/or coupons may be communicated between the external system or merchant to/from the vehicle. Some systems may be configured only to gather demographic information, purchasing information, behavioral information, and/or other information from the vehicle control system. Other systems may be configured to gather information and to provide advertisements (based on the gathered information or otherwise). Frequent buyer identification information (e.g., membership card number, membership ID, account number, etc.) of a user may be communicated to the vehicle and/or external system and discounts may be displayed and/or offered based on the identification information.

### Access to and/or Payment for Other Goods or Services

It would be desirable to provide a vehicle system that may be used to pay for a variety of goods and/or services while driving. According to an exemplary embodiment, the vehicle control systems shown and described in the present disclosure may be configured and/or modified to allow a vehicle occupant to pay bills, to order goods/services, and/or to make other non-vehicle related payments. For example, the payment information stored in the vehicle and/or discovered by the vehicle via a payment mechanism reader may be used to pay utility bills, to order movie tickets, to place an order with a restaurant, to order carry-out from a restaurant, to order delivery from a restaurant, etc. A remote source (e.g. a bank, a credit card company, a utility company, an insurance company, a mobile phone company, etc.) may be configured to send bill information to the vehicle control system, to allow a user to view/hear details regarding bills, and/or allow the user to pay the bills. A restaurant may form a direct or indirect connection with the vehicle control system, provide menu information to the control system, allow the user to place an order via the control system, and/or to receive payment information from the vehicle control system. The transaction may take place in locations such as drive-through windows, parking lots, toll booths, parks, banks, gas stations, service stations, etc.

It should be appreciated that if no payment is required for a good or service, the system with which the vehicle control system is communicating may take orders, commands, or requests without requiring payment. For example, the vehicle control system may connect to a system for setting a home digital video recorder, for reserving a spot at a restaurant, to request concierge service, and/or to request navigation help. According to yet other exemplary embodiments, on-demand services may be ordered and/or paid for using a vehicle control system described herein. For example, a vehicle control system configured to receive satellite or Internet radio signals may be configured to purchase blocks of time, single songs, or other increments of radio access. Media files may also be browsed, ordered, and/or downloaded via the vehicle control system. For example, a vehicle control system may be configured to connect to Apple's iTunes store, to allow the user to browse iTunes, and to order and download music via iTunes.

Payment systems described herein may also be used to send data and/or payment to government departments (e.g., a department of motor vehicles (DMV)). For example, a DMV where the vehicle is registered may be configured to send emissions test reminders, payment reminders, and/or other information to the vehicle control system. If the information sent from the DMV to the vehicle is a payment reminder, the vehicle control system may be configured to allow the user to pay the bill using stored, detected, and/or entered payment information. Emissions test requests sent from a remote system associated with a DMV, for example, may be processed by the vehicle control system and used to complete the test using prompts and a sensor built into the vehicle. In other exemplary embodiments, vehicles will (by default or otherwise) be fitted with emissions sensors and test emissions on a regular or irregular basis. If any of the emissions tests (or a series) indicate failure, the vehicle control system may communicate the failure to the DMV and the DMV may instruct (via the vehicle control system) to bring his or her vehicle in for further testing and/or to visit a technician to address the problem. Successful test results can also be communicated from the vehicle, eliminating the need for regular testing at DMV stations.

The vehicle control systems described herein may also be configured and/or modified to send information to law enforcement devices upon request. For example, as a police office is walking up to a stopped vehicle, he or she may wirelessly query the vehicle for VIN or other identification information. The vehicle control system may be configured to respond to such requests. In order to respond to requests from law enforcement devices the vehicle control system may be communicably connected to the vehicle data bus and/or other vehicle subsystems. Data that may be transmitted to the law enforcement device (e.g., PDA, law enforcement headset, squad car, etc.) may include vehicle registration information, proof of insurance information, driver license information, etc.

According to other exemplary embodiments, various mediums of exchange in addition to or other than a monetary exchange may be utilized. For example, “points” may be acquired from or added to membership cards, goods and/or services may be traded for other goods and/or services, products may be bartered or traded for money and/or other products, bids for auction items may be submitted and/or accepted, etc. It is important to note that purchasing and/or exchanging payment information may include acquiring goods or services without exchanging for payment of any type.

### Insurance Information

According to an exemplary embodiment, insurance providers may configure insurance systems to receive and/or process information from a vehicle control system described herein. The vehicle control system may be configured to extract and/or compile information regarding driving traits (average speed, braking information, speed to speed limit information, stability control system information, etc.). The vehicle information may receive this information from the vehicle data bus, the vehicle electronic control unit (ECU), and/or any other vehicle subsystem. The vehicle control system may be configured to compile and/or to store the information in the memory.

An insurance system may be configured to use the information to provide discounts on insurance, to determine premiums for subsequent insurance periods, etc. According to an exemplary embodiment, information from the vehicle control system may be configured to facilitate variable insurance premiums. For example, using information from the vehicle control system (relating to driving traits and/or other vehicle use parameters) the insurance company may be able to pass additional risk and/or discounts to the vehicle user. For example, if the user is a hazardous driver (frequently causing a stability control system to activate, frequently making use of anti-lock brakes, frequently driving above the speed limit, etc.) the insurance company may increase the user's premiums during those time periods that the user was hazardous (e.g., days, months, hours, etc.). Safe drivers may receive a discount as they may present less of an insurance risk to the insurance company. Such logic may result in the promotion of safe driving as the driving behavior may be electronically tracked and communicated to the insurance agency.

According to an exemplary embodiment, the vehicle control system may be configured to provide the user with an interface for selecting static or dynamic insurance premium calculation. According to yet other exemplary embodiments, the user may be able to change his or her coverage (thereby resulting the premiums) at any time. For example, the vehicle control system may be configured to provide the user with a GUI allowing the user to slide coverage amount, umbrella amount, deductible amount or other insurance parameter according to the user's tolerance for risk. Because the user may feel more or less secure in different driving conditions, he or she may be able to adjust the insurance protection up during those conditions. While the insurance protection is elevated, the user will be charged more. The vehicle control system may be configured to display (upon being provided information from the insurance company) coverage parameters and cost for multiple different cost levels and/or coverage levels. By way of example, if the user is driving in a traffic jam during rush hour, he or she may increase the protection level to the maximum level and/or reduce the deductible substantially. While adjusted upward, the user may be charged relatively high premiums. Once the user is back on residential streets or a clear highway, he or she may reduce the protection level and/or increase the deductible. While adjusted downward, the user may be charged relatively low premiums. According to an exemplary embodiment, the vehicle control system may be configured with an “automatic” mode that detects car speed, temperature, road wetness, fog, traffic information, trip length, “home city” or other information from the vehicle or a connected system and adjusts insurance coverage accordingly. For example, the vehicle control system may be configured to increase insurance protection automatically whenever traveling in a city other than the user's “home city.”

According to an exemplary embodiment, driving traits utilized for insurance purposes may also (or alternatively) be used to provide government, private party, or other incentives. For example, state or federal government may adjust carbon credits based on actual data received from vehicles. Tax credit and/or other tax incentives may be provided directly to the vehicle owner based on determined and communicated emissions, driving habits, and/or other actual vehicle data. If the vehicle is a hybrid, solar, electric, or other vehicle with energy generation or regeneration features, energy generation information may be sent to a private party or a government site for incentives, credits, and/or other purposes. According to one exemplary embodiment, if a system is provided that may extract excess energy from the vehicle and provide the excess energy to an electrical grid, the system may credit a financial account associated with the vehicle for the excess energy.

### Communication Between Vehicle and Merchant via a Remote System

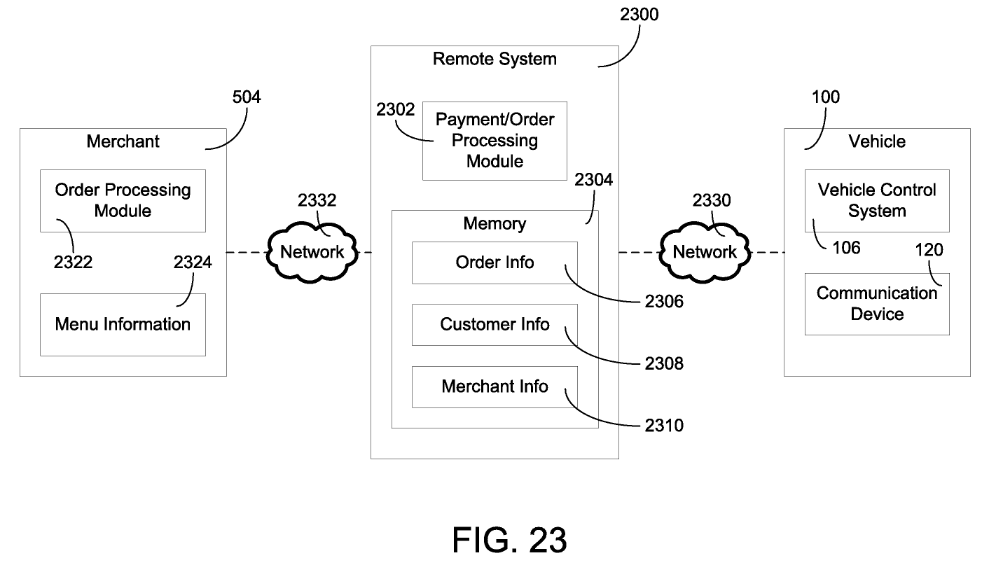

Referring to FIG. 23, vehicle 100 may communicate with merchant 504 via a remote system 2300 to place an order for a product and/or service. According to various exemplary embodiments, vehicle 100 and/or merchant 504 may communicate with remote system 2300 via a cellular network, the Internet, a LAN, a WAN, or any other network 2330, 2332 capable of facilitating wireless communication between vehicle 100 and/or merchant 504 and remote system 2300.

Vehicle 100 includes vehicle control system 106 configured to provide a user interface (e.g., VUI, GUI, TUI, etc.) and communication device 120 configured to facilitate communication between vehicle 100 and remote system 2300. According to various exemplary embodiments, communication device 120 may be a cellular phone, an embedded phone device, a PDA, a PND, an embedded navigation device, or any other device capable of facilitating communication between vehicle 100 and remote system 2300.

Remote system 2300 may be or include includes a payment/order processing module 2302 and a memory 2304. Payment/order processing module 2302 is configured to process order information from vehicle 100 (for example as specified by a user of vehicle control system 106), process payment information from vehicle 100, process order confirmation from the merchant, etc. Memory 2304 is configured to store order information 2306 (e.g., information about pending orders, order history information, etc.), customer information 2308 (e.g., preferred payment method, address, purchase patterns, etc.), and merchant information 2310 (e.g., product/service information, pricing information, typical or current delivery/pick-up time information, etc.).

Merchant 504 includes an order processing module 2322 and stored menu information 2324. Order processing module 2322 is configured to receive and further process orders (e.g., for availability, for shipping, etc.) from remote system 2300 as well as send an order confirmation and invoice once the order has been processed. Menu information 2324 generally controls how the merchant products/services are stored in remote system 2300 and appear to the vehicle user. For example, the menu structure and layout, the pricing information, images and/or description of a product, and images and/or description of the merchant may be configured by menu information 2300.

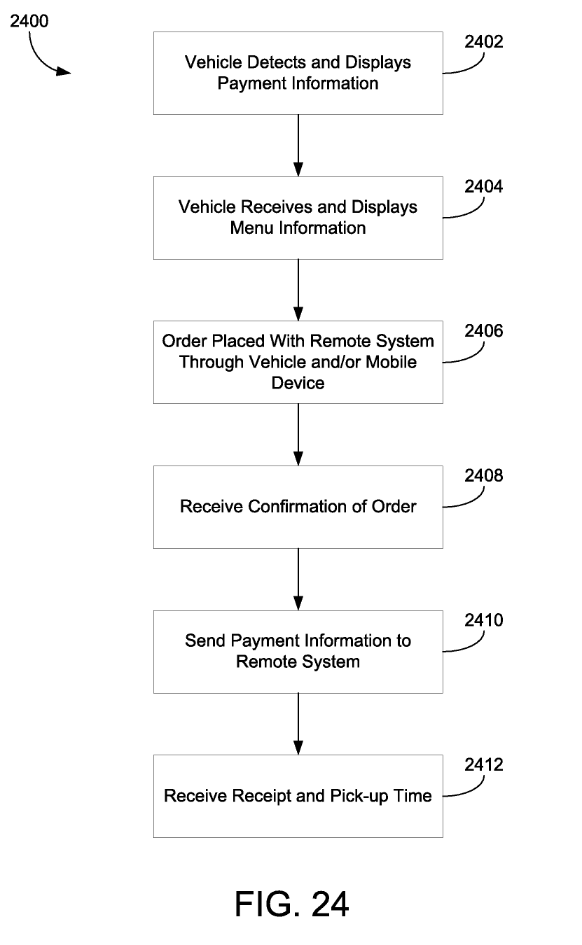

Referring to FIG. 24, a flow chart of a process 2400 for placing an order using remote system 2300 of FIG. 23 is shown, according to an exemplary embodiment. The vehicle detects a payment mechanism and displays payment options to a vehicle occupant on a vehicle display (step 2402). The vehicle receives and displays menu information related to products and/or services available from the merchant for selection by the vehicle occupant (step 2404). Once selected by the vehicle occupant, an order is placed with the remote system through an embedded vehicle communication device and/or connected mobile device (step 2406). Once the remote system processes the order and forwards it to the merchant for further processing, a confirmation of the order is sent from the merchant to the remote system and then to the vehicle for display to the vehicle occupant (step 2408). The vehicle then sends payment information (e.g., the detected payment information) to the remote system for processing (step 2410). Once processed, the remote system may send a payment to the merchant. The remote system sends a conformation and/or receipt to the vehicle once it processes the payments and provides an estimated pick-up time (step 2412), for example based on the stored merchant information or from a message sent by the merchant.

### Navigation and Mobile Commerce Features

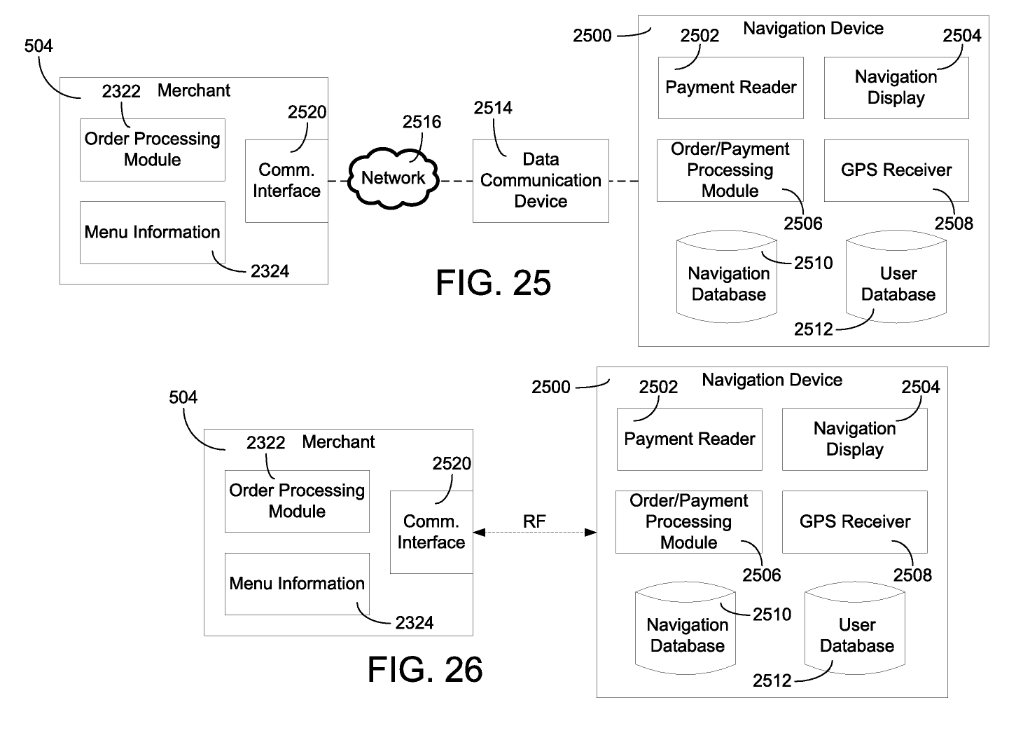

Referring to FIG. 25, a navigation device 2500 is configured to communicate with merchant 504 via a data communication device 2514 to place an order for a product and/or service, according to an exemplary embodiment. According to various exemplary embodiments, data communication device 2514 may communicate with merchant 504 via a cellular network, the Internet, a LAN, a WAN, or any other network 2516 capable of facilitating wireless communication between navigation device 2500 and merchant 504. According to various exemplary embodiments, data communication device 2514 may be a cellular phone, a modem, an RF transceiver, or any other standalone device or device embedded in navigation device 2500 capable of communicating over network 2516. In exemplary embodiments where data communication device 2514 is a standalone device, communication with navigation device 2500 may be over a Bluetooth®, IEEE 802.11, IEEE 802.16, wireless USB, or any other RF communication link. Alternatively, data communication device 2514 may communicate with navigation device 2500 via a wired or other physical connection.

According to one exemplary embodiment, navigation device 2500 may be a standalone navigation device, for example a PND. According to another exemplary embodiment, navigation device 2500 may embedded in another system, for example in a vehicle control system. Navigation device 2500 includes a navigation display 2504, a GPS receiver 2508, a navigation database 2510, a payment reader 2502, an order/payment processing module 2506, and a user database 2512. Navigation display 2504 is generally configured to display coordinate, heading, map, and other navigation information received from GPS receiver 2508 and/or read from navigation database 2510. Payment mechanism reader 2502 is configured to retrieve data from RF tagged payment devices such as a credit card or NFC handset. Order/payment processing module 2506 is configured to process user selected order information and payment information for transmission to merchant 504 via data communication device 2514 and configured to process received order confirmations. User database 2512 is configured to store user information such as past or preferred payment information, purchasing patterns and/or history, address information, etc.

Merchant 504 includes a communication interface 2520, an order processing module 2322, and stored menu information 2324. Communication interface 2520 is configured to communicate with the data communication device over network 2516. Order processing module 2322 is configured to receive and further process orders (e.g., for availability, for shipping, etc.) from navigation device 2500 as well as send an order confirmation and invoice once the order has been processed. Menu information 2324 may be configured to control how the merchant products/services are displayed by navigation device 2500. For example, the menu structure and layout, the pricing information, images and/or description of a product, and images and/or description of the merchant may be configured by menu information 2324.

Referring to FIG. 26, navigation device 2500 may directly communicate with merchant 504 to place an order for a product and/or service. According to various exemplary embodiments, navigation device 2500 may communicate with merchant 504 via a Bluetooth®, IEEE 802.11, IEEE 802.16, wireless USB, or any other wireless communication link. Communication interface 2520 of merchant 504 is configured to communicate over the wireless communication link.

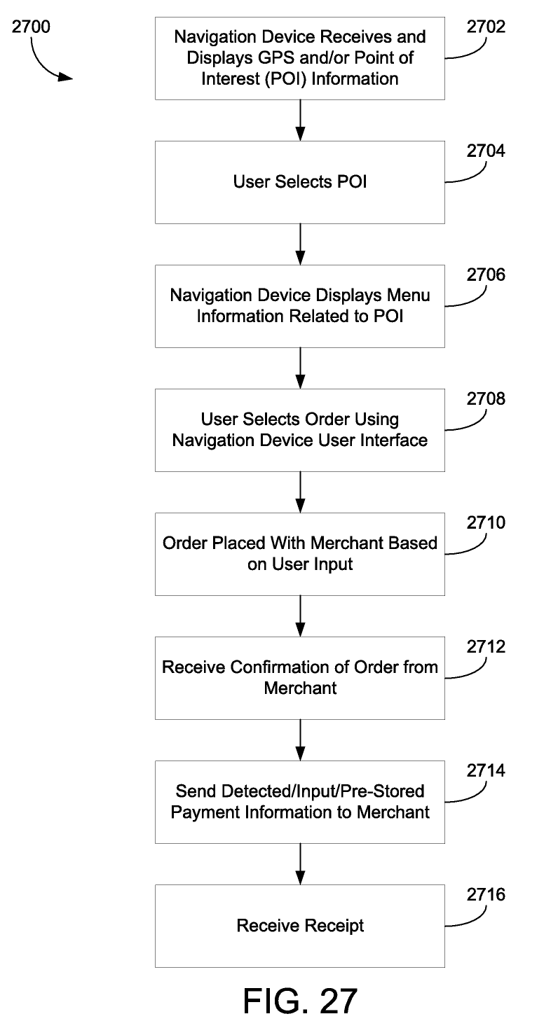

Referring to FIG. 27, a flow chart of a process 2700 for placing an order using the navigation system of FIGS. 25-26 is shown, according to an exemplary embodiment. The navigation device receives (via GPS receiver and/or from the merchant) and displays GPS and/or point of interest (POI) information on the navigation display (step 2702). The user may then select a POI for further information and/or to place an order (step 2704). Once a POI is selected, the navigation device may display menu information related to the POI, for example product/service information, location information, pricing information, etc. (step 2706). The user may select an order based on the menu information via a user interface of the navigation device (step 2708). The order may be placed with the merchant based on the user input or selection (step 2710). Once the merchant processes the order, the navigation device may receive an order confirmation (step 2712). The navigation device may then send detected, input, and/or pre-stored payment information to the merchant (step 2714). Once the merchant processes the payment information, a payment receipt may be sent to the navigation device (step 2716).

### Remote System Configured to Processes Transactions

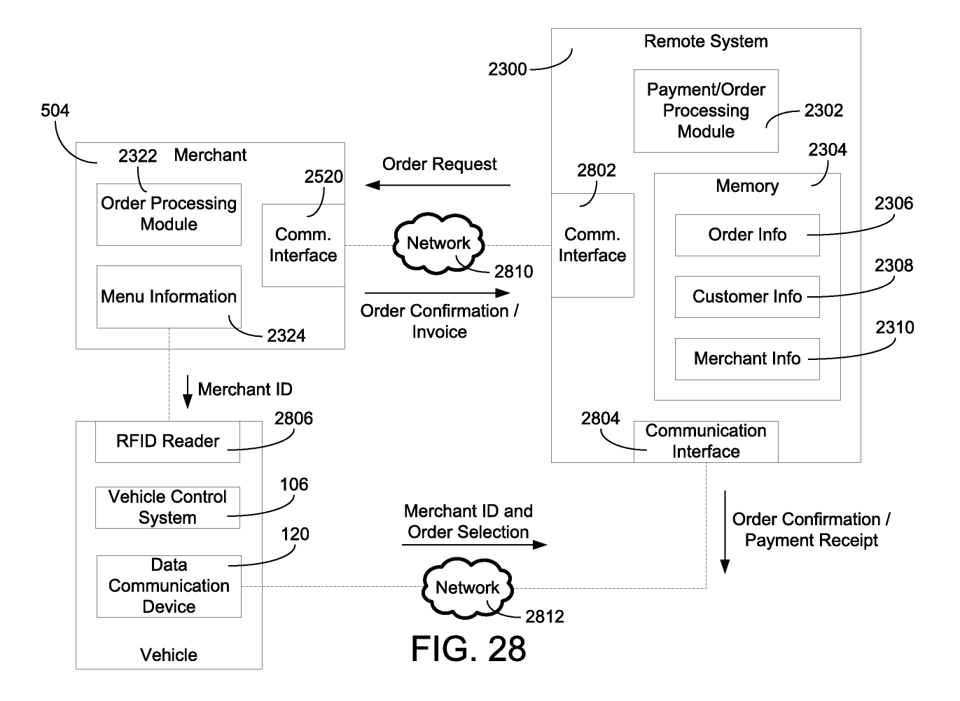

Referring to FIG. 28, vehicle 100 may communicate with merchant 504 via remote system 2300 to place an order for a product and/or service. According to various exemplary embodiments, vehicle 100 and/or merchant 504 may communicate order/payment information with remote system 2300 via a cellular network, the Internet, a LAN, a WAN, or any other network 2810, 2812 capable of facilitating wireless communication between vehicle 100 and/or merchant 504 and remote system 2300.

Vehicle 100 may include an RFID reader 2806, vehicle control system 106, and data communication device 120. RFID reader 2806 may be configured to query for nearby merchant RFID devices and to receive information from the tags (e.g., a merchant ID, product information, price information, etc.) Vehicle control system 106 is configured to provide a user interface (e.g., VUI, GUI, TUI, etc.) and communication device 120 configured to facilitate communication between vehicle 100 and remote system 2300 via network 2812. According to various exemplary embodiments, communication device 120 may be a cellular phone, an embedded phone device, a PDA, a PND, an embedded navigation device, or any other device configured to facilitate communication between vehicle 100 and remote system 2300. Vehicle 100 typically sends merchant ID and/or order selection information to remote system 2300 for processing.

Remote system 2300 may include one or more communication interfaces 2802, 2804, payment/order processing module 2302, and memory 2304. The one or more communication interfaces 2802, 2804 may be configured to facilitate communication with vehicle 100 and/or merchant 504. Payment/order processing module 2302 can be configured to process order information from vehicle 100 (for example as specified by a user of vehicle control system 106), process payment information from vehicle 100, process order confirmation from merchant 504, etc. Memory 2304 can be configured to store order information 2306 (e.g., information about pending orders, order history information, etc.), customer information 2308 (e.g., preferred payment method, address, purchase patterns, etc.), and merchant information 2310 (e.g., product/service information, pricing information, typical or current delivery/pick-up time information, etc.). Remote system 2300 may send order confirmation and/or payment receipts to vehicle 100 and/or order requests to merchant 504.

Merchant includes communication interface 2520, order processing module 2322, and stored menu information 2324. Communication interface 2520 is configured to communicate with remote system 2300 over network 2810. Order processing module 2322 is configured to receive and further process orders (e.g., for availability, for shipping, etc.) from remote device 2300 as well as send an order confirmation and invoice once the order has been processed. Menu information 2324 may control how the merchant products/services are displayed by remote device 2300. For example, the menu structure and layout, the pricing information, images and/or description of a product, and images and/or description of merchant 504 may be configured by menu information 2324. Merchant 504 typically sends order confirmation information and/or invoices to remote system 2300.

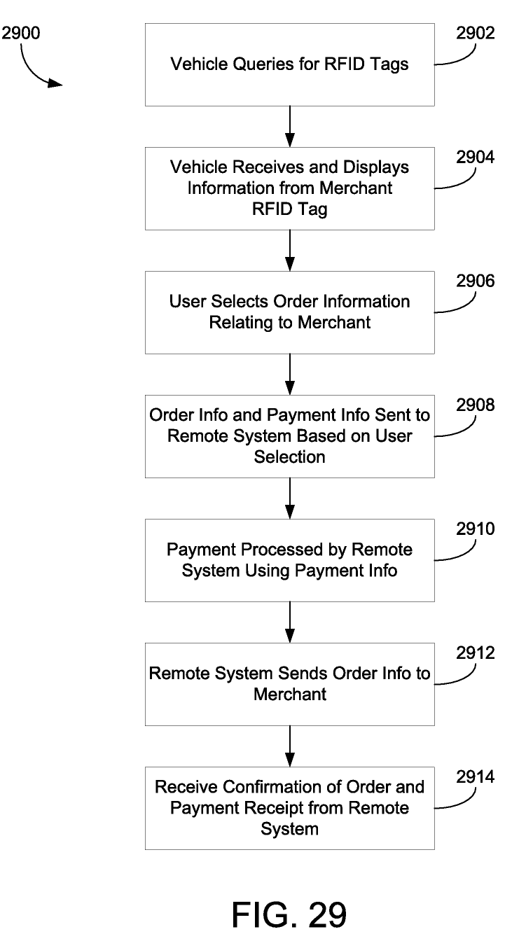

Referring to FIG. 29, a flow chart of a process 2900 for placing an order on remote system 2300 of FIG. 28 is shown, according to an exemplary embodiment. The vehicle may query at a predetermined interval and/or at a vehicle occupant request for RFID tags within range (step 2902). Once an RFID tag is found, the vehicle receives and displays information form the merchant RFID tag (e.g., a merchant ID, product information, price information, etc.) (step 2904). The user may then select order information relating to the merchant (step 2906). The order information and payment information may then be sent to the remote system based on the user selection (step 2908). The payment is processed by the remote system using the payment information (step 2910) and the remote system sends the order information to the merchant for fulfillment or further processing (step 2912). Once the merchant fulfills or further processes the order, an order confirmation and/or payment receipt is sent to the vehicle via the remote system (step 2914).

### Voice Recognition Systems

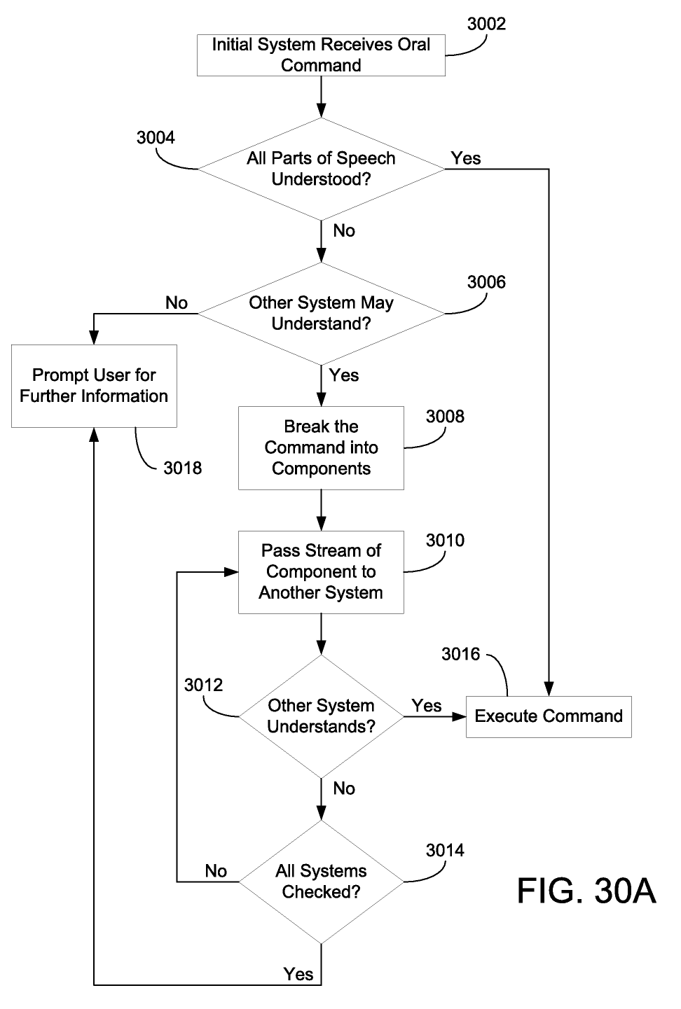

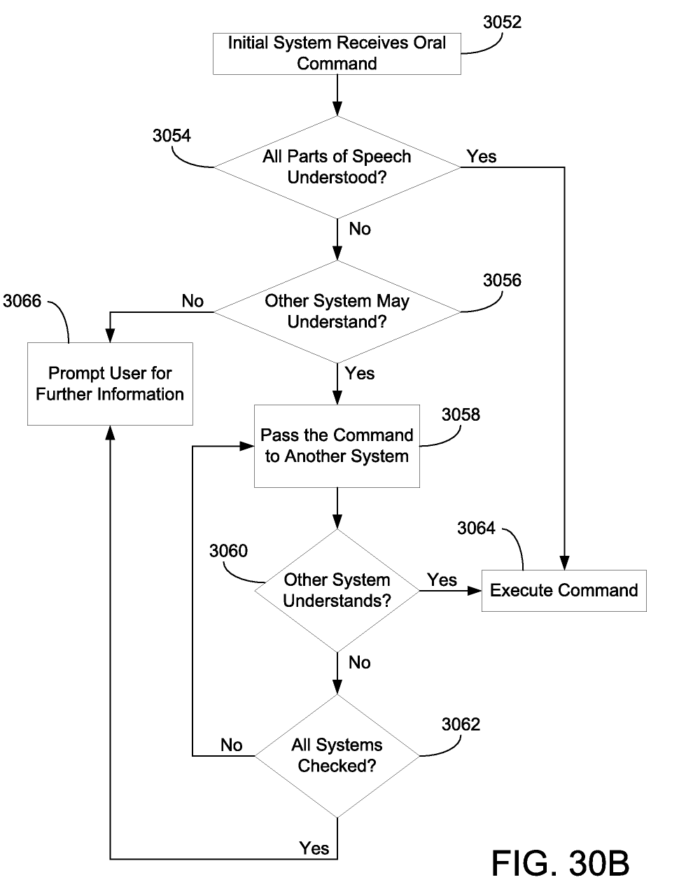

A vehicle control system as described generally in the disclosure may include a voice recognition system that can supplement or replace the speech recognition device as described in FIG. 4. A system of multiple voice recognition systems may be configured to designate one voice recognition system to receive an initial input (e.g., a voice command or utterance), attempt to interpret all phonemes, and determine if other voice recognition systems available need to be used to interpret remaining phonemes. The voice recognition system generally described in FIGS. 30A-B may be used with other embodiments described in the present disclosure. For example, the voice recognition systems described in FIGS. 30A-B may be used to process orders and the like spoken by the user but perhaps not recognizable by conventional voice recognition systems.

Referring to FIG. 30A, a flow chart of a process 3000 for using multiple systems (e.g., voice recognition or speech recognition systems) to execute a command based on a vocal utterance is shown, according to an exemplary embodiment. The initial (or first) system receives an oral command (step 3002). The initial system may be designated by the vehicle control system as a system that receives all oral commands from a user of the vehicle, or a decision on an ideal system to use for the oral command may be made as the oral command is uttered. The oral command may be provided by a user of the vehicle and may include any request of products, services, or information, a request to change various settings of the vehicle, or any other request or command.

The initial system then attempts to interpret and understand the oral command, which may be broken down into parts of speech (step 3004). The parts of speech may include individual or multiple words, a command, a sentence, a syllable or partial utterance of a word or phrase, a phoneme, etc. Parts of speech that can be interpreted by the system are interpreted, and parts of speech that may not be interpreted may be identified. If all parts are understood, no other systems are needed and a command may be executed based on the result (step 3016).

If all parts of speech cannot be understood, another system may be used to interpret the remaining parts. A determination may be made as to whether another system can interpret the parts (step 3006). The determination may be made depending on particular settings for each available system (e.g., one system may be designated to handle a different language or dialect) or another system may be selected at random. If there are no available systems, the user may be prompted for further information regarding the provided oral command (step 3018).

Once another system is identified, the user command is provided to the identified second system. The first system may first break up the user command into components (e.g., phonemes or other parts of speech that are further parsed than the parts of speech used in the step above) (step 3008). The components may be broken up in a method related to the way parts of speech were determined in an earlier step. The method in which the parts of speech are broken down into components may relate to various settings of the second system to be used. The stream of components are then passed to the second system (step 3010). According to one exemplary embodiment, only the non-interpreted components may be sent to second system.

The second system may be responsible for breaking down the user command into phonemes. The second system may then attempt to interpret the user command (step 3012). If all remaining phonemes are understood, the user command may be executed by the vehicle control system (step 3016).

If there are still non-interpreted phonemes, another system may be used (step 3014). If the system has not been used yet, remaining phonemes may be sent to the system and the system may attempt to interpret the phonemes. The process may continue until either all phonemes are interpreted and the user command is executed or until there are no available systems. If all systems have been used, the user may be prompted to provide further information.

Referring to FIG. 30B, a flow chart of a process 3050 for using multiple voice recognition systems to execute a command based on an oral input is shown, according to another exemplary embodiment. The initial system receives an oral command (step 3052). The initial system may be designated by the vehicle control system as a system that receives all oral commands from a user of the vehicle, or a decision on an ideal system to use for the oral command may be made as or immediately after the oral command is uttered. The oral command may be provided by a user of the vehicle and may include any request of products, services, or information, a request to change various settings of the vehicle, or any other request or command.

The initial system may then attempts to interpret and understand the oral command (step 3054). If all parts of speech are understood, no other systems may be needed and a command may be executed based on the result (step 3064).

If all parts of speech cannot be understood, another system may interpret the remaining parts. A determination is made as to whether another system can interpret the phonemes (step 3058). If there are no available systems, the user must be prompted for further information regarding the provided oral command (step 3066).

Once another system is identified, the user command may be provided to the second system. The user command may be directly passed to the system. The second system may be responsible for breaking down the user command into phonemes (or other parts of speech). The second system may then attempt to interpret the user command (step 3060). The second system may either attempt to interpret phonemes that were determined that were not interpreted by the original system, or may attempt to interpret the entire user command. If all phonemes can be interpreted, the user command may be executed by the vehicle control system (step 3064).

Otherwise, there are still non-interpreted phonemes; therefore, another system may be used to interpret the phonemes. If a system has not been used yet, leftover phonemes may be sent to the system and the system may attempt to interpret the phonemes (step 3062). The process may continue until either all phonemes are interpreted and the user command is executed or until there are no available systems. If all systems have been used, the user may be prompted to provide further information.

### Communication Between Vehicles and a Remote System

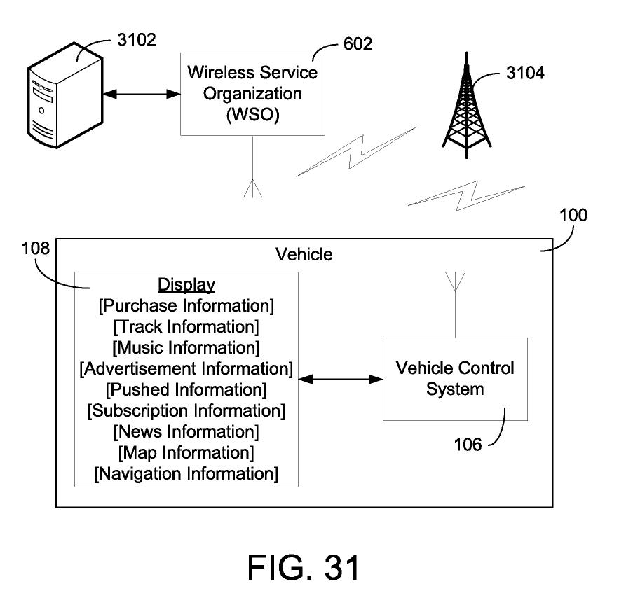

Referring to FIG. 31, a block diagram of a system for communication between a vehicle 100 and a remote system is shown, according to an exemplary embodiment. A media server 3102 is shown coupled to a wireless service organization (WSO) 602. WSO 602 may receive signals regarding a request for various products and services from a vehicle control system. WSO 602 may access media server 3102 and provide the products and services (e.g., a song, an audio book, driving directions, etc) to the vehicle via a wireless link 3104.

Vehicle control system 106 may send out the request for various products and services. The request may relate to current information provided to vehicle 100. For example, a radio advertisement relating to a song may prompt vehicle control system 106 to request the media server for particular songs to be made available for download by WSO 602. Vehicle control system 106 may receive a response from WSO 602 via a wireless link and provide the response to display 108, which may format the response (e.g., information regarding the media available for purchase) for display to the user.

Display 108 may include display information about purchasing a song, album, audio book, or other product via vehicle control system 106. WSO 602 may provide the product upon request; for example, once a user indicates a desire to purchase the product, the product may be downloaded via a wireless connection to vehicle control system 106. Track and music information may be displayed regarding a song that is currently playing from the radio, a compact disc (CD), cassette tape, or other device. The information may include pricing information for purchasing the song that is playing on a radio, band and/or artist information of the song, etc.

Advertisement information may be included on display 108. Vehicle control system 106 may detect an advertisement for a certain product and WSO 602 may provide the product available for immediate purchase by a user of vehicle 100 (e.g., an advertisement for a music album may result in the music album being offered for sale on display 108). Pushed information and subscription information (e.g., information about subscriptions that the user may have with regards to accessing media) may also be included in display 108.

News information may also be included on display 108. A user of vehicle 100 may request news in various genres (e.g., world, business, sports, etc.) and WSO 602 may provide the news by accessing various news sources. Map and navigation information provided by either a GPS system of vehicle 100 or by WSO 602 may be displayed.

### Vehicle Control System User Interface Embodiments

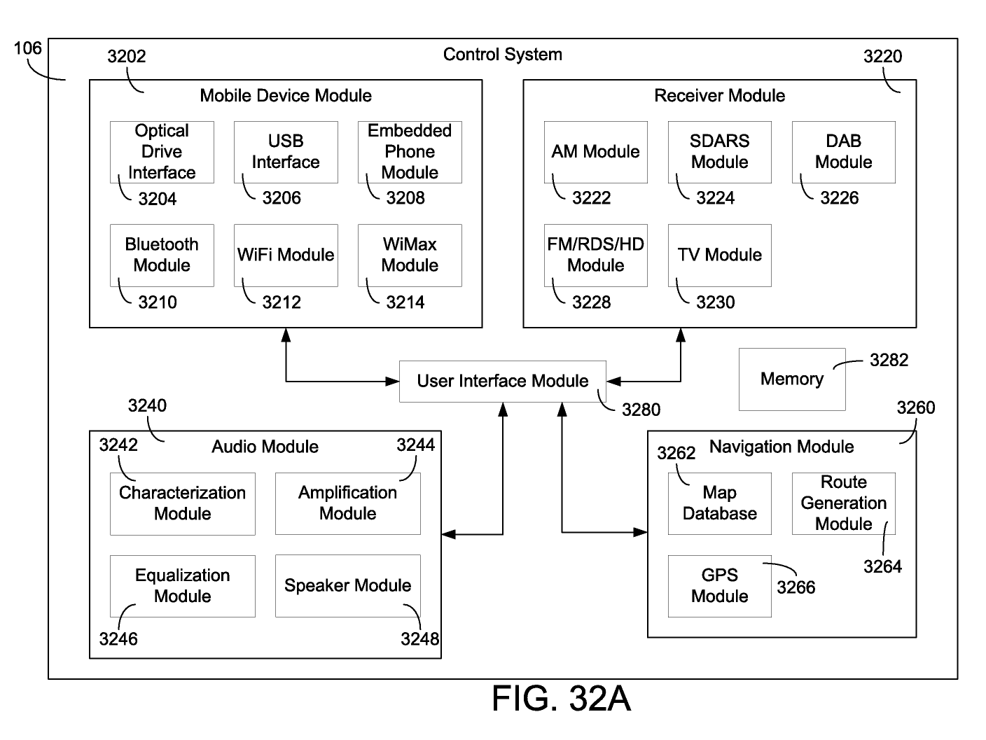

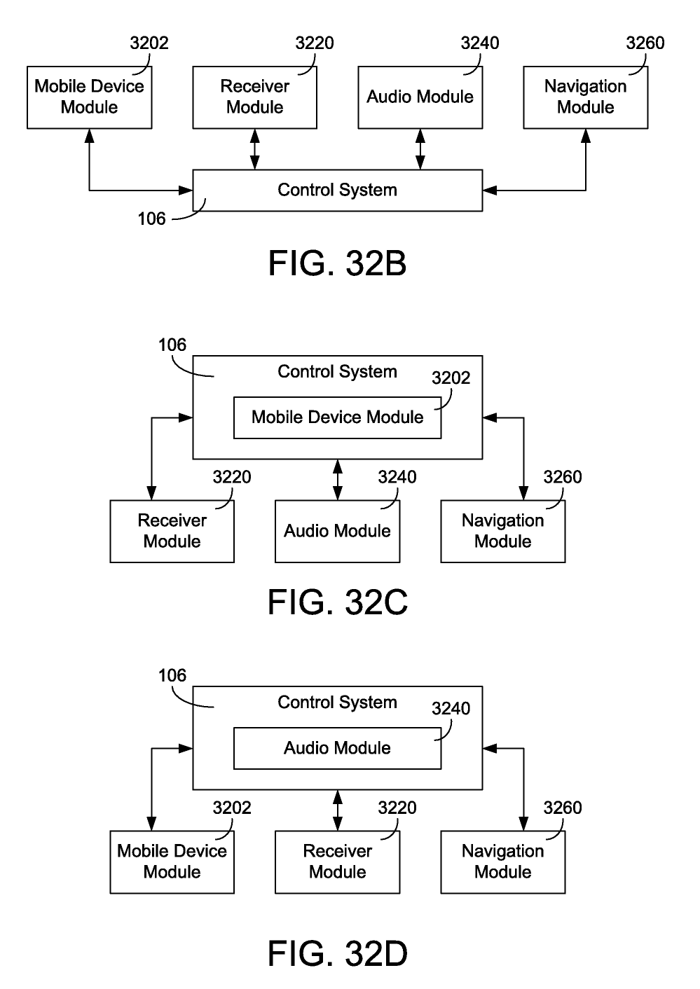

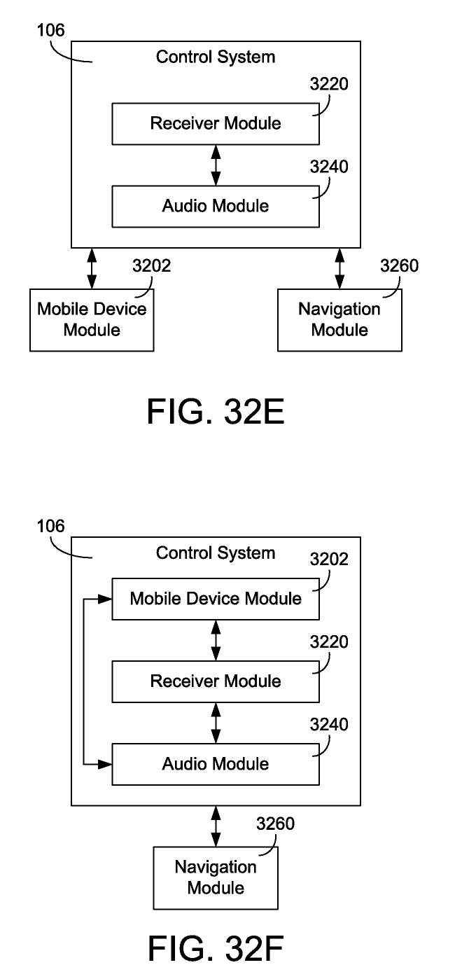

Typically, the various modules of a vehicle may each have its own control system with its own set of configurations. For example, a receiver module may receive a radio signal and display radio information on a display screen, while a navigation module may display directions on another display screen. The two modules may be separate and the displays may be different (e.g., different font colors or sizes, different graphics, etc.). A user of the vehicle may utilize display screens and/or audio output devices throughout the vehicle for the various modules; however, a user interface module (which may use a display screen, an audio output device, etc.) configured to provide a consistent user interface look and feel in a vehicle may be desirable. Various ways to implement such a system are illustrated in FIGS. 32A-F.

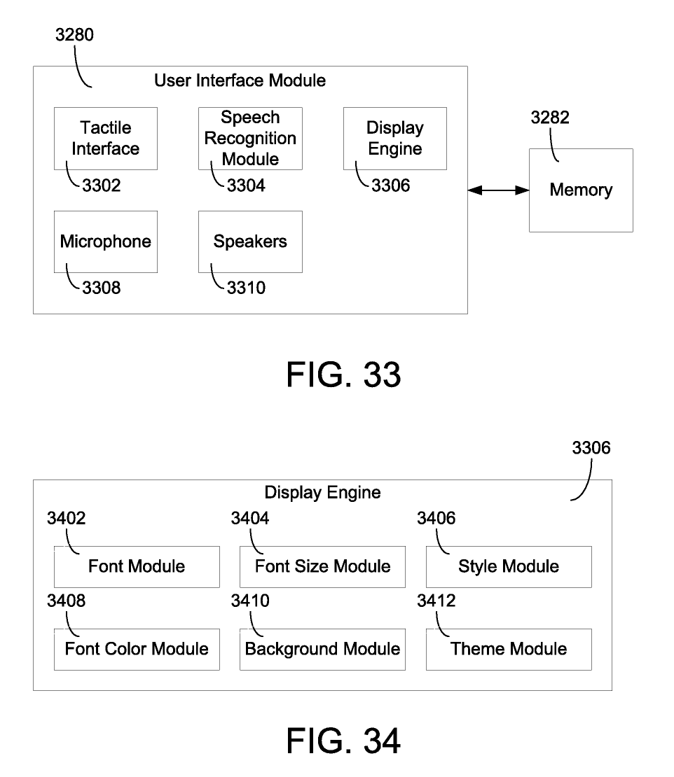

Referring to FIG. 32A, a block diagram of vehicle control system 106 is shown, according to an exemplary embodiment. System 106 is shown to include a user interface module 3280 configured to provide display or audio output to a user of the vehicle based on information provided by the various modules of the vehicle and vehicle control system 106. User interface module 3280 is described in greater detail in FIG. 33. System 106 also includes a memory 3282. Memory 3282 may be configured for storing preferences or user settings for later use by system 106. For example, memory 3282 may store data regarding the radio stations most listened to, various searches and directions recently used with the navigation module, audio settings (e.g., base, treble, fade, etc.), etc.

Mobile device module 3202 is also shown as included within system 106. Mobile device module 3202 may include modules and interfaces relating to the connection and use of various mobile devices. An optical drive or USB interface 3204, 3206 may be provided to connect various devices to module 3202. An embedded phone module 3208 may be included to allow a mobile phone to be connected to system 106 and used by a user of the vehicle. Other modules provided for wireless connections (Bluetooth module 3210, WiFi module 3212, WiMax module 3214, etc.) may also be included within module 3202.

System 106 includes a receiver module 3220. Receiver module 3220 may be configured to handle various outside signals. For example, modules that may be included within the receiver module may include an AM module 3222, a satellite digital audio radio service (SDARS) module 3224, a digital audio broadcasting (DAB) module 3226, a FM/RDS/HD module 3228, and/or a TV module 3230.

System 106 includes an audio module 3240. Audio module 3240 may be configured to handle audio settings and preferences. For example, a characterization module 3242, amplification module 3244, equalization module 3246, and/or speaker module 3248 may be used to control various settings of an audio output.

System 106 includes a navigation module 3260. Navigation module 3260 may include a map database 3262 that may be used to look up location information. A route generation module 3264 may be configured to provide directions between two locations. GPS module 3266 may be configured to receive position information from a GPS system.

The various modules are all coupled to user interface module 3280, which receives input from all modules 3202, 3220, 3240, 3260 and provides a visual or audio display for a user of the vehicle regarding one or more of modules 3202, 3220, 3240, 3260.

Referring to FIG. 32B, a block diagram of vehicle control system 106 is shown, according to another exemplary embodiment. System 106 is shown operatively coupled to, but not including, mobile device module 3202, receiver module 3220, audio module 3240, and navigation module 3260. System 106 receives an input from the various modules 3202, 3220, 3240, 3260 of the vehicle and provides a visual or audio display for a user of the vehicle with data regarding one or more of the modules 3202, 3220, 3240, 3260.

Referring generally to FIGS. 32C-F, vehicle control system 106 may include any number of modules and be operatively coupled to other modules. For example, in the embodiment of FIG. 32C, system 106 includes mobile device module 3202 but is operatively coupled to receiver module 3220, audio module 3240, and navigation module 3260. In the embodiment of FIG. 32D, system 106 includes audio module 3240 but is operatively coupled to mobile device module 3202, receiver module 3220, and navigation module 3260.

In the embodiment of FIG. 32E, system 106 includes receiver module 3220 and audio module 3240 but may be operatively coupled to mobile device module 3202 and navigation module 3260. Receiver module 3220 and audio module 3240 may be operatively coupled within system 106. In the embodiment of FIG. 32F, mobile device module 3202, receiver module 3220, and audio module 3240 are all operatively coupled with one another in system 106, while navigation module 3260 is operatively coupled to system 106.

According to an exemplary embodiment, multiple modules may be combined or coupled to form a subsystem within system 106. For example, receiver module 3220 and audio module 3240 may be coupled as its own subsystem or module (e.g., the two may combine to form an audio overhead module that manages audio input and output associated with an outside signal received by the receiver module). The subsystem may provide a single connection to user interface module 3280, or multiple connections may be provided for each individual module.

Referring to FIG. 33, a block diagram of user interface module 3280 and memory 3282 of FIGS. 32A-F is shown in greater detail, according to an exemplary embodiment. User interface module 3280 may include various components used to interact with users of a vehicle. Module 3280 may include a tactile interface 3302 designed to give the user of the vehicle a method for entering preferences by adjusting the component. For example, the “Buy” button as described in FIG. 2H may be provided on module 3280.

Module 3280 may also include a microphone 3308, speakers 3310, and other various audio input and output devices configured to allow a user to communicate with various modules and systems of the vehicle via oral communications and to provide a user with oral feedback in lieu of visual feedback. Module 3280 may also include a speech recognition module 3304 (e.g., similar to speech recognition device 136 of FIG. 4) and a display engine 3306 as described in FIG. 34.

Memory 3282 may be coupled to the module. Memory 3282 may include various preferences saved from any of the components within module 3280, for example, display engine 3306. Memory may be volatile or non-volatile memory and may be the memory as described in FIGS. 3-4.

Referring to FIG. 34, a block diagram of display engine 3306 for use with a vehicle control system is shown, according to an exemplary embodiment. Display engine 3306 configuring to control graphical user interface/visual output for a user of the vehicle. Display engine 3306 may include a font module 3402 which selects a font or text to be displayed. Display engine 3306 may also include a font size module 3404 and a font color module 3408 for choosing a size and color of the font to display, respectively. Display engine 3306 may also include a background module 3410 for configuring the background, color, or image of the screen used for visual display and a style module responsible for determining a specific style (e.g., a “skin”, stored profile, menu design or structure, etc.) of display. For example, various graphics may be selected, various formatting of text may be chosen (e.g., if text scrolls, how fast the text scrolls, if there is a list of options, how the list is ordered and displayed, etc.).

Display engine 3306 may also include a theme module 3412. Theme module 3412 may be included either in lieu of or supplementing the other various modules (3402-3210). As data is provided to display engine 3306, display engine 3306 formats the data according to theme module 3412. Theme module 3412 allows a specific configuration for the visual display to be defined in whole instead of defining five separate properties using five separate modules 3402-3410. For example, a specific “template” may be stored within theme module 3412 that contains information about the choice of font, font size, font color, background, and style. Instead of display engine 3306 using five separate modules 3402-3410 to create a display, display engine 3306 may use the “template” in theme module 3412.

### Vehicle Control System User Interface Embodiments

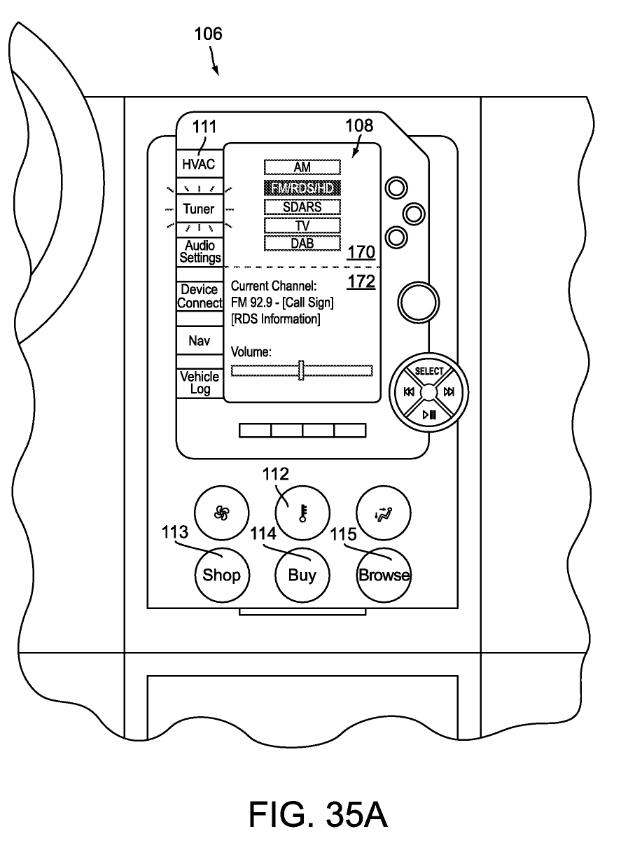

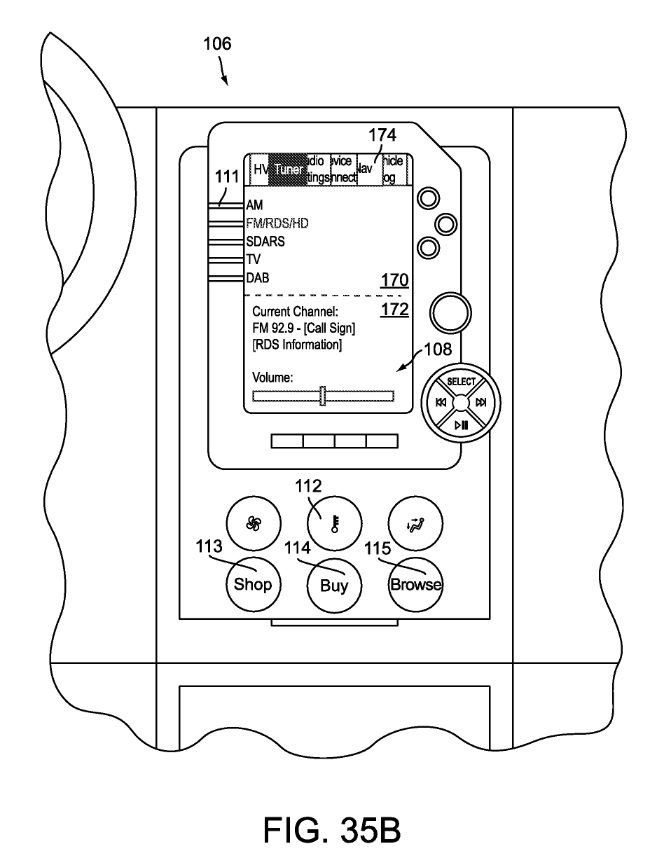

Referring generally to FIGS. 35A-B, alternative embodiments of the user interface of the vehicle control system shown in FIG. 2H are described.

Referring to FIG. 35A, a front elevation view of the user interface of vehicle control system 106 of FIG. 1 is shown, according to another exemplary embodiment. Vehicle control system 106 generally includes output display 108 that may be separated into an upper display 170 and a lower display 172, one or more knobs 112-115, and one or more tactile user inputs or pushbuttons 111, which facilitate controlling various vehicle functions. Output display 108 may have the functionality as described in FIG. 2, and be configured to display two or more unique sets of data for a user of the vehicle. For example, as shown in FIG. 35A, upper display 170 is a touch screen that allows a user to select the mode of the radio or output device of the vehicle. Lower display 172 is a screen that displays channel information of the tuner and may also be a touch screen allowing a user to adjust the volume of the tuner. According to other exemplary embodiments, the touch screen may be configured to allow the user to select other menu items, for example to facilitate the purchase or order of a product or to facilitate any other vehicle function.

Pushbuttons 111 are shown as labeled instead of using output display 108 to identify pushbuttons 111 as in FIG. 2H. For example, pushbutton 111 for “tuner” is shown as illuminated, and output display 108 provides the appropriate options and information for the radio system of the vehicle. The operation of pushbutton 111 for HVAC control may display a menu screen or execute commands that allow the user to control cabin temperature and air flow by tactile or oral command. The operation of pushbutton 111 for audio settings may allow a user of the vehicle to adjust the volume, base, treble, or other setting (e.g., a setting for “rock” music or “jazz” music). The operation of pushbutton 111 for device connect may initialize a method of connecting a remote device to vehicle control system 106. The operation of pushbutton 111 for navigation control may allow a user to get directions, locate the current position of the vehicle, or find other information using a global positioning system (GPS) or other similar system. The operation of pushbutton 111 for vehicle log management may display a menu screen or execute commands that allow the user to input, view, select and/or reset information related to vehicle operation (e.g. fuel economy, engine temperature, distance to empty, etc.) by tactile or oral command.

Pushbuttons 111 may be used to change to any of the functions described while performing any operation of one of the functions. For example, in FIG. 35A, when “tuner” is selected, five options of audio output type are displayed (AM, FM/RDS/HD, SDARS, TV, DAB). The information on output display 108 may change if another pushbutton 111 is used, while other information (e.g., the radio information displayed on the bottom display) might or might not change based on pushbutton 111.

Pushbuttons 113-115 typically allow for the selection and display of various functions of vehicle control system 106. The operation of pushbutton 113 or an oral command to execute a “Shop” operation may prompt the output display to provide a menu or other configuration to provide a user to view various products that may be purchased that are related to a radio or other advertisement. The vehicle can include a microphone (e.g., an audio input device shown in FIGS. 3-4) for receiving voice commands that are interpreted by a voice recognition component or module set. The operation of pushbutton 113 or an oral command to execute a “Buy” operation may display a menu screen or execute commands that allow a user to input, view, and/or select information or media for purchase and/or download or delivery. The operation of pushbutton 113 or an oral command to execute a “Browse” operation may prompt the output display to provide an interface for a user to navigate through various products and services that may be purchased through the vehicle control system.

Referring to FIG. 35B, a front elevation view of the user interface of vehicle control system 106 of FIG. 1 is shown, according to yet another exemplary embodiment. In the embodiment of FIG. 35B, output display 108 is shown separated into an top display 174, an upper display 170, and a lower display 172. Output display 108 may have the functionality as described in FIGS. 2H and 35A, and be configured to display three or more sets of data for a user of the vehicle. Top display 174 may be a touch sensitive display that allows a user to select any number of options. Upon selection of an option (e.g., “tuner”), upper display 170 and lower display 172 may provide the appropriate information, and a user of the vehicle may select another option from top display 174 by simply “touching” the appropriate location on top display 174. As illustrated, top display 174 may be a tabbed menu structure or other menu structure. The “Shop”, “Buy”, and “Browse” commands and pushbuttons 112-115 may have the same functionality as described in FIGS. 2H and 35A.

Pushbuttons 111 may be used to change to any of the functions described while performing any operation of one of the functions. For example, in FIG. 35B, when “tuner” is selected, five options of audio output type are displayed (AM, FM/RDS/HD, SDARS, TV, DAB). The information on output display 108 (and more specifically, upper display 170) may change if another pushbutton 111 is used, while other information (e.g., the radio information displayed on bottom display 172) might or might not change based on the use of a pushbutton 111.

### Other Exemplary Embodiments or Modifications of Presented Embodiments

While the exemplary embodiments illustrated in the figures and described herein are presently preferred, it should be understood that the embodiments are offered by way of example only. Accordingly, the present application is not limited to a particular embodiment, but extends to various modifications that nevertheless fall within the scope of the appended claims. In many cases, the concepts and embodiments described herein can be utilized together. For example, a vehicle control system can be configured to include computer code and/or hardware components for completing the mobile commerce activities described here and to provide the two-tier speech recognition activities described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system.

The construction and arrangement of the systems and methods as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, elements shown as integrally formed may be constructed of multiple parts or elements (e.g., the control system, memory device, communication device, data processing device, remote source, and/or remote server of FIGS. 3-4, etc.), the position of elements may be reversed or otherwise varied (e.g., the components of the control system of FIGS. 3-4), and the nature or number of discrete elements or positions may be altered or varied (e.g., the communication device, memory device, and/or components of the control system of FIGS. 3-4). Accordingly, all such modifications are intended to be included within the scope of the present disclosure. Other substitutions, modifications, changes and omissions may be made in the design, operating conditions and arrangement of the exemplary embodiments without departing from the scope of the present disclosure. The vehicle control systems, controllers for the vehicle control systems, circuits for the vehicle control system, transmitter/receivers for the vehicle control system and the like can be mounted to the vehicle, coupled to the vehicle, and/or integrated in the vehicle at any vehicle location, including, for example, an overhead console location, a center stack location, a front dash location, distributed throughout the vehicle, etc. According to an exemplary embodiment, components of the vehicle control system (e.g., the processing circuit therefor) may be integrated in a visor, a mirror (e.g., a rear view mirror), a center console, an overhead console, or any other vehicle component.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system for a vehicle and for conducting a transaction with a remote system remote from the vehicle, the system comprising:
a circuit configured to wirelessly obtain data from a payment mechanism brought into the vehicle and to wirelessly transmit the data to the remote system.

2. The system of claim 1 wherein the circuit comprises a reader configured to wirelessly receive the data from the payment mechanism.

3. The system of claim 1 wherein the circuit further comprises a transmitter configured to transmit the data to the remote system.

4. The system of claim 1 wherein the circuit is configured to communicate with a connectivity module in the vehicle and to wirelessly transmit the data to the remote system via the connectivity module.

5. The system of claim 1 wherein the circuit is configured to communicate with a telematics module in the vehicle and to wirelessly transmit the data to the remote system via the telematics module.

6. The system of claim 1 wherein the circuit is configured to communicate with a remote control system in the vehicle and to wirelessly transmit the data to the remote system via the remote control system.

7. The system of claim 1 wherein the circuit is integrated with a connectivity module.

8. The system of claim 1 wherein the circuit is integrated with a telematics module.

9. The system of claim 1 wherein the circuit is integrated with a remote control system configured to transmit a signal to activate a garage door opener.

10. The system of claim 1 wherein the payment mechanism is portable and at least one of a credit card, a debit card, an identifier tag, a key fob, a mobile phone, and a personal digital assistant; and
wherein the remote system is at least one of a remote payment processing system, a mobile commerce agent, and a merchant.

11. A system for a vehicle and for conducting a transaction with a merchant remote from the vehicle using a mobile commerce agent and a payment processing system remote from the vehicle, the vehicle having a transmitter and a receiver for wireless communications, the system comprising:
a circuit configured to cause the transmitter to transmit a transaction signal for reception by the mobile commerce agent and to receive first information via the receiver after transmitting the transaction signal;
wherein the circuit is further configured to gather payment data;
wherein the circuit is further configured to process the first information and the payment data to cause the transmitter to transmit payment information for reception by the remote payment processing system.

12. The system of claim 11 wherein processing the first information and the payment data comprises transforming the payment data based on the first information.

13. The system of claim 11 wherein the remote payment processing system is one of a plurality of remote payment processing systems and wherein processing the first information and the payment data comprises formatting the payment information for secure transmission to a particular remote payment processing system indicated by the first information.

14. The system of claim 11 wherein the mobile commerce agent is configured to provide the first information to vehicle systems in response to receiving transaction signals and wherein the first information comprises an identifier of the remote payment processing system.

15. The system of claim 11 wherein the identifier for the remote payment processing system is transmitted with the payment information.

16. The system of claim 11 wherein the circuit is further configured to encrypt a portion of the payment information prior to transmission.

17. The system of claim 16 wherein the encryption is based on the first information.

18. The system of claim 17 wherein the first information is used as at least part of a cryptography key during the encryption of the payment information.

19. The system of claim 11 wherein the circuit is configured to gather the payment data using at least one of:
(a) user interface electronics,
(b) the receiver,
(c) pre-stored information recalled from a memory device of the circuit,
(d) a second receiver configured to receive the payment data from a payment mechanism brought within the vehicle, and
(e) a wired interface communicably coupling a payment mechanism and the in-vehicle control system.

20. The system of claim 19 wherein the second receiver is configured to utilize induction-field communication, near-field communication, or induction-field communication and near field communication to receive the payment data from the portable electronic device.

21. The system of claim 19 wherein the payment mechanism is at least one of a smart card, a mobile phone, a personal digital assistant, a key fob, and a portable navigation device.

22. The system of claim 19 wherein the second receiver is at least one of a Bluetooth transceiver, a radio frequency identification (RFID) receiver, and a near field communication (NFC) receiver.

23. The system of claim 11 wherein the circuit is further configured to provide an indication to an in-vehicle electronic display system and/or an in-vehicle audio playback system, the indication of at least one of:
a first confirmation that the payment information has been accepted by the remote processing system;
a second confirmation that the merchant will respond to the transaction signal by providing a good and/or a service.

24. The system of claim 11 wherein the mobile commerce agent is configured to:
(a) provide the first information to in-vehicle control systems in response to receiving transaction signals,
(b) receive payments, promises of payments, and/or confirmations of payments from remote payment processing systems,
(c) provide transaction signals to merchants, and
(d) provide menu information to in-vehicle systems in response to requests for the menu information from the in-vehicle systems.

25. The system of claim 11 wherein the transmitter and receiver are configured to at least one of:
(a) form a wireless communications link with a portable electronic device brought into the vehicle, the portable electronic device configured to communicate with remote sources and to provide data received from the remote sources to the receiver and to provide data received from the transmitter to the remote sources, and
(b) form a wireless communications link with a wireless service organization without the use of a portable electronic device brought into the vehicle.

26. The system of claim 11 wherein the remote payment processing system is at least one of a bank and a bank network.

27. A method for conducting a transaction with a merchant using a vehicle system, a mobile commerce agent, and a remote payment processing system, the method comprising:
causing the a transmitter in the vehicle to transmit a transaction signal for reception by the mobile commerce agent;
receiving first information at a receiver in the vehicle after the transmitter transmits the transaction signal;
gathering payment data at the vehicle system; and
processing the first information and the payment data to cause the transmitter to transmit payment information for reception by the remote payment processing system.

28. The method of claim 27 wherein processing the first information comprises transforming the payment data based on the first information.

29. The method of claim 27 wherein the remote payment processing system is one of a plurality of remote payment processing systems and wherein processing the first information and payment data comprises formatting the payment information for secure transmission to a particular remote payment processing system indicated by the first information.

30. The method of claim 27 wherein the first information comprises an identifier of the remote payment processing system.

31. The method of claim 27 wherein the identifier for the remote payment processing system is transmitted with the payment information.

32. The method of claim 27 further comprising:
encrypting a portion of the payment data and wherein the encrypted portion of the payment data is included with the payment information transmitted to the remote payment processing system.

33. The method of claim 32 wherein the encryption is based on the first information.

34. The method of claim 33 wherein the first information is used as at least part of a cryptography key during the encryption of the payment information.

35. The method of claim 27 wherein the payment data is gathered at the vehicle system using at least one of:
(a) user interface electronics mounted in the vehicle,
(b) a memory device in the vehicle, and
(c) a receiver communicably coupled to the vehicle system and configured to receive the payment data from a payment mechanism brought within the vehicle; and
(d) a wired interface communicably coupling a payment mechanism and the vehicle system.

36. The method of claim 35 wherein the receiver is configured to utilize induction-field communication and/or near-field communication to receive the payment data.

37. The method of claim 27 further comprising:
receiving a first confirmation at the receiver that the payment information has been accepted by the remote processing system;
receiving a second confirmation at the receiver that the merchant will respond to the transaction signal by providing a good and/or a service; and
providing an indication of at least one of the first confirmation and the second confirmation to an electronic display system and/or to an audio playback system.

38. The method of claim 27 wherein the mobile commerce agent is configured to at least one of:
(a) provide the first information to vehicle systems in response to receiving transaction signals,
(b) receive payments and/or confirmations of payments from remote payment processing systems,
(c) provide transaction signals to merchants, and
(d) provide menu information to vehicle systems in response to requests for the menu information from the vehicle systems.

39. A mobile commerce agent for facilitating a transaction originating from a vehicle system and using a merchant and a payment processing system, the mobile commerce agent comprising:
a processing circuit configured to process a transaction signal received from the vehicle system, wherein the processing circuit is further configured to cause the transmission of a payment processing system identifier to the vehicle system in response to the transaction signal;
wherein the processing circuit is configured to receive a confirmation of payment from the remote payment processing system; and
wherein the processing circuit is further configured to cause the transmission of the purchase request to the merchant in response to the received confirmation of payment.

40. The mobile commerce agent of claim 39 further comprising:
a memory device associating payment processing system identifiers with merchants;
wherein the processing circuit is configured to select the payment processing system identifier for transmission to the vehicle control system by recalling the payment processing system identifier associated with a merchant as indicated by the transaction signal.

41. A method for facilitating a transaction originating from a vehicle system using a merchant and a payment processing system, the method comprising:
receiving a transaction signal from a vehicle system;
processing the transaction signal received from the vehicle control system to determine a payment processing system identifier relating to the transaction signal;
transmitting the payment processing system identifier to the vehicle system;
receiving a confirmation of payment from the payment processing system corresponding to the payment processing system identifier; and
transmitting the transaction signal to the merchant in response to receiving the confirmation of payment.

42. The method of claim 41 further comprising:
selecting the payment processing identifier for transmission to the vehicle system by recalling, from a memory device, a payment processing system identifier associated with a merchant indicated by the transaction signal.
